(19) United States
(12) Patent Application Publication
(10) Pub. No.: US 2014/0002617 A1
(43) Pub. Date: Jan. 2, 2014

(54) PARTICLE TRACKING SYSTEM AND METHOD

(71) Applicant: The Board of Trustees of the University of Illinois, Urbana, IL (US)

(72) Inventors: Yuanhui Zhang, Champaign, IL (US); Douglas E. Barker, Watertown, MA (US)

(21) Appl. No.: 13/928,078

(22) Filed: Jun. 26, 2013

Related U.S. Application Data
(60) Provisional application No. 61/664,788, filed on Jun. 27, 2012.
(60) Provisional application No. 61/679,104, filed on Aug. 3, 2012.

(51) Int. Cl. H04N 13/02

(52) U.S. Cl. CPC H04N 13/0242
USPC 348/48

(57) ABSTRACT

Preferred embodiment systems of the invention use a scalable number of cameras that can image a volume of interest from plurality of angles. The volume can be large and illuminated with general non-coherent illumination. Synchronized cameras process data in real time to addresses particle overlap issues while also increasing observable volumes. Systems of the invention also use higher frame rate cameras to increase the amount of particle travel in each frame. Approaches of the invention alleviate the concerns with additional data accumulation by conducting image processing and segmentation at the time of acquisition prior to transfer from a camera to eliminate a data transfer bottleneck between camera and computer and eliminate a data storage problem. A heterogeneous CPU/GPU processor cluster processes data sent from the plurality of programmable, synchronized cameras and conducting multi-camera correspondence, 3D reconstruction, tracking and result visualization in real time by spreading processing over multiple CPUs and GPUs. Systems of the invention be scaled to hundreds of cameras and fully characterize fluid flows extending to room size and larger.

### PRIORITY CLAIM AND REFERENCE TO RELATED APPLICATION

The application claims priority under 35 U.S.C. §119 from prior provisional application Ser. No. 61/664,788, which was filed Jun. 27, 2012 (incorporated by reference herein); and from prior provisional application Ser. No. 61/679,104, which was filed on Aug. 3, 2012 (incorporated by reference herein).

### FIELD

A field of the invention is particle tracking. Example applications of the invention include systems for the analysis of particle dynamics in natural and industrial environments, including weather and environmental analysis systems and industrial control systems. Particular example industrial processes include industrial processes include aerosol separation in pollution control equipment (uniflow and reverse flow cyclones) and trapped vortex combustion in Integrated Gasification Combined Cycle (IGCC) plants.

### BACKGROUND

The use of computational fluid dynamics (CFD) simulations is ubiquitous in research of natural phenomena and also in engineering design. As an example, CFD is relied upon in most engineering design pipelines today. The current state of the art CFD relies upon numerous assumptions and simplifications. These models produce uncertain and unreliable results for complex fluid flows. This often creates post-design testing and revision of prototypes and ultimately adds substantially to the time and effort currently involved in making crucial fluid system design decisions. In addition, prototype testing with roughly approximated and unreliable fluid flow characterizations can produce pipeline systems that can have critical failures after being constructed.

Pipeline design and many other applications lack tools that permit non-invasive measurement of complex 3D flows, in real-world/full-scale environments. Present commercial products are based upon Particle Image Velocimetry (PIV), Tomographic Particle Image Velocimetry, and 3D Particle Tracking Velocimetry (PTV). These techniques generally address high speed particle movement and limit data by acquiring two static images at two points in time. The PTV methods attempt to identify a particle in each of the images, while the PIV methods operate upon differences between the frames.

Lagrangian Particle Tracking (LPT) is important in the study of fluid turbulence and particle motion. Inertial particles dynamics in turbulent flows reveal particles that do not behave like ideal flow tracers. Natural phenomena and industrial applications include such dynamics, for example rain droplets in clouds, dust storms in arid environments, fuel sprays in a combustion chambers, and aerosol separation in cyclone air cleaners.

These PIV and PTV systems were developed for researchers and experts, but have limitations when applied to practical analysis of natural phenomena and industrial applications. Typical systems use a maximum of four CCD cameras to make the data analysis manageable. High power lasers are used for flow illumination, which confines the volume analyzed to small laboratory scales on the order of (˜10 cm×10 cm×10 cm). The volume tested is limited both by the laser illumination and a desire to limit the amount of data acquired. Acquiring information from larger volumes is viewed in the art as undesirable as the data then overwhelms the techniques used to characterize the volume that is acquired by the CCD cameras. These PIV and PTV systems that are commercially available can only measure flow velocity fields because the systems base analysis upon two frames of data that are acquired in different points of time.

The PTV methods provide more information than PIV, which uses image correlation between two acquired frames without identifying a particle in each. A benefit of PTV and LPT is the ability to measure velocity fields with higher spatial resolution through sub-pixel accuracy in particle localization. See, Pereira, F., H. Stuer, et al., “Two-frame 3D particle tracking,” Measurement Science and Technology 17(7): 1680-1692 (2006). Another benefit is an ability to reconstruct long particle trajectories with high temporal resolution. Ouellette, N. T., H. Xu, et al., “A quantitative study of three-dimensional Lagrangian particle tracking algorithms,” Experiments in Fluids 40(2): 301-313 (2006). Higher order spatial and temporal derivatives can be directly evaluated from these long particle trajectories, which allow characterization of anisotropic turbulence and other fluid mechanics. See, e.g., Luthi, B., A. Tsinober, et al. “Lagrangian measurement of vorticity dynamics in turbulent flow,” Journal of Fluid Mechanics 528(−1): 87-118 (2005).

The resolution and accuracy of the particle tracking systems are naturally limited by hardware limitations from cameras, computers, illumination, etc. Enormous data generation rates, low transfer rates, and finite camera memory combine to severely limit recording time to only a few seconds in most cases. For example, a PTV system with four 1 mega-pixel cameras recording at 500 frames per second generates 120 GB in just 60 seconds. This limit leads to convergence issues in statistical analysis of Lagrangian motion. The processing required also demands high-level and specialized computer equipment, and commercial systems often specify equipment that far exceeds normal processing capabilities of standard workstations and laptops.

Particle tracking systems have reached or are rapidly approaching limits of accuracy and resolution by leveraging a steady progress in hardware improvements. These include increased sensor resolution (pixels and frame rate), cheaper memory, and faster CPU clock frequencies.

Recently, “smart cameras” for machine vision have emerged that utilize embedded architectures such as Field Programmable Gate Arrays (FPGA) and provide real-time image processing capabilities on the camera. These cameras can reduce data transfer rates by up to 1000×. See, Kreizer, M. and A. Liberzon, “Three-dimensional particle tracking method using FPGA-based real-time image processing and four-view image splitter,” Experiments in Fluids: 1-8 (2010).

Lagrangian analysis of turbulence is one of the most important applications of Lagrangian particle tracking systems. The small interrogation volume of current systems limits the range of Reynolds numbers that can be observed in the Lagrangian reference frame. See, e.g., Toschi, F. and E. Bodenschatz, “Lagrangian properties of particles in turbulence,” Annual Review of Fluid Mechanics 41: 375-404 (2009). Turbulent motion over the entire inertial range of eddies is of interest, but the small integration volume creates a constraint. Observation of these characteristics at higher Reynolds numbers requires reducing the kinematic viscosity of the fluid or drastically increasing the length scale.

Typical PTV or LPT systems only work with a fixed number of cameras between three and four. It is generally known that adding more cameras increases the observable volume and reduces the number of ambiguities when matching particle images between cameras. Maas, H. G. “Complexity analysis for the determination of image correspondences in dense spatial target fields,” International Archives of Photogrammetry and Remote Sensing XXIX: 102-107 (1992). This concept was demonstrated by synchronizing up to eleven low cost cameras to track a few flies in motion. Straw, A. D., K. Branson, et al., “Multi-camera Realtime 3D Tracking of Multiple Flying Animals,” Journal of the Royal Society Interface rsif.2010.0230v1-rsif20100230 (2010). Solving the multi-camera correspondence problem in real-time for a large number of tracer particles remains a challenge that has not been addressed, except for the techniques discussed above that limit the number of cameras and the interrogation volumes. Current commercial particle tracking velocimetry (PTV) systems, for example, are only capable of measuring flow field velocities, without particle trajectory reconstruction, in small scale flows (<0.001 m³) due to imaging and illumination system limitations.

Parallel processing has been used in 3D particle tracking and related PIV research to speed processing of Fast Fourier Transform (FFT) used in PIV cross-correlation and holographic PTV. See, e.g., Meinhart et. al. “A parallel digital processor system for particle image velocimetry,” Measurement Science and Technology 4: 619-626 (1993); Satake et al “Parallel computing of a digital hologram and particle searching for microdigital-holographic particle-tracking velocimetry,” Appl. Opt. 46(4): 538-543 (2007). The research pointed toward temporal decomposition of image video as a speed up tool in application specific configurations.

Before describing particular prior techniques and systems, some background information about particle in fluid flows is first provided. In general, particles can become inertial for two reasons, 1) their density is greater or less than the surrounding fluid, 2) their size is finite and large compared to the eddy dissipation scale. A pair of useful dimensionless numbers Φ and Γ can be used to characterize a particle's size and density relative to the dissipation scale and flow density respectively.

$$\begin{matrix}Φ = \frac{d}{η} & ( 1 \text{-} 1 ) \\ Γ = \frac{{ρ}_{p}}{{ρ}_{f}} & ( 1 \text{-} 2 )\end{matrix}$$

Where d is the diameter of the particle, η is the eddy dissipation scale, also called the Kolmogorov length, η=(ν³/ε)^{1/4}, ρₚ is the density of the particle and ρ_{ƒ} is the density of the fluid. See, Qureshi, N. M., M. Bourgoin, et al. “Turbulent transport of material particles: An experimental study of finite size effects,” Physical Review Letters 99(18) (2007).

Traditionally, the dimensionless Stokes number is considered to contain the significance of the particles size and density with respect to the flow. The Stokes number is defined as the particle's response time divided by the characteristic eddy time τ_{η}=(ν/ε)^{1/2}. At small Stokes numbers particles behave as ideal fluid tracers and their trajectories match those of fluid particles. At high Stokes numbers, St>0.1, the particles behave differently than the surrounding flow field. This can be seen through preferential concentration of inertial particles, where particles accumulate in areas of the flow field after being expelled from small eddies and changes in the probability distribution function of acceleration variance (Ouellette, O'Malley et al. 2008).

$$St = \frac{{τ}_{p}}{{τ}_{η}} \qquad ( 1 \text{-} 3 )$$

Recent research questioned relevance of the Stokes number with respect to predicting how inertial particles will behave in a flow field. See, e.g. Qureshi, N. M., M. Bourgoin, et al., “Turbulent transport of material particles: An experimental study of finite size effects,” Physical Review Letters 99(18) (2007). Qureshi et al. reported on the dynamics of millimeter sized helium bubbles in grid generated turbulence for size and density ranges of 10<Φ<30 and 1<Γ<70. According to their study, probability distribution functions of mean and variance, were not affected by changes in size or density compared with ideal fluid tracers. Statistics of acceleration were also reportedly not affected, and only the variance of acceleration was significantly impacted by the fact that the particles were inertial. Others have also reported no observable difference in the velocity or acceleration statistics of the particles (acceleration variance was affected), but reported differences in the actual trajectories for the larger particles to conclude that inertial effects do not scale with Stokes number as was traditionally thought. Ouellette, N. T., P. J. J. O'Malley, et al., “Transport of finite-sized particles in chaotic flow,” Physical Review Letters 101(17) (2008).

Finite size inertial particles do follow different paths than much smaller flow tracers, but interestingly the velocity and acceleration statistics of inertial particles tend match those of the underlying flow. In anisotropic turbulent flows, the location of turbulence intensities observed by the motion of inertial particles will be displaced from the true location of those values and the distribution observed through the filter of inertial particle motion will be different. However the scale of this effect is still an open question in the field and there may be flows where large neutrally buoyant particles, such as helium filled soap bubbles may provide a close approximation to the characteristics of the flow field.

Therefore, the study of inertial particles in turbulent flow remains an open question and traditional theories of the Stokes number as an indicator of particle behavior have been called into question. Many flows are still poorly understood and can't be predicted, and systems to characterize particles in turbulent flows remain critical to developing better understanding of natural phenomena and to industrial and engineering based design of systems with particles in fluid flows.

The hardware components of a typical particle tracking system include: particle seeding and illumination systems, cameras, data transfer and storage, and data processors. In typical systems all images are first transferred to computer, typically a powerful desktop computer, where all processing takes place. The software used on the computer that receives the images typically performs a number of tasks. A first process is image acquisition and processing. In this processing, images of a particle laden flow from three or more cameras are first processed to remove background, filter noise. A second process is particle detection and centroid localization: Particle “blob” images are detected and analyzed to determine the centroid of individual particles in pixel coordinates. A third process is determination of image correspondence. The stereo correspondence problem between particles which are imaged in multiple camera planes is most often solved using epipolar geometry. A fourth process is 3D reconstruction. The matched 3D location of each particle is reconstructed in object space from calibration parameters. A fifth process is temporal tracking in 3D and/or 2D: The reconstructed 3D particle data is typically analyzed from frame to frame to identify the temporal correspondence of particles in object space. Temporal tracking can also be conducted in 2D image space to help eliminate spatial matching ambiguities. Another process typically used is post processing and visualization. In this process, the reconstructed trajectories are used to calculate the particles instantaneous velocity and acceleration along its path. If the data has high spatial density for the desired resolution, then it can be interpolated to a regular grid and averaged to calculate the Eularian velocity field. Image processing, particle detection and centroid localization

A common method to segregate the particle “blob” images is to subtract the image background, apply a high-pass filter, perform threshold binarization followed by centroid identification. Selecting the proper threshold value which maximizes the number of particle identifications in the presence of image noise, non-uniform illumination, and overlapping particle “blob” images can be difficult. This crucial step defines the spatial density of particle information and amount of measurement error propagated through 3D position reconstruction. Neural network approaches using the optical flow equation and the 1D Gaussian estimator have been demonstrated to perform better than the standard threshold binarization and weighted average approaches in the presence of noise and non-uniform illumination. However, the present inventors do not know of the prior development of a single all-purpose algorithm that is optimal for all cases.

Stereo correspondence between particles located in different image planes has traditionally been solved traditionally using the geometric epipolar constraint. See, Maas, H. G., A. Gruen, et al., “Particle tracking velocimetry in three-dimensional flows: Part 1. Photogrammetric determination of particle coordinates,” Experiments in Fluids 15(2): 133-146 (1993). To fully define the 3D position of a particle based solely on the epipolar constraint, at least three cameras must be used. Use of more than three cameras increases, in theory, the measurement volume and matching confidence. Analytical expressions for the uncertainty in matching particles observed in multiple cameras have been derived and the authors concluded that if four cameras are used in the matching process, then ambiguity can be reduced to near zero. Virant, M. and T. Dracos, “3D PTV and its application on Lagrangian motion,” Measurement science and technology 8: 1539-1552 (1997). Despite this recognition, practical systems have failed to achieve this because of processing limitations and data bottlenecks. There have been attempts to reduce stereo matching ambiguity with additional particle information such as size, color, intensity, and temporal correspondence in the image plane. The latter technique is considered most effective to resolve unmatched missing particles in the 3D reconstructed data set, and has been reported to result in an average 20% more particles matched. Willneff, J. and A. Gruen, “A new spatio-temporal matching algorithm for 3D-particle tracking velocimetry,” Proceedings of the 9th of International Symposium on Transport Phenomena and Dynamics of Rotating Machinery Honolulu, Hawaii, Feb. 10-14 (2002).

Tracking algorithms establish temporal correspondence of particles through object space and reconstructs long trajectories. Nearly all tracking algorithms take the input of 3D particle coordinates grouped by time step (frame) and output the reconstructed trajectories. The most common include the 2-frame and multi-frame algorithms. Another approach is the neural network approach. Pereira, F., H. Stuer, et al., “Two-frame 3D particle tracking,” Measurement Science and Technology 17(7): 1680-1692 (2006). An additional approach is the Extended Kalman Filter approach. Straw, A. D., K. Branson, et al., “Multi-camera Realtime 3D Tracking of Multiple Flying Animals,” Journal of the Royal Society Interface rsif.2010.0230v1-rsif20100230 (2010).

The multi-frame algorithm is superior for long trajectory tracking and more robust against noise. See, e.g., Kitzhofer, J. and C. Bruecker, “Tomographic particle tracking velocimetry using telecentric imaging,” Experiments in Fluids 49: 1307-1324 (2010). In a multi-frame temporal tracking algorithm the next position of each particle is predicted based on its location in up to five previous time steps using a kinematic model of velocity and acceleration. In general, the multi-frame temporal tracking algorithm has the following procedure:

(1) For an initial frame f−1, initiate two point trajectories by adding the nearest neighboring particle in frame f to each particle in frame f−1.
(2) Extrapolate the trajectories to estimate the particle's position in the following frame f+1 with an approximation of velocity and acceleration.

$${\hat{x}}_{i}^{f + 1} = {x}_{i}^{f} + {u}_{i}^{f} Δ t + {a}_{i}^{f} Δ {t}^{2} \qquad ( 1 \text{-} 4 )$$

(3) Evaluate the quality of each candidate particle for addition to each trajectory using a cost function.
(4) Move to the next frame and complete steps 2-4 until all frames have been processed.

Common trajectory extrapolation methods include; 1st order finite difference (FD) approximation of velocity, 1st order FD velocity with 2nd order acceleration correction, and 2nd order polynomial regression. Multiple quality or “cost” functions have been proposed for selecting particles for addition to a trajectory including: nearest neighbor, minimum acceleration, and minimum change in acceleration. Malik, N. A., T. Dracos, et al., “Particle tracking velocimetry in three-dimensional flows: Part II. Particle tracking,” Experiments in Fluids 15(4): 279-294 (1993). Another technique is a ratio of regression residual to geometric mean displacement. See, e.g., Li, D., Y. Zhang, et al., “A multi-frame particle tracking algorithm robust against input noise,” Measurement Science and Technology 19: 105401 (2008).

In the context of particle tracking systems, real time response can be defined by 1) preventing data accumulation in the camera or computer which limits experiment run time; (See, Chan, K. Y., D. Stich, et al. “Real-time image compression for high-speed particle tracking,” Review of Scientific Instruments 78(2):023704 (2007)(which compressed images to address data accumulation); Hoyer, K., M. Holzner, et al. “3D scanning particle tracking velocimetry,” Experiments in Fluids 39: 923-934 (2005)); and/or 2) active monitoring of dynamic objects for feedback in an online control system (Straw, A. D., K. Branson, et al., “Multi-camera Realtime 3D Tracking of Multiple Flying Animals,” Journal of the Royal Society Interface rsif.2010.0230v1-rsif20100230 (2010). Straw et al. described a tracking system that could trace the trajectory of several flies and trigger a secondary high speed camera based on a fly's location in real-time, but concluded that tracking hundreds or thousands of flies in real-time was outside the capability of the same or available algorithms.

Data accumulation has been recognized as a limit to achieving real time processing in particle tracking systems, but the typical approach is to store data with a large number of hard drives and conduct analysis of stored data. See, Adrian, R. J., “Particle-imaging techniques for experimental fluid mechanics,” Annual Review of Fluid Mechanics 23(1): 261-304 (1991); Kreizer, M., D. Ratner, et al., “Real-time image processing for particle tracking velocimetry,” Experiments in Fluids 48(1): 105-110 (2009). The increasing frame rates and resolution of advancing camera technology impedes the ability efficiently to transfer, process and store the enormous amount of image data, and this problem has persisted with artisans having short observation time frames and/or small volumes. A principal bottleneck occurs in data transfer between camera and computer. With enormous data generation rates, the camera must hold images in buffer memory. As an example, a PTV system with four 1 mega-pixel 8-bit monochrome cameras at 500 frames per second recording for 60 seconds will generate 120 GB of image data. A typical approach is to limit the duration of data acquisition. Hoyer et. al., for example, reported that camera memory with 500 Hz cameras limited maximum measurement duration of testing to four seconds. This created convergence problems in their statistical analysis. Hoyer, K., M. Holzner, et al., “3D scanning particle tracking velocimetry,” Experiments in Fluids 39: 923-934 (2005). For a given camera, the recording time limit is a function of net data accumulation rate (B/s) and memory capacity of the camera. The net data accumulation rate is equal to the data generation rate minus the data transfer rate.

Camera technologies have eliminated the memory transfer bottleneck for some applications, but the data generated in particle tracking remains outside of compression technologies used in cameras. It has been effective to reduce the net data accumulation, but data still accumulates and when more than modest volumes are used, the data accumulation rate still places a significant constraint on particle tracking systems. Chan et. al. developed a data compression system that reduced data transfer between the camera and computer by up to 1000 times, increasing the continuous recording time from 6.5 seconds up to a week. This experiment involved a single camera and observed in a 2D plane. Chan, K. Y., D. Stich, et al. “Real-time image compression for high-speed particle tracking,” Review of Scientific Instruments 78(2): 023704 (2007).

Another approach to reduce net data accumulation used processing to only output pixel coordinates of particle centroids. Kreizer, M. and A. Liberzon, “Three-dimensional particle tracking method using FPGA-based real-time image processing and four-view image splitter,” Experiments in Fluids: 1-8 (2010). This approach used Field Programmable Gate Arrays (FPGA) to process each pixel in parallel and a fast method to filter noise, remove background and locate particle centroids in real-time prior to transferring data to the host computer, but using only a single camera. This approach allows continual running for a single camera at a rate of about 2000 Hz with 1280×1024 pixel CMOS camera, 1024 particles per frame, and 20 Bytes per particle. A drawback of this approach was that the system used one camera with a mirror system to split the image into four view points. The single camera limits the effectiveness of the system. Also, in these approaches and other prior approaches that speed the camera to computer transfer, a processing bottleneck alleviated at the camera is often shifted to the remaining required steps (solving the correspondence problem, 3D reconstruction, and tracking) to create a bottleneck at the computer used for processing.

### SUMMARY OF THE INVENTION

Preferred embodiment systems of the invention use a scalable number of cameras that can image a volume of interest from plurality of angles. The volume can be large and illuminated with general non-coherent illumination. Synchronized cameras process data in real time to addresses particle overlap issues while also increasing observable volumes. Systems of the invention also use higher frame rate cameras to increase the amount of particle travel in each frame. Approaches of the invention alleviate the concerns with additional data accumulation by conducting image processing and segmentation at the time of acquisition prior to transfer from a camera to eliminate a data transfer bottleneck between camera and computer and eliminate a data storage problem. A heterogeneous CPU/GPU processor cluster processes data sent from the plurality of programmable, synchronized cameras and conducting multi-camera correspondence, 3D reconstruction, tracking and result visualization in real time by spreading processing over multiple CPUs and GPUs. Systems of the invention be scaled to hundreds of cameras and fully characterize fluid flows extending to room size and larger.

A method of receiving particle tracking trajectory data from a multi-camera system in real-time calculates Lagrangian values along each trajectory in the particle tracking data in real-time. Instantaneous pressure gradients are calculated along each trajectory. Calculated instantaneous values are stored over time in cells of a finite volume grid. Mean and variance of pressure gradient are extracted from each cell to thereby transform instantaneous Lagrangian accelerations and velocities into a Eularian representation of the pressure gradient field. Static pressure in the Eularian frame are calculated as the mean and variance of the instantaneous pressure gradient values accumulated in each cell.

### BRIEF DESCRIPTION OF THE DRAWINGS

FIG. 1 is block diagram of a preferred embodiment real-time Lagrangian particle tracking system of the invention;

FIG. 2 illustrates an epipolar constraint used the system of FIG. 1;

FIG. 3 illustrates a transformation from world to camera coordinates used in the system of FIG. 1;

FIGS. 4A-4C illustrate the effect of frame rate and trajectory sampling to make particle velocity substantially linear;

FIG. 5 is a block diagram that illustrates a statistical accumulator grid technique of the invention for accepting instantaneous values of Lagrangian properties and actively calculating statistical values for the each property including mean, variance and/or covariance;

FIGS. 6A and 6B illustrate the display and visualization of vector fields of velocity and vorticity are displayed as vectors that are colored by magnitude;

FIG. 7 illustrates visualization of vector fields for six cameras with the statistical accumulator grid technique of FIG. 5;

FIGS. 8A and 8B illustrates a preferred multi-thread processing pipelining that process the LPT data across CPU cores as it streams in from the cameras in the system of FIG. 1;

FIGS. 9A-9C illustrate a processes to decompose LPT data into multiple sets of consecutive frames;

FIG. 10 illustrates a preferred trajectory merge operation that conserves processor communications by examining trajectory tails;

FIG. 11 is a flow diagram illustrating a parallel tracking algorithm of a preferred embodiment for a simplified case of three global trajectories spanning four frame sets on two processors;

FIG. 12 shows trajectories from standard PIV data set \#352 spanning 75 frames or greater that were used to evaluate the parallel tracking algorithm;

FIG. 13 shows a larger set of simulated trajectories used for scaling analysis of the parallel tracking algorithm;

FIG. 14 illustrates scaling results that show strong scaling of the six data sets up to 512 processors;

FIG. 15 illustrates speedup results from parallel execution compared to sequential execution and demonstrating perfect scaling with the number of processors;

FIG. 16 illustrates a simulated indoor air flow field used to test the trajectory reconstruction accuracy and parallel performance of the present tracking algorithm in the presence of large velocity gradients and non-uniform particle seeding over time;

FIG. 17 illustrates a subset of the simulated particle trajectories for the displacement indoor air ventilation simulation of FIG. 16;

FIG. 18 illustrates fluctuation of the number of particles per frame for the simulated data set of FIG. 16;

FIG. 19 illustrates the condition number of 3D reconstruction matrix A as a function of changing angle between two cameras;

FIG. 20 illustrates relative 3D standard uncertainty variation with of angle between two cameras; and

FIG. 21 illustrates relative 3D position error resulting from centroid location errors and variation with angle between two cameras.

### DETAILED DESCRIPTION OF THE PREFERRED EMBODIMENTS

Previous approaches to particle tracking measurement systems try to develop and use complex algorithms in an effort to address hardware limitations to gain resolution, reduce errors and uncertainty, and improve usability. Preferred embodiments of the invention integrate a plurality of technologies and provide a scalable system to obtain more data than necessary and efficiently identify and analyze data that is critical while also identifying data that is unreliable and/or unnecessary (data that is a poor indicator of particle identification) and that can be discarded in real time to avoid what would otherwise be an unrealistic data storage problem. Preferred embodiments leverage parallel computing paradigms, heterogeneous computing architectures, smart cameras, and open source programming tools to overcome the particle tracking limitations and provide a solution that is scalable.

Preferred embodiment systems of the invention use a scalable number of cameras that can exceed the typical four used in conventional systems to image a flow from a plurality of angles, while identify unreliable data in real time to addresses particle overlap issues while also increasing observable volumes compared to state of the art systems. Systems of the invention also use higher frame rate cameras to increase the amount of particle travel in each frame. Approaches of the invention alleviate the concerns with additional data accumulation by disposing of unreliable and unnecessary data at the time of acquisition. Image processing and segmentation is conducted at the time of acquisition prior to transfer from a camera to eliminate a data transfer bottleneck between camera and computer and eliminate a data storage problem. Real-time processing and discarding of unneeded intermediate data (images, etc.). Embodiments of the invention take a different approach from the standard practice of limiting volume observed and data acquired, and instead over observe the flow through many camera angles and at higher frame rate. With unnecessary and unreliable data quickly required, particle tracking is achieved with simpler and faster algorithms to facilitate real-time processing.

Preferred embodiments of the invention provide a motion capture system for real-time tracking and characterization of full scale three dimensional fluid flow fields. Systems of the invention are scalable and have been demonstrated through experiments to be capable of characterizing the velocity, acceleration, pressure and turbulence distributions in 3D fluid flows despite obtaining data from larger volumes, with larger numbers of cameras, and/or with high data acquisition rates.

Example embodiments of the invention use a scalable plurality of cameras, at least four are preferred. The synchronized plurality of cameras observes particles in a fluid flow, triangulates their 3D position, and tracks them through space and time to obtain instantaneous velocity and accelerations for each particle. Particle accelerations and velocities are then used to calculate other important flow parameters including turbulent kinetic energy, vorticity, turbulence intensity and pressure distribution. This occurs in real time without data accumulation and while also allowing real-time display. The plurality of cameras are selected and controlled to obtain significantly more data than is necessary for analysis, but unreliable or unnecessary data is discarded immediately after acquisition after a fast identification. With intelligent selection of data to be retained, calculations for instantaneous velocity, acceleration, pressure and turbulence distributions in 3D can be simplified.

Preferred systems of the invention include a plurality of smart cameras that acquire data and include software that identifies unreliable or unnecessary data to be retained or discarded. A generous (larger than the very small volume conventional systems) volume is illuminated, preferably by LED illumination in a volume that is observed by the plurality of smart cameras. Systems of the invention can use non-coherent lighting (non-laser lighting) Data that is not immediately discarded is communicated from the plurality of smart cameras to a multi-core parallel computing and general purpose graphics processing (GPU). Systems of the invention are believed to be capable of unprecedented results for particle tracking and motion measurement. A prototype system of the invention demonstrated capabilities and scalability. The prototype system consisted of six synchronized smart cameras and processing to visualize, reproduce and analyze flows or particle motion in a three dimensional space, with real-time capability. The processing established in the prototype system is demonstrated to be readily scalable to a large number of cameras, e.g., up to hundreds of cameras, while still being above to visualize full scale flow field in large volumes. Systems of the invention can also be scaled down to measure micro-scale flows. Scaling down can be achieved by control, e.g., deactivating a number of cameras in a system for a particular operation. Unlike prior systems, algorithms used by preferred embodiments of the invention can function independently of the exact number of cameras being used for a particular test.

Systems and methods of the invention can calculate pressure fields or be used for particle transport studies. Systems of the invention can track individual particles over time and therefore can determine particle acceleration and calculate the pressure distribution. These are unique capabilities. Systems of the invention can track particles individually over hundreds of frames, which also permits characterization of particle transport. As an example, particle transport is important for characterizing contaminant dispersion in ventilated spaces (bio-aerosol agent release in protected spaces, pathogenic aerosols in hospitals, etc). Systems of the invention provide a powerful tool to aid the design of many fluid systems including, for example, such air distribution and HVAC systems, as well as combustion processes and many other natural and industrial applications involving fluid flows.

Systems of the invention effectively leverage accelerator technologies such as the Graphic Processing Unit (GPU) have emerged to introduce a finer grain parallelism that can speed up current algorithms by over 100× (NVIDIA, 2010). With initial acquisition of more data than needed followed by real-time discarding of unnecessary or unreliable data, embodiments of the invention provide a fully scalable Lagrangian particle tracking system that can observe larger volumes and longer time frames than conventional small volume system while also visualizing the data in real-time.

Preferred systems of the invention are scalable and provide particle detection, multi-camera correspondence, 3D reconstruction, tracking and interactive visualization in real time for large volumes, at high frame rates and with a large number of cameras scalable from four cameras to hundreds of cameras. Real-time processing to discard unreliable or unnecessary data alleviates data accumulation in memory and frees researchers from current limits on experimental duration. This, in turn, allows better statistical characterization of chaotic phenomena, such as turbulence and inertial particle motion. Preferred embodiments of the invention provide algorithms for massively parallel processing on modern computing architectures and that can readily scale up or down in terms of the number of cameras and processors used from one experiment to the next. Preferred systems of the invention can provide detailed flow field information including Eularian velocity vectors and Lagrangian trajectories of tracer particles in fluid dynamics studies.

As mentioned, preferred systems of the invention are highly scalable. With adequate parallel processing resources made available, algorithms used in systems of the invention can scale up to an arbitrary number of cameras. Algorithms provided in preferred embodiments scale with an increased number of cameras and higher frame rates. Real-time processing is provided in preferred embodiments with two parallel frameworks. In one framework, multi-threading is conducted within each with multi-core processors' node and GPU accelerators. As second framework leverages message passing to utilize high performance clusters. Preferred systems of the invention have reduced overall sensitivity to camera location, image noise and propagated uncertainty compared to typical prior systems.

An experimental analysis was conducted to assess the accuracy and uncertainty in the 3D position, velocity and acceleration of particles in the Lagrangian frame. The 3D position uncertainty was 0.48 mm and accuracy was comparable to a caliper in measure distances between static particles. The velocity measurements were within less than 1% of the calculated value for an object rotating with constant angular velocity. Acceleration was accurate to within 1% for low frame rates but diverged from the calculated value at higher frame rate largely due to local velocity fluctuations in the object.

The system was used to characterize the dynamic motion of neutrally buoyant helium filled soap bubbles in an unconfined round turbulent jet. The results for axial velocity decay and transverse velocity profile all matched well with the accepted models in literature. In addition, the profiles of Reynolds shear stress and axial turbulence intensity were in good agreement in both profile and magnitude of those found in literature as measured with hot-wire anemometry. The validated LPT system was then applied to a forced air turbulent vortex. Particles were successfully tracked with complex 3D paths. Static pressure profiles were calculated based on the measured velocity field and found to be qualitatively in good agreement with theory.

Those knowledgeable in the art will appreciate that embodiments of the present invention lend themselves well to practice in the form of computer program products. Accordingly, it will be appreciated that embodiments of the present invention may comprise computer program products comprising computer executable instructions stored on a non-transitory computer readable medium that, when executed, cause a computer to undertake methods according to the present invention, or a computer configured to carry out such methods. The executable instructions may comprise computer program language instructions that have been compiled into a machine-readable format. The non-transitory computer-readable medium may comprise, by way of example, a magnetic, optical, signal-based, and/or circuitry medium useful for storing data. The instructions may be downloaded entirely or in part from a networked computer. Also, it will be appreciated that the term “computer” as used herein is intended to broadly refer to any machine capable of reading and executing recorded instructions. It will also be understood that results of methods of the present invention may be displayed on one or more monitors or displays (e.g., as text, graphics, charts, code, etc.), printed on suitable media, stored in appropriate memory or storage, etc.

Preferred embodiments of the invention will now be discussed with respect to experiments and drawings. The description of experiments and drawings may include schematic representations, which will be understood by artisans in view of the general knowledge in the art and the description that follows. Features may be exaggerated in the drawings for emphasis, and features may not be to scale. Additional features and variations will be apparent to artisans from review of the description of the experiments.

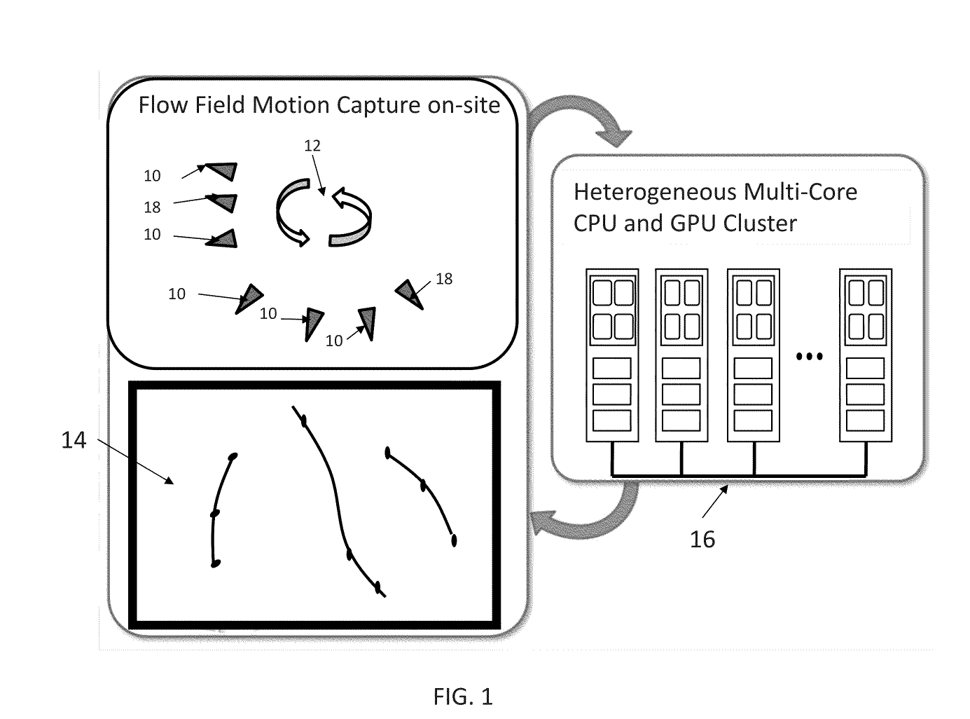

In FIG. 1, a plurality of smart cameras (cameras with on-board processes that are programmed to carry out functions in accordance with the invention) 10 are arranged to observe a volume of interest including a fluid flow 12 with particles therein. The volume of interest can be substantially larger than the small volumes illuminated by lasers in many prior techniques. The particles 12 can be placed in the flow via a seeding device or may be a natural part of the flow. The number of cameras 10, as mentioned, is at least four and can be scaled to much larger numbers, as discussed above. In FIG. 1, there are seven cameras illustrated as an example. As mentioned above, the cameras 10 are preferably numbered are to oversample, and then programmed to process to eliminate unnecessary and/or unreliable date. After conducting significant portions of particle tracing in real-time, the programming can provide real-time display capabilities to a work station with one or more displays. The workstation may be local or remote, and can be connected via wireless or wired network or other connection. Intense processing tasks are sent to parallel processing, such as in a cloud parallel processing resource 16.

The smart cameras 10 preferably include FPGA and are programmed to conduct tasks that reduce net data retention rates to zero and provide a Lagrangian particle tracking systems that can record indefinitely while achieving both a higher frame rate and higher resolution than is believed to have been previously provided by the efforts of artisans as summarize in the Background section above. The cameras 10 in the present system conduct image acquisition, processing and particle detection. The cameras 10 used high frame rates to reduce particle tracking burden but increases the number of particles to process through the remaining steps.

The increased amount of data is handled by a scalable method is to spread the data across a computer cluster processing system, such as the cloud 16. The cloud 16 includes a heterogeneous CPU/GPU cluster. The cameras 10 send data over the internet to the cloud 16. This adds scalability and flexibility in installation, as the cameras 10 can be physically separated from the processing system. The cameras 10 are programmed to conduct image processing and particle detection, while a heterogeneous CPU/GPU cluster 16, which can be in the cloud, processes the multi-camera correspondence, 3D reconstruction, tracking and result visualization. The cameras 10 are preferably networked in the sense that they are connected to the computer cluster 16 through a network and may or may not be at the same physical location as the computer cluster. The type of programming used to control the cameras preferably conducts an algorithm to detect and then communicate data about the particle centroids and discard the images. Advantageously and to provide much larger illuminated volumes than laser illumination typically used in past efforts, illumination can preferably be achieved with LED lights 18 or another form of general, non-coherent illumination. Volumes that can be tracked by systems of the invention are not limited to a few cubic centimeters or less, as in many prior systems, but are scalable to even room sized volumes while maintaining real-time capabilities.

The cameras 10 send identified particle pixel coordinates or segmented images in real-time to a cluster of computers located in the cloud 16. The cluster is an array of nodes each with multi-core CPU processors and GPU accelerators. The cluster processes frames of particles in parallel across the array of nodes in a streaming pipeline as they are received. Each node receives a small set of frames, then divides the particles within each frame and processes the particles in parallel on the GPU to determine the multi-camera correspondence of particle images, followed by 3D reconstruction, and tracking. Each node communicates with a local group to merge trajectory segments to form longer trajectories. The resulting trajectories can be processed to determine Lagrangian and Eularian properties of the particle flow field and send the results back to a researcher at one or more work stations 14 for real-time visualization.

Experimental systems have conducted processing in a parallel processing cloud and open source code has been combined to provide individual functions. The experiments will now be described and will illustrate many additional features of the invention.

### Lagrangian Particle Tracking Algorithms

The algorithms developed are separated into five sections 1) image processing and object detection, 2) Multi-camera correspondence, 3) 3D reconstruction, 4) Tracking and 5) Result processing and visualization.

An implementation approach for the real-time LPT system leverages high quality open source libraries for proven algorithms to maintain a high quality scalable code. The algorithms in experiments were all implemented in C++, where some of the methods were selected from open source C++ libraries listed in Table 1.

TABLE 1
Open source libraries used to implement the LPT algorithms

| Open source C++ library | Usage |
|---|---|
| Open source Computer Vision | Camera calibration, image processing, |
| (OpenCV) | object detection |
| Visualization Toolkit (VTK) | Foundation building blocks for |
| | the interactive rendering environment |
| Boost C++ Libraries | Statistical accumulator |
| | framework |

### Image Processing and Particle Detection

The image processing and particle detection algorithm should minimize errors because errors in detection will propagate through the entire process, impacting the uncertainty and accuracy of the 3D reconstruction. The selection of image processing methods and detection schemes is dependent on the type of illumination and seed particles used, as discussed in the background. Helium filled soap bubbles were selected for the present experiments based upon guidance from the work discussed in the background.

Image Segmentation: During this section, a uniform threshold operation is applied to create a segmented binary image with bright particles images assigned 1s and the backgrounds 0s. The threshold is selected empirically and the optimal threshold depends on illumination level and sensitivity of the sensor.

Structural image transformations: iteratively dilate and erode the image to fill in the non-uniformities of the segmented particle images.

Calculate the centroid of each processed particle image through the weighted-average technique, where particle centroid pixel locations are given by (2-1).

$${x}_{pd} = \frac{\sum xI ( x , y )}{\sum I ( x , y )} \\ {y}_{pd} = \frac{\sum yI ( x , y )}{\sum I ( x , y )} \qquad ( 2 \text{-} 1 )$$

The image processing and particle detection algorithm for helium soap bubbles was based on Biwole. See, Biwole, “A complete 3D particle tracking algorithm and its applications to the indoor airflow study,” Meas. Sci. Technol. 20 115403 (2009). Image processing and particle detection was implemented with the open source computer vision library (OpenCV). OpenCV provides a number of functions for image processing and object detection. The final algorithm developed for the experiments was as follows.

(1) Apply a three point kernel Gaussian filter to the image to effectively blur the image and reduce the impact of pixel noise.
(2) Threshold the image based on a user defined value from 0-255. All pixels below the threshold are assigned 0 and all above are assigned 1. The result is each particle “blob” image becoming white against a dark background.
(3) Apply the find contours detector of OpenCV which identifies the perimeter of each segmented “blob”. The x y pixel coordinates of the perimeter pixels are stored in an array for each “blob” detected.
(4) The spatial moments of each contour found are calculated and the centroid is then found based on 2-2.

$${m}_{ij} = {\sum }_{x , y} I ( x , y ) {x}^{j} {y}^{i} \\ {x}_{pd} = \overline{x} = \frac{{m}_{10}}{{m}_{00}} \\ {y}_{pd} = \overline{y} = \frac{{m}_{01}}{{m}_{00}} \qquad ( 2 \text{-} 2 )$$

Lens distortion can be significant in real lenses. Numerically removing distortion can reduce uncertainty in the reconstructed 3D particle positions. Distortion is modeled through the model given in equation 2-3. This model includes up to six radial distortion coefficients (k1 to k6) and two tangential distortion coefficients, p1 and p2. These eight coefficients together with the focal length [fx, fy] and principle point [cx, cy] are the camera's intrinsic parameters.

$$\begin{matrix}{x}^{″} = {x}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + 2 {p}_{1} {x}^{′} {y}^{′} + {p}_{2} ( {r}^{2} + 2 {x}^{′2} ) & ( 2 \text{-} 3 ) \\ {y}^{″} = {y}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + {p}_{1} ( {r}^{2} + 2 {y}^{′2} ) + 2 {p}_{2} {x}^{′} {y}^{′} \\ {r}^{2} = {x}^{′2} + {y}^{′2} & ( 2 \text{-} 4 )\end{matrix}$$

Where (x″, y″) and (x′, y′) are the distorted and undistorted homogeneous coordinates (camera coordinates xc and yc normalized by zc) of an image, respectively. The undistorted homogenous coordinates (x′, y′) are determined through solving iteratively the non-linear equations (2-3), where the distorted homogenous camera coordinates are found from the intrinsic parameters and the observed distorted pixel coordinates of an image point x_{pd} and y_{pd} (2-5).

$${x}^{″} = \frac{{x}_{pd} - {c}_{x}}{{f}_{x}} \\ {y}^{″} = \frac{{y}_{pd} - {c}_{y}}{{f}_{y}} \qquad ( 2 \text{-} 5 )$$

Then, the undistorted image pixel coordinates can be found through the undistorted homogeneous coordinates along with the focal length and principle point.

xₚ=ƒₓx′cₓ

yₚ=ƒ_{y}y′c_{y} (2-6)

### Multi-Camera Correspondence

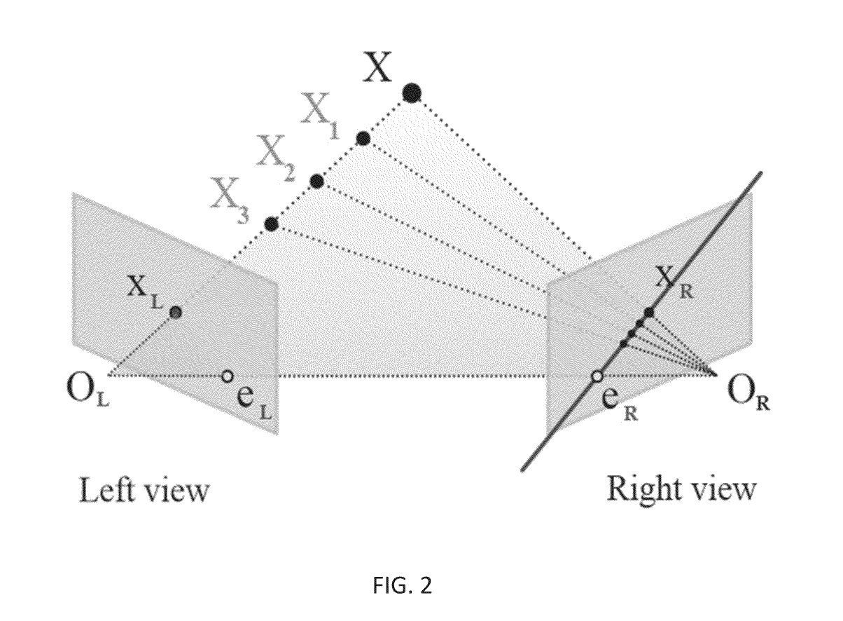

The criterion used in preferred embodiments to determine spatial correspondence between particle images in multiple image planes is called the epipolar geometry constraint. The epipolar geometry between two cameras is shown in FIG. 2. Point X represents a point in object space and XR and XL are the corresponding image coordinates of X for the right and left image plane respectively.

### FIG. 1: Epipolar Geometry in Stereo Vision

The epipolar line eRXR on the right image plane is created from the ray between the origin of the left image plane OL and point X. Correspondence ambiguities in the right camera can exist along the epipolar line as shown in the figure. For example, the right image can clearly distinguish the four points X, X1, X2 and X3 along ray OL X, while the left image can only distinguish one point. In this case a third camera is required to eliminate the ambiguities and conclude that XL and XR corresponds to X and not the other three points. The epipolar constraint equation is derived next.

For two cameras, the image coordinates Xr and Xl of corresponding to a single object point are known to be relatable through a rotational matrix R and translational vector t as in equation 2-7.

Xᵣ=R(Xₗt) (2-7)

The epipolar plane as shown in the figure above is defined by the location of object point X and the coplanar condition in equation 2-8 for the left and right image coordinates.

(Xₗ−t)^{T}t×Xₗ=0 (2-8)

Substituting the coplanar condition into equation 2-8 results in 2-9

(R^{T}Xᵣ)^{T}t×Xₗ=0 (2-9)

Trucco and Verri (Introductory Techniques for 3D Computer Vision (1998)) showed that by using a vector product rule for rank deficient matrices in 2-9 that this equation can be refactored to the form in 2-10.

$$\begin{matrix}t \times {X}_{l} = {SX}_{l} [ \begin{matrix}0 & - {T}_{z} & {T}_{y} \\ {T}_{z} & 0 & - {T}_{x} \\ - {T}_{y} & {T}_{z} & 0\end{matrix} ] {X}_{l} & ( 2 \text{-} 10 ) \\ {X}_{r}^{T} {EX}_{l} = 0 & ( 2 \text{-} 11 ) \\ E = RS = R [ \begin{matrix}0 & - {T}_{z} & {T}_{y} \\ {T}_{z} & 0 & - {T}_{x} \\ - {T}_{y} & {T}_{x} & 0\end{matrix} ] & ( 2 \text{-} 12 )\end{matrix}$$

The epipolar constraint in 2-11 is the result of this derivation and E is the essential matrix which is defined as E=RS where R is the rotation matrix. Using this constraint, two points in camera coordinates can be inserted into equation 2-11 and if the result is zero then the points satisfy the epipolar constraint, if the result is greater than zero then no match is made. The epipolar constraint can be rewritten in terms of the image pixel coordinates using the camera intrinsic parameters, such the matrix M is the camera matrix is:

$$M = [ \begin{matrix}{f}_{x} & 0 & {c}_{x} \\ 0 & {f}_{y} & {c}_{y} \\ 0 & 0 & 1\end{matrix} ] \qquad ( 2 \text{-} 13 )$$

Then the image pixel coordinates xl relate to the point's camera coordinates as 3-14.

Xᵢ=M⁻¹xₗ (2-14)

The fundament matrix F then relates to the essential matrix through the camera matrices of the stereo pair as follows.

F=Mᵣ^{-T}EMₗ⁻¹ (2-15)

The epipolar constraint can be written as in 2-16.

xᵣ^{T}Fxₗ=0 (2-16)

The epipolar constraint leaves ambiguities for stereo cameras, and the ambiguities can be resolved with a third camera is needed. Matches with are third camera are made as follows 1) an epipolar line is projected in camera two, 2) for all particles in camera two falling within a tolerance of the epipolar line from camera one, respective epipolar lines are projected from camera two into camera three, 3) An epipolar line from camera one is then projected into camera three, 4) Any particle within the intersecting epipolar lines from camera one and two in camera three is a correct match. However, three cameras may still not be able to eliminate the ambiguities completely. It has been shown previously that, for higher seed particle densities, the use of four cameras can drive down the ambiguities by a factor of 100 and nearly eliminates them all together. Maas, H. G., “Complexity analysis for the determination of image correspondences in dense spatial target fields,” International Archives of Photogrammetry and Remote Sensing XXIX: 102-107 (1992). A challenge with the four camera epipolar matching algorithm is that it is computationally expensive because for each particle found by a given camera an epipolar line has to be projected into the other three cameras and a search is completed for particles that satisfy the constraint.

In the experiments, to achieve real-time LPT system, the correspondence algorithm was implemented to scan over an arbitrary number of cameras searching for particles that satisfy the four camera matching criteria described by Maas (1992). To make this manageable and scalable, the multi-camera correspondence algorithm is separated into two stages. A first stage determines all possible two camera combinations and identifies particles within each camera pair that satisfy the epipolar constraint within a tolerance (measured by a predetermined threshold). As an example, for a six camera system, that leads to 15 unique cameras pairs. If the result of 2-16 is less than a set threshold then the corresponding match particle is stored by each camera and passed on to stage two. Logic for the first stage is shown below:

Multi-camera Correspondence Algorithm: Stage 1 - Find all epipolar
matches in stereo pairs

```
for all camera two combinations (A, B)
    for all camera A particles x_{A,i}
          for all camera B particles x_{B,j}
                Solve d = x_{A,i}^{T}F_{A,B}x_{B,j} (Equation 3-16)
                      if (d < threshold)
                            Add x_{A,i} to camera B's match list
                            Add x_{B,j} to camera A's match list
```

In the second stage all four camera groups, which is 15 unique groups for a 6 camera LPT system, are evaluated to determine if the matched two camera sets combine within a group to satisfy the four camera epipolar constraint. This involves searching all possible combinations of cameras in unique groups of four, labeled A, B, C, and D. This search becomes a combinatorial nested loop as shown below.

Multi-camera Correspondence Algorithm: Stage 2 - Evaluate four camera
epipolar criteria for stereo matches

```
n = total number of cameras
    for a = 0 to n
          for b = a to n
                for c = b to n − 1
                      for d = c to n − 1
                            Search each camera's match list for
                            corresponding particles (x_{A} , x_{B} ,
                            x_{C} , x_{D})
                            If four camera correspondence is found
                                  Add x_{A}, x_{B}, x_{C}, x_{D} to list for 3D
                                  reconstruction
```

The above algorithms separate the computation (evaluation of the epipolar constraint equation) from the judgment (comparing each camera's stereo match list to find four camera correspondence). This exposes parallelism in stage 1 where computational cost is high. This parallelism is utilized to create a real time algorithm for an arbitrary number of cameras. Once all four camera correspondences are found, they are packaged together and sent to the 3D reconstruction algorithm.

### 3D Reconstruction

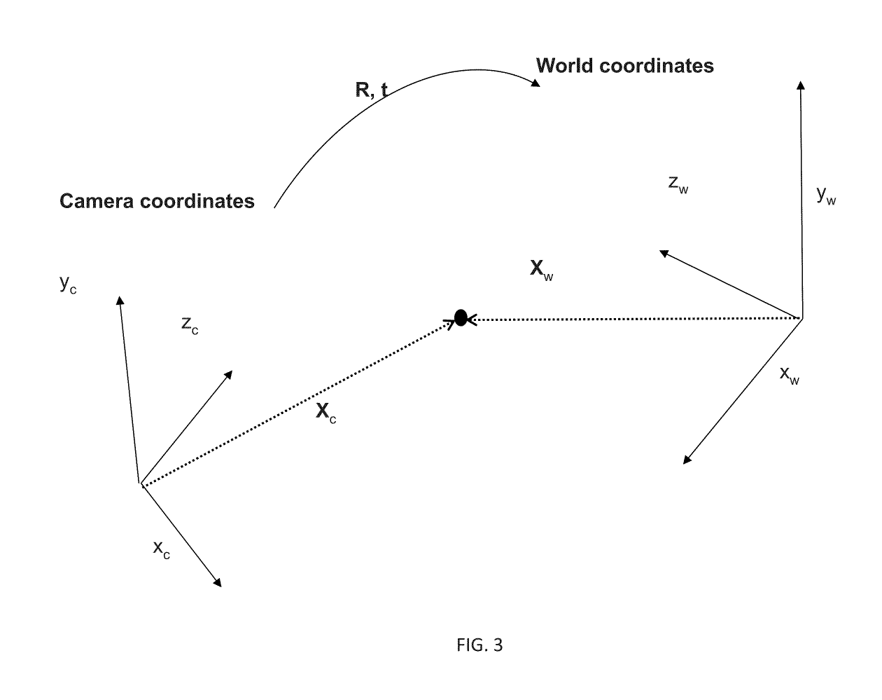

The 3D reconstruction algorithm is responsible for taking the matched particle images from four camera groups and computing a single 3D world coordinate from four sets of 2D image pixel coordinates. This can be accomplished through the classic camera projection model shown in FIG. 3, which relates camera and world coordinate systems through the extrinsic camera parameters. Given a pinhole camera model equation 2-10 describes the a projection from a point with world coordinates Xw to an camera coordinates Xc assuming the external camera parameters, 3×3 rotation matrix R and 3×1 translation vector t are known.

$${X}_{c} = [ \begin{matrix}{x}_{c} \\ {y}_{c} \\ {z}_{c}\end{matrix} ] = {RX}_{w} + t = R [ \begin{matrix}{x}_{w} \\ {y}_{w} \\ {z}_{w}\end{matrix} ] + t \qquad ( 2 \text{-} 17 )$$

The goal is to utilize equation 3-17 to create a transformation from camera coordinates to world coordinates. Equation 3-17 can be written in element notation as follows.

x_{c}=r₁₁x_{w}+r₁₂x_{w}+r₁₃x_{w}+Tₓ

y_{c}=r₂₁x_{w}+r₂₂y_{w}+r₂₃z_{w}+T_{y}

z_{c}=r₃₁x_{w}+r₃₂y_{w}+r₃₃z_{w}+T_{z} (2-18)

The camera coordinates can be normalized to for the homogeneous coordinates (x′, y′).

$${x}^{′} = \frac{{x}_{c}}{{z}_{c}} \\ {y}^{′} = \frac{{y}_{c}}{{z}_{c}} \qquad ( 2 \text{-} 19 )$$

Then substituting 2-18 into 2-19 provides a simple linear function relating the homogenous coordinates to the world coordinates through the external parameters of the camera.

$${x}^{′} = \frac{{r}_{11} {x}_{w} + {r}_{12} {y}_{w} + {r}_{13} {z}_{w} + {T}_{x}}{{r}_{31} {x}_{w} + {r}_{32} {y}_{w} + {r}_{33} {z}_{w} + {T}_{z}} \\ {y}^{′} = \frac{{r}_{21} {x}_{w} + {r}_{22} {y}_{w} + {r}_{23} {z}_{w} + {T}_{x}}{{r}_{31} {x}_{w} + {r}_{32} {y}_{w} + {r}_{33} {z}_{w} + {T}_{z}} \qquad ( 2 \text{-} 20 )$$

Finally the intrinsic parameters, focal length (fx, fy) in pixels and image center (cx, cy), and undistorted pixel coordinates (xₚ, yₚ) can be used to calculate the homogenous coordinates for substitution into 2-21.

$${x}^{′} = \frac{{x}_{p} - {c}_{x}}{{f}_{x}} \\ {y}^{′} = \frac{{y}_{p} - {c}_{y}}{{f}_{y}} \qquad ( 2 \text{-} 21 )$$

Now, the direct transformation process from 2D undistorted image pixel coordinates to 3D world coordinates is complete. There are now two equations for each camera, which can be rearranged into the form AX_{w}=b.

(x′r₃₁−r₁₁)x_{w}+(x′r₃₂−r₁₂)y_{w}+(x′r₃₃−r₁₃)z_{w}= [symbol] ₓx′T_{z}

(y′r₃₁−r₂₁)x_{w}+(y′r₃₂−r₂₂)y_{w}+(y′r₃₃−r₂₃)z_{w}= [symbol] _{y}y′T_{z} (2-22)

Where A and b are comprised of sub matrices Ai and bi for each camera i to N:

$$\begin{matrix}\begin{matrix}A = [ \begin{matrix}{A}_{1} \\ {A}_{i} \\ ⋮ \\ {A}_{N}\end{matrix} ] & b = [ \begin{matrix}{b}_{1} \\ {b}_{i} \\ ⋮ \\ {b}_{N}\end{matrix} ]\end{matrix} & ( 2 \text{-} 23 ) \\ {A}_{i} = [ \begin{matrix}{x}_{n , i} {r}_{31} - {r}_{11} & {x}_{n , i} {r}_{32} - {r}_{12} & {x}_{n , i} {r}_{33} - {r}_{13} \\ {y}_{n , i} {r}_{31} - {r}_{21} & {y}_{n , i} {r}_{32} - {r}_{22} & {y}_{n , i} {r}_{33} - {r}_{23}\end{matrix} ] ; \\ {b}_{i} = [ \begin{matrix}{T}_{x} - {x}_{n , i} {T}_{z} \\ {T}_{y} - {y}_{n , i} {T}_{z}\end{matrix} ] & ( 2 \text{-} 24 )\end{matrix}$$

This linear system of equations can be solved for 3D coordinates Xw using a linear least squares solver including QR factorization, such as a Householder rotation and backward substitution, or Singular Value Decomposition (SVD). See, Heath, “Scientific Computing: An Introductory Survey,” The McGraw-Hill Companies, Inc (2002). The resulting core of the 3D reconstruction algorithm is shown below.

3D Reconstruction Algorithm

```
        for camera i = 1 to N
                k = i * 2;
                x′ = ( x_{p,i} − c_{x,i} ) / f_{x,i}
                y′ = ( y_{p,i} − c_{y,i} ) / f_{y,i}
```

| | |
|---|---|
| A(k−1, 1) | = x′ * Rᵢ(3,1) − Rᵢ(1,1) |
| A(k−1, 2) | = x′ * Rᵢ(3,2) − Rᵢ(1,2) |
| A(k−1, 3) | = x′ * Rᵢ(3,3) − Rᵢ(1,3) |
| A(k, 1) | = y′ * Rᵢ(3,1) − Rᵢ(2,1) |
| A(k, 2) | = y′ * Rᵢ(3,2) − Rᵢ(2,2) |
| A(k, 3) | = y′ * Rᵢ(3,3) − Rᵢ(2,3) |
| B(k−1) | = Tᵢ(1) − x′ * Tᵢ(3) |
| B(k) | = Tᵢ(2) − y′ * Tᵢ(3) |

```
        end
        Solve AX_{w}=B for world coordinate X_{w} using QR factorization
or SVD
```

Utilization of all four cameras from the correspondence group improve the conditioning and sensitivity of the least squares problem compared to conducting 3D correspondence with a minimum of two cameras.

### Tracking

In the experiments, tracking was conducted with a prior technique and with a new technique. The prior technique is multi-frame regression based tracking algorithm. See, Li, D., Y. Zhang, et al., “A multi-frame particle tracking algorithm robust against input noise,” Measurement Science and Technology 19: 1054012 (2008). Another technique was also developed and this algorithm is called Particle Priority matching. The Particle Priority matching algorithm is based on a finite difference approximation of particle velocity and strict two judgment approach with computationally inexpensive cost functions.

Multi-Frame Regression Based Tracking Algorithm

Li's regression algorithm is for 2D. The following modification is used in preferred embodiments and to enable 3D tracking.

(1) Initialize trajectories: for all particles in the current frame f, draw a search sphere around the i^{th} particle's location xᵢ^{ƒ} and identify all particles at the next frame, f+1 within the sphere. Create a two point trajectory for each of these candidate particles and the original particle in frame f.

(2) Extrapolate trajectory: proceed to next frame and fit existing trajectories with polynomials through linear least squares regression. The order of the polynomial used is a function of the number of particles in the trajectory; two point trajectories are fit exactly with first order polynomials while longer trajectories use a second order approximation as shown in equation (2-25). The ith particle's extrapolated position in the next frame \hat{x}ᵢ^{ƒ+1} can then be determined by equation (2-25). A, B and C are 3 by 1 vectors determined by regression and tf+1 is the time at the f+1 frame.

\hat{x}ᵢ^{ƒ+1}=At_{ƒ+1}²+Bt_{ƒ+1}+C (2-25)

(3) Establish search region: create a search sphere with radius r around \hat{x}ᵢ^{ƒ+1} based on the estimated velocity from the previously connected points in the trajectory as shown in equation (2-26), where t is time corresponding to the frame index subscript and α is a user defined constant. Then identify all particles that fall inside this sphere as candidates for the trajectory.

$$r = α \frac{{t}_{f + 1} - {t}_{f}}{{t}_{f} - {t}_{f - 1}} \vert {X}_{f} - {X}_{f - 1} \vert \qquad ( 2 \text{-} 26 )$$

(4) Evaluate cost function: for each candidate, a cost function is evaluated based on the smoothness of the trajectory. A candidate particle j with a cost value Φⱼ below a given threshold is added to the trajectory. If more than one candidate particle falls within the cost threshold then the trajectory is copied and a new trajectory branch is tracked in future frames. The cost function is adapted from Li et. al. equation (2-27).

$$\begin{matrix}{φ}_{j} = \frac{\sqrt{{\sum }_{k = 0}^{3} {\vert {D}_{k} - G {τ}_{k} - H \vert}^{2}}}{\sqrt{{\sum }_{k = 0}^{3} {\vert {D}_{k} \vert}^{2}}} & ( 2 \text{-} 27 ) \\ {\hat{D}}_{k} = G {τ}_{k} H & ( 2 \text{-} 28 )\end{matrix}$$

τₖ is the mid time between frame k and k+1. Dₖ is the particle displacement between frames k and k+1. G and H are 3 by 1 matrices determined from the regression process of equation (2-28).

(5) Remove short trajectories: check that each trajectory is active by identifying how many frames exist where no candidate particles were found. If a trajectory has not found a candidate particle for N_{gap} consecutive frames and has fewer than N_{True} frames then the trajectory is not tracked any further.

(6) Proceed tracking the trajectories through each frame completing steps (1) through (5) until all frames have been processed.

Particle Priority Strict Matching Algorithm

The regression above has a significant computational cost is significant. Tracking ambiguities are possible because multiple trajectories can match with the same particle in the new frame. Resolving ambiguities adds additional computational overhead. Preferred embodiments of the invention instead use a new algorithm developed for systems of the invention to maintain real time.

A preferred particle priority strict matching algorithm prevents tracking ambiguities by ensuring that candidate particles in the next frame (n+1) can match with only one trajectory at the current frame (n) based on minimizing a cost function. This is a strict matching algorithm because the matching cost is efficiently judged in two steps. First, candidate particles are assigned the trajectory that minimizes the cost function among all existing trajectories. In this step, a single trajectory may be an optimal match with several candidate particles. Therefore a second judgment step is used to break ambiguities. In the second step, trajectories sort their list of optimal candidate particles and select the one with the lowest cost. The cost function is only evaluated once. The Euclidian distance between a candidate at frame n+1 with the predicted trajectory position at frame n+1 can be used as the cost function. This approach is fast and provides good tracking for cases where particle displacement is small relative to particle spacing in each frame.

The Particle Priority Strict matching algorithm reduces computational cost and reduces tracking ambiguities. It can proceed as follows:

(1) Initialize trajectories: For all unmatched particles in frame n−1, initiate two point trajectories (xⁿ⁻¹, xⁿ) by adding the nearest neighboring particle in frame n to each particle in frame n−1, with each particle in frame n being matched with at most one particle in frame n−1. Proceed to the next frame.
(2) Extrapolate trajectory and search region: Extrapolate the trajectories to estimate the particle's position in the new frame n+1 with an approximation of velocity through the first order backward difference scheme. Then calculate the search radius r based on the magnitude of velocity multiplied by the time step. This search radius will define a sphere in object space centered at \hat{x}ᵢⁿ⁺¹.

$$\begin{matrix}{\hat{x}}_{i}^{f + 1} = {x}_{i}^{f} + {u}_{i}^{f} Δ t & ( 2 \text{-} 29 ) \\ {u}_{i}^{f} = \frac{{x}_{i}^{f} - {x}_{i}^{f - 1}}{Δ t} o ( + t ) & ( 2 \text{-} 30 ) \\ r = {‖ u ‖}_{2} t & ( 2 \text{-} 31 )\end{matrix}$$

(3) Evaluate cost function: For each candidate particle x_{c}ⁿ⁺¹ in frame n+1, loop through all trajectories calculating the distance d from the candidate particle x_{c}ⁿ⁺¹ to the extrapolated point of the trajectory \hat{x}ᵢⁿ⁺¹ (equation 3-32). If d is less than r then a cost function is evaluated. If the cost of adding the current candidate particle x_{c}ⁿ⁺¹ to the trajectory is less than any prior trajectory then this optimal candidate particle/trajectory match is temporarily stored. Once the candidate particle has evaluated the cost associated with all trajectories, it stored as a match in the optimal trajectory's list of optimal matches.

d=∥x_{c}^{f+1}−\hat{x}ᵢ^{f+1}∥₂ (2-32)

(4) Sort optimal candidates and select best match: Loop through each trajectory to sort its optimal candidate list and select the lowest cost candidate particle to extend the trajectory by one frame.
(5) Proceed: track the particles with existing trajectories through each frame completing steps (1) through (4) until all frames have been processed. If a trajectory fails to find an optimal candidate particle in the following frame, then remove the trajectory from the active trajectory list. All unmatched candidate particles in a frame will be used to initialize new trajectories in the following frame.

The Particle Priority algorithm is fast because it utilizes finite difference approximations and prevents tracking ambiguities by ensuring that particles in frame f+1 can match with only one trajectory based on minimizing the selected cost function. It is a strict matching algorithm because the matching cost is efficiently judged twice. First, the particle in the new frame picks the trajectory that minimizes the tracking cost, and then if a trajectory has been selected by multiple particles, it sorts them and selects the candidate that minimizes the cost function. The cost function is only evaluated once, but the resulting value is judged by both the particle and the trajectory. Therefore, even if two particles in frame f+1 match equally well with a trajectory, only one will be added.

The cost function can be changed based on the type of experiment being run. Utilizing the predicted position residual as a cost function is fast and provides good tracking for cases where particle displacement at each time step is small relative to particle spacing in the domain.

Another particle priority matching algorithm is set forth and is similar to the above.

(1) For an initial frame f−1, initiate two point trajectories by adding the nearest neighboring particle in frame f to each particle in frame f−1. Proceed to the next frame.

(2) Extrapolate the trajectories to estimate the particle's position in the new frame f+1 with an approximation of velocity through the first order backward difference scheme. Then calculate the search radius r based on the magnitude of velocity times the time step. This search radius will define a sphere in object space centered at \hat{x}ᵢ^{f+1} (with 2-20 through 2-32).

(3) For each of the particles x_{c}^{f+1} in frame f+1, loop through all trajectories calculating the distance d from the particle x_{c}^{f+1} to the extrapolated point of the trajectory \hat{x}ᵢ^{f+1}. If d is less than r then a cost function is evaluated. If the cost is less than any prior trajectory costs for that particle then the particle stores the trajectory and cost as the best match and proceeds to the next trajectory. The cost function can be simply d. Once the particle has tried to match with all trajectories, the particle and its lowest cost trajectory matched in the trajectory's candidate list in (2-32).

(4) After all particles at frame f+1 have tried to match with all trajectories then each trajectory sorts its candidate list and accepts its lowest cost match, extending the trajectory

Result Processing and Visualization Derived from LPT

Data processing and visualization traditionally take place offline and after the experiment or data gathering activity has been completed. Systems of the invention achieve real-time processing and visualization of results as the experiment is in progress. With the invention, derivative results can be obtained directly from the Lagrangian particle trajectories and the invention provides methods to visualize and interact with the results in real-time.

A Visualization Toolkit (VTK) provides an interactive visualization module for the real-time LPT system. This module provides the capability to view Lagrangian trajectories and/or a Eularian grid containing statistical values of the particle flow properties during an experiment in real time. The derived properties that are calculated for each reference frame are given in Table 2.

TABLE 2
Derived properties calculated for each reference frame

| Lagrangian | Eularian |
|---|---|
| Velocity | Velocity |
| Acceleration | Mass residual |
| Pressure gradient | Vorticity |
| | Reynolds Stress |
| | Turbulence Intensity |
| | Static Pressure |

Eularian properties of the particle flow field are enabled with statistical accumulator grid (SAG) technique that is introduced with the invention. The Eularian flow properties are derived and calculated assuming the particles are ideal tracers, which does not hold true for inertial particles in turbulent flows. Pseudo Eularian flow properties are calculated in the case inertial particles are being tracked. While the dynamics of inertial particles in turbulence are not well-understood, the present technique posits that it is possible to advance understanding by observing divergence between the pseudo flow properties and true flow properties.

Lagrangian Reference Frame

Particle Velocity and Acceleration

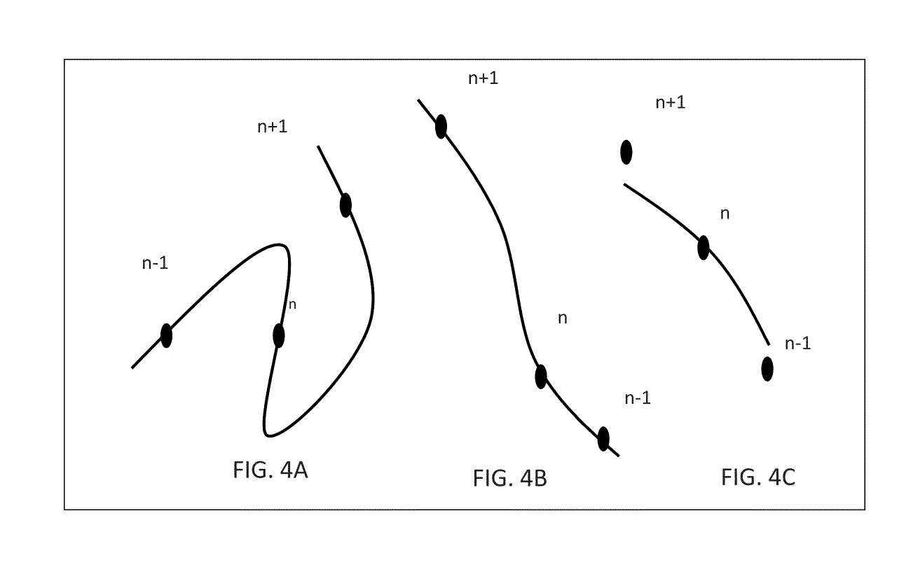

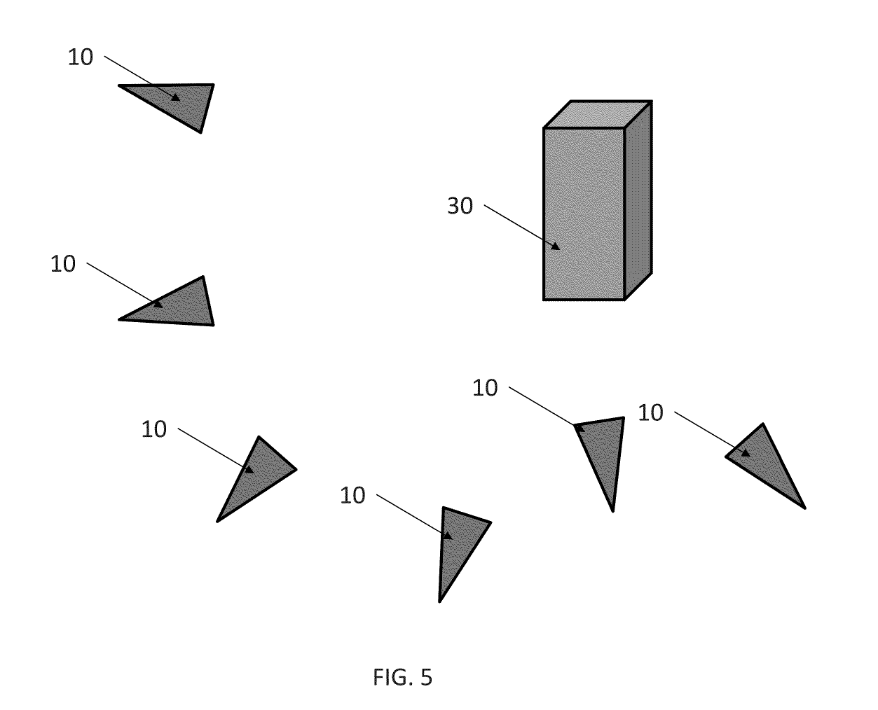

The Lagrangian velocity and acceleration of a particle along a trajectory are calculated based on second order central difference schemes and the reconstructed particle positions xⁿ as follows. Preferred embodiments of the invention increase frame rate to accurately estimate velocity and acceleration with a simple calculation by making the frame rate high enough to make particle trajectory appear substantially linear. This is illustrated in FIGS. 4A-4C, where frame rates are two low in the left (FIG. 4A) and middle trajectories (FIG. 4B), while the rightmost trajectory (FIG. 4C) is made substantially linear by a higher frame rate. The velocity and acceleration calculations are sensitive to uncertainties in the particle position, and the uncertainties will scale with 1/Δt for velocity and 1/Δt² for acceleration.

$$\begin{matrix}v \approx \frac{{x}^{n + 1} - {x}^{n - 1}}{2 Δ t} + o ( Δ {t}^{2} ) & ( 2 \text{-} 33 ) \\ a \approx \frac{{x}^{n + 1} - 2 {x}^{n} + {x}^{n - 1}}{Δ {t}^{2}} + o ( Δ {t}^{2} ) & ( 2 \text{-} 34 )\end{matrix}$$

Static Pressure Gradient

If velocity vector (v) and acceleration vector (a) are known for a particle moving in an incompressible fluid, the instantaneous static pressure gradient can be calculated based on the Navier-Stokes equations, shown below in vector notation. For inertial particles this is a pseudo pressure gradient for an imaginary flow in which the particles behave as ideal flow tracers. The resulting pressure gradients are used in preferred embodiments in the Eularian framework to calculate static pressures in cells of a finite volume grid through a method that is referred to as Instantaneous Lagrangian Acceleration (ILA) method:

$$\begin{matrix}a = \frac{\partial v}{\partial t} v + v \cdot ∇ \frac{1}{ρ} = ( p μ - {∇}^{2} v ) + & ( 2 \text{-} 35 ) \\ ∇ p = - ρ a + μ {∇}^{2} v & ( 2 \text{-} 36 )\end{matrix}$$

In 2-35 and 2-36μ is the dynamic viscosity and ρ is the density of the fluid. The acceleration and diffusion terms are discretized using second order central finite differences. The discretized acceleration term is given in 2-37 and the discretized Laplacian of velocity (∇²v) is given in equation 2-38.

$$\begin{matrix}a = \frac{( {x}^{n + 1} - 2 {x}^{n} + {x}^{n - 1} )}{Δ {t}^{2}} i + \frac{( {y}^{n + 1} - 2 {y}^{n} + {y}^{n - 1} )}{Δ {t}^{2}} j + \frac{( {z}^{n + 1} - 2 {z}^{n} + {z}^{n - 1} )}{Δ {t}^{2}} k + o ( Δ {t}^{2} ) & ( 2 \text{-} 37 ) \\ {∇}^{2} v = [ \begin{matrix}\frac{( {u}^{n + 1} - 2 {u}^{n} + {u}^{n - 1} )}{Δ {x}^{2}} + \\ \frac{( {u}^{n + 1} - 2 {u}^{n} + {u}^{n - 1} )}{Δ {y}^{2}} + \\ \frac{( {u}^{n + 1} - 2 {u}^{n} + {u}^{n - 1} )}{Δ {z}^{2}}\end{matrix} ] i [ \begin{matrix}\frac{( {v}^{n + 1} - 2 {v}^{n} + {v}^{n - 1} )}{Δ {x}^{2}} + \\ \frac{( {v}^{n + 1} - 2 {v}^{n} + {v}^{n - 1} )}{Δ {y}^{2}} + \\ \frac{( {v}^{n + 1} - 2 {v}^{n} + {v}^{n - 1} )}{Δ {z}^{2}}\end{matrix} ] j [ \begin{matrix}\frac{( {w}^{n + 1} - 2 {w}^{n} + {w}^{n - 1} )}{Δ {x}^{2}} + \\ \frac{( {w}^{n + 1} - 2 {w}^{n} + {w}^{n - 1} )}{Δ {y}^{2}} + \\ \frac{( {w}^{n + 1} - 2 {w}^{n} + {w}^{n - 1} )}{Δ {z}^{2}}\end{matrix} ] k & ( 2 \text{-} 38 )\end{matrix}$$

The (pseudo) static pressure gradient along a trajectory is calculated in real-time along with velocity and acceleration as the trajectories are being constructed. In practice the diffusion term is small compared to the acceleration. However, the added computation cost of including the diffusion term is rather small compared to the dynamic memory operations of adding particles to trajectories.

Trajectory Visualization

An open source C++ visualization library was used to develop an interactive rendering environment where the particles and their trajectories could be observed in real-time. The particles can be rendered individually as colored spheres based on the velocity or acceleration (for example from blue color to orange for slowly moving or accelerating particles), and/or they can be combined with a rendering of their path history trailing by a set number of frames. This provides a powerful verification method, where trajectories can be visually inspected to provide instant feedback on the impact of changes to system parameters (frame-rate, image segmentation threshold, etc.) on the tracking efficiency. Visualization of the particle paths can help to visually identify regions of high and low velocity and acceleration without interpolating to a Eularian grid. A user can interact with the rendering environment by zooming and/or spinning the view to observe the flow field from alternative viewpoints.

Eularian Reference Frame

Interpolate or otherwise assigning the Lagrangian properties to a fixed Eularian grid permits comparisons with traditional point wise flow measurement equipment, such as hot-wire anemometers, and CFD can be made. In addition by structuring the data on a grid, other properties of the (pseudo) flow field can be calculated including: continuity, vorticity, Reynolds stress, turbulent kinetic energy, and static pressure. Preferred embodiments provide methods for collecting, storing and representing Lagrangian properties on a Eularian grid.

Statistical Accumulator Grid

A mechanism of statistically storing the Lagrangian properties over time and attributing them to fixed Cartesian grid has been developed for the invention and is referred to as the statistical accumulator grid (SAG). The SAG defines a structured Cartesian virtual finite volume grid, where each voxel contains an array of statistical accumulators. FIG. 5 shows an accumulator 30 that is viewed by 6 cameras 10. These accumulators are objects which accept instantaneous values of the Lagrangian properties and actively calculate statistical values for the each property including mean, variance and/or covariance. Each cell contains 12 statistical accumulators: three for velocity, three for acceleration, three for pressure gradient and three for the covariance of velocity. This grid is can be represented in the interactive rendering environment as a rectangular cube (as in FIG. 5) that can be resized and placed to cover a sub-volume of interest within the observed volume of the LPT cameras 10, six of which are shown in FIG. 5.

A preferred method for adding Lagrangian particle properties to the SAG is based weighted means and variances. Particle properties are added to all cells within a defined cell neighborhood with an associated weight based on the distance from the particle to the center of each cell. An example simple implementation of the cell neighborhood includes only the 26 cells immediately surrounding the cell which contains the particle. Then weight factors (a) are calculated based on the inverse of the distance as in equation 2-39.

a=∥xₚx_{ce l̅l̅}∥₂⁻¹ (2-39)

The weighted mean \hat{μ} is then calculated based on the instantaneous values X and weight factors a according to 3-40.

$$\hat{μ} = \frac{{\sum }_{i = 1}^{n} {a}_{i} {X}_{i}}{{\sum }_{i = 1}^{n} {a}_{i}} \qquad ( 2 \text{-} 40 )$$

The weighted variance and covariance are calculated based iterative Monte Carlo estimators in equations 2-41 and 2-42, respectively.

$$\begin{matrix}{\hat{σ}}_{n}^{2} = \frac{{\overline{a}}_{n} - {a}_{n}}{{\overline{a}}_{n}} {\hat{σ}}_{n - 1}^{2} + \frac{{a}_{n}}{{\overline{a}}_{n} - {a}_{n}} {( {X}_{n} - {\hat{μ}}_{n} )}^{2} & ( 2 \text{-} 41 ) \\ {\hat{c}}_{n} = \frac{{\overline{a}}_{n} - {a}_{n}}{{\overline{a}}_{n}} {\hat{c}}_{n - 1} + \frac{{a}_{n}}{{\overline{a}}_{n} - {a}_{n}} ( {X}_{1 , n} - {\hat{μ}}_{1 , n} ) ( {X}_{2 , n} - {\hat{μ}}_{2 , n} ) & ( 2 \text{-} 42 )\end{matrix}$$

The obtained mean values and variance/covariance serve as the foundation to calculate the distributions of mass residual, vorticity, Reynolds stress, turbulent kinetic energy, and static pressure.

Mass Residual and Vorticity

Conservation of mass across the virtual finite volume grid can be a good indicator of how well the particles are tracking the flow field. If particles experience preferential concentration due to inertial effects, then the flow field observed through filter of particle motion can be compressible. This can be detectable if the mass residual resulting from solving the continuity equation under the assumption of compressibility is significant.

The continuity equation simplifies to reads as follows for incompressible flow fields.

$$\frac{\partial \overline{u}}{\partial x} + \frac{\partial \overline{v}}{\partial y} + \frac{\partial \overline{w}}{\partial z} = 0 \qquad ( 2 \text{-} 43 )$$

Where the mass residual in each cell (i,j,k) of size [Δx, Δy, Δz] can be calculated based on second order central finite difference approximations of the velocity gradients as in 2-44.

$$mass resdiual in cell [ i , j , k ] = ( \frac{{\overline{u}}_{i + 1} - {\overline{u}}_{i - 1}}{2 Δ x} ) + ( \frac{{\overline{v}}_{j + 1} - {\overline{v}}_{j - 1}}{2 Δ y} ) + ( \frac{{\overline{w}}_{k + 1} - {\overline{w}}_{k - 1}}{2 Δ z} ) \qquad ( 2 \text{-} 44 )$$

Once the mean velocities ū, v̅ and w̅ are determined through hundreds or thousands of particle observations per cell, the mass residuals can be calculated in a domain marching scheme starting from one corner of the grid and traversing each row until all rows and columns have been covered.

Vorticity is a useful property derived from the velocity field that can provide an alternative way of inspecting a flow field. It is a vector field corresponding to rotation in the flow and can be calculated from the velocity spatial gradient crossed with the velocity vector (2-45).

$$ω = ∇ \times v = ( \frac{\partial w}{\partial y} - \frac{\partial v}{\partial z} ) i + ( \frac{\partial u}{\partial z} - \frac{\partial w}{\partial x} ) j + ( \frac{\partial v}{\partial x} - \frac{\partial u}{\partial y} ) k \qquad ( 2 \text{-} 45 )$$

The discretized form of the vorticity equation is based on second order central differencing of the velocity field as given in 2-46.

$$ω = ∇ \times \overline{v} = ( \frac{{\overline{w}}_{j + 1} - {\overline{w}}_{j - 1}}{2 Δ y} \frac{{\overline{v}}_{k + 1} - {\overline{v}}_{k - 1}}{2 Δ z} ) i ( + \frac{{\overline{u}}_{k + 1} - {\overline{u}}_{k - 1}}{2 Δ z} \frac{{\overline{w}}_{i + 1} - {\overline{w}}_{i - 1}}{2 Δ x} ) j ( + \frac{{\overline{v}}_{i + 1} - {\overline{v}}_{i - 1}}{2 Δ x} \frac{{\overline{u}}_{j + 1} - {\overline{u}}_{j - 1}}{2 Δ y} ) k \qquad ( 2 \text{-} 46 )$$

Reynolds Stress

The Reynolds stress properties aid understanding of the anisotropic nature of turbulence in fluids. Reynolds stress is a tensor that describes variance and covariance of the fluctuating velocity components in turbulent flow and serves as a key component in Reynolds Averaged Navier Stokes (RANS) turbulence models, such as the k-ε model. To see how Reynolds stress plays a role in fluid flow, start with the Navier-Stokes equations for incompressible flow of Newtonian fluids can be summarized in vector notation as follows

$$ρ ( \frac{\partial v}{\partial t} + v \cdot ∇ v ) = - ∇ p + μ {∇}^{2} v \qquad ( 2 \text{-} 47 )$$

And in Einstein summation convention as

$$\frac{\partial {u}_{i}}{\partial t} + {u}_{j} \frac{\partial }{\partial {x}_{j}} {u}_{i} = + \frac{1}{ρ} \frac{\partial p}{\partial {x}_{i}} v \frac{{\partial }^{2} {u}_{i}}{\partial {x}_{j}^{2}} \qquad ( 2 \text{-} 48 )$$

When the statistical nature of the flow is of interest for studies of turbulence, the Reynolds Averaged Navier-Stokes form of the equations can be used. In this formulation the velocities are represented as two components, the mean component of velocity ūᵢ and fluctuating component of velocity u′ᵢ.

uᵢ=ūᵢu [symbol] (2-49)

Based on this assumption and through rules of ensemble averaging, the well-known Reynolds Averaged Navier Stokes equations are given in 2-50:

$$\frac{\partial {\overline{u}}_{i}}{\partial t} + {\overline{u}}_{j} \frac{\partial \overline{u}}{\partial {x}_{j}} = \frac{1}{ρ} \frac{\partial }{\partial {x}_{j}} ( \overline{p} {δ}_{ij} μ + \frac{\partial {\overline{u}}_{i}}{\partial {x}_{j}} {τ}_{ij}^{′} + ) \qquad ( 2 \text{-} 50 )$$

Where τ′ᵢⱼ is the Reynolds stress tensor defined by the following notation.

$$\begin{matrix}{τ}_{ij}^{′} = - ρ \overline{{u}_{i}^{′} {u}_{j}^{′}} \\ = - ρ [ \begin{matrix}\overline{{u}_{1}^{′} {u}_{1}^{′}} & \overline{{u}_{1}^{′} {u}_{2}^{′}} & \overline{{u}_{1}^{′} {u}_{3}^{′}} \\ \overline{{u}_{2}^{′} {u}_{1}^{′}} & \overline{{u}_{2}^{′} {u}_{2}^{′}} & \overline{{u}_{2}^{′} {u}_{3}^{′}} \\ \overline{{u}_{3}^{′} {u}_{1}^{′}} & \overline{{u}_{3}^{′} {u}_{2}^{′}} & \overline{{u}_{3}^{′} {u}_{3}^{′}}\end{matrix} ] \\ = - ρ [ \begin{matrix}\overline{{u}^{′2}} & \overline{{u}^{′} {v}^{′}} & \overline{{u}^{′} {w}^{′}} \\ \overline{{v}^{′} {u}^{′}} & \overline{{v}^{′2}} & \overline{{v}^{′} {w}^{′}} \\ \overline{{w}^{′} {u}^{′}} & \overline{{w}^{′} {v}^{′}} & \overline{{w}^{′2}}\end{matrix} ]\end{matrix} \qquad ( 2 \text{-} 51 )$$

The Reynolds stress tensor is symmetric and contains six independent values, three shear stress terms corresponding to the covariance between each of the velocity components and three normal stress terms corresponding to the variance of each velocity component (u, v, and w). Reynolds stress components correspond to the mean and instantaneous velocities according to the definition of variance and covariance of samples as shown below.

$$\begin{matrix}\begin{matrix}\overline{{u}^{′2}} = Var ( u ) \\ = \frac{{\sum }_{r = 1}^{n} {( {u}_{r} - \overline{u} )}^{2}}{n}\end{matrix} & ( 2 \text{-} 52 ) \\ \begin{matrix}\overline{{u}^{′} {v}^{′}} = Cov ( u , v ) \\ = \frac{{\sum }_{r = 1}^{n} ( {u}_{r} - \overline{u} ) ( {v}_{r} - \overline{v} )}{n}\end{matrix} & ( 2 \text{-} 53 )\end{matrix}$$

By actively collecting the instantaneous velocity components of particles as they move through the statistical accumulator grid, the Reynolds stress tensor at each cell is simply calculated as the variance and covariance of the accumulated velocities at within the cell.

The Reynolds stress values are an important indicator of the nature of turbulence. For example, in anisotropic turbulence often found in natural flows, the normal and shear terms can provide a better characterization of how the turbulences varies in each direction. This information can be helpful in the design of fluid systems. With the ability to derive distributions of Reynolds stress, an LPT system of the invention can provide a way to quantitatively compare measured values with results from common RANS turbulence models.

The turbulent kinetic energy is energy contained in turbulent eddies of a flow field and is related to the Reynolds stress tensor in that it is the sum of the component velocity variances along the diagonal over two (2-54).

$$\begin{matrix}K = \frac{1}{2} \overline{{u}_{i}^{′2}} \\ = \frac{1}{2} ( \overline{{u}^{′2}} \overline{{v}_{+}^{′2}} \overline{{w}_{+}^{′2}} )\end{matrix} \qquad ( 2 \text{-} 54 )$$

Static Pressure

The static pressure distribution is a desired output for many flow field measurement systems, such as PIV. A limitation of conventional PIV is that it is typically used to measure instantaneous flow velocities in a plane. Therefore assumptions have to be made regarding the out of plane terms in the Navier Stokes equation in order to solve for the pressure field. For 3D LPT in accordance with the invention, velocities in all three dimensions are known. Therefore, the solution for pressure becomes much more accessible. One output made available the real-time LPT system of the invention is the static pressure field based on particle velocity and acceleration. Two static pressure calculation methods can be used in preferred embodiments 1) RANS method and 2) Instantaneous Lagrangian Acceleration method. For incompressible flows the Navier-Stokes equations can be solved for the pressure gradient as shown in 2-55.

$$∇ p = - ρ ( \frac{\partial v}{\partial t} + v \cdot ∇ v ) + μ {∇}^{2} v \qquad ( 2 \text{-} 55 )$$

Where the velocity vector field is known through measurement, the resulting pressure field is typically calculated based on solving the Pressure Poisson equation (2-56), which can be solved with an iterative sparse-matrix solver such as Successive Over Relaxation (SOR) or line integration method. See, Charonko, J. J., C. V. King, et al., “Assessment of pressure field calculations from particle image velocimetry measurements,” Measurement Science and Technology 21(10): 105401 (2010). The conditions at measurement domain boundaries are applied as Neumann boundary conditions, in which the pressure gradient is specified through 2-55.

$${∇}^{2} p = ∇ \{ - ρ ( \frac{\partial u}{\partial t} + u \cdot ∇ u ) + μ {∇}^{2} u \} \\ {∇}^{2} \overline{p} = ∇ Φ \qquad ( 2 \text{-} 56 )$$

The right and left hand sides of the pressure Poisson equation are discretized using second order central differences for the first and second derivatives as given in 2-56-1 and 2-56-2, respectively.

$$\begin{matrix}{∇}^{2} \overline{p} \approx \frac{{\overline{p}}_{i + 1} - 2 {\overline{p}}_{i} + {\overline{p}}_{i - 1}}{Δ {x}^{2}} + \frac{{\overline{p}}_{j + 1} - 2 {\overline{p}}_{j} + {\overline{p}}_{j - 1}}{Δ {y}^{2}} + \frac{{\overline{p}}_{k + 1} - 2 {\overline{p}}_{k} + {\overline{p}}_{k - 1}}{Δ {z}^{2}} & ( 2 \text{-} 56 \text{-} 1 ) \\ ∇ Φ \approx \frac{{Φ}_{i + 1} - {Φ}_{i - 1}}{2 Δ x} + \frac{{Φ}_{j + 1} - {Φ}_{j - 1}}{2 Δ y} + \frac{{Φ}_{k + 1} - {Φ}_{k - 1}}{2 Δ z} & ( 2 \text{-} 56 \text{-} 2 )\end{matrix}$$

After the pressure gradients at each location in the grid have been calculated, as will be discussed below, the pressure Poisson equation (2-56) can be solved iteratively using SOR. The pressure gradient is specified at the boundaries to create a Neumann boundary condition, where equation 2-55 is evaluated with first order forward differences. Two methods used to calculate the pressure gradients are discussed next.

RANS (Reynolds Averaged Navier-Stokes) Method:

For stationary flow fields, the steady state Reynolds Averaged Navier-Stokes formulation can be used to estimate the gradient of mean pressure as given in 2-57. For a real-time LPT system of the invention, velocity and Reynolds stress in each cell of the virtual finite volume grid are known through measurement, and therefore the pressure gradient can be readily evaluated the discretized second order accurate finite difference approximations given below.

$$∇ \overline{p} = \frac{\partial \overline{p}}{\partial {x}_{j}} {δ}_{ij} = - {\overline{u}}_{j} \frac{\partial {\overline{u}}_{i}}{\partial {x}_{j}} + \frac{1}{ρ} \frac{\partial }{\partial {x}_{j}} ( μ \frac{\partial {\overline{u}}_{i}}{\partial {x}_{j}} + {τ}_{ij}^{′} ) \\ {\overline{u}}_{j} \frac{\partial {\overline{u}}_{i}}{\partial {x}_{j}} \approx ( \overline{u} \frac{{\overline{u}}_{i + 1} - {\overline{u}}_{i - 1}}{2 Δ x} + \overline{v} \frac{{\overline{u}}_{j + 1} - {\overline{u}}_{j - 1}}{2 Δ y} + \overline{w} \frac{{\overline{u}}_{k + 1} - {\overline{u}}_{k - 1}}{2 Δ z} ) i + ( \overline{u} \frac{{\overline{v}}_{i + 1} - {\overline{v}}_{i - 1}}{2 Δ x} + \overline{v} \frac{{\overline{v}}_{j + 1} - {\overline{v}}_{j - 1}}{2 Δ y} + \overline{w} \frac{{\overline{v}}_{k + 1} - {\overline{v}}_{k - 1}}{2 Δ z} ) j + ( \overline{u} \frac{{\overline{w}}_{i + 1} - {\overline{w}}_{i - 1}}{2 Δ x} + \overline{v} \frac{{\overline{w}}_{j + 1} - {\overline{w}}_{j - 1}}{2 Δ y} + \overline{w} \frac{{\overline{w}}_{k + 1} - {\overline{w}}_{k - 1}}{2 Δ z} ) k \\ \frac{{\partial }^{2} {\overline{u}}_{i}}{\partial {x}_{j}^{2}} \approx ( \begin{matrix}\overline{u} \frac{{\overline{u}}_{i + 1} - 2 \overline{u} + {\overline{u}}_{i - 1}}{Δ {x}^{2}} + \\ \overline{v} \frac{{\overline{u}}_{j + 1} - 2 \overline{u} + {\overline{u}}_{j - 1}}{Δ {y}^{2}} + \\ \overline{w} \frac{{\overline{u}}_{k + 1} - 2 \overline{u} + {\overline{u}}_{k - 1}}{Δ {z}^{2}}\end{matrix} ) i + ( \begin{matrix}\overline{u} \frac{{\overline{v}}_{i + 1} - 2 \overline{v} + {\overline{v}}_{i - 1}}{Δ {x}^{2}} + \\ \overline{v} \frac{{\overline{v}}_{j + 1} - 2 \overline{v} + {\overline{v}}_{j - 1}}{Δ {y}^{2}} + \\ \overline{w} \frac{{\overline{v}}_{k + 1} - 2 \overline{v} + {\overline{v}}_{k - 1}}{Δ {z}^{2}}\end{matrix} ) j + ( \begin{matrix}\overline{u} \frac{{\overline{w}}_{i + 1} - 2 \overline{w} + {\overline{w}}_{i - 1}}{Δ {x}^{2}} + \\ \overline{v} \frac{{\overline{w}}_{j + 1} - 2 \overline{w} + {\overline{w}}_{j - 1}}{Δ {y}^{2}} + \\ \overline{w} \frac{{\overline{w}}_{k + 1} - 2 \overline{w} + {\overline{w}}_{k - 1}}{Δ {z}^{2}}\end{matrix} ) k \\ \frac{\partial {τ}_{ij}^{′}}{\partial {x}_{j}} \approx ρ ( \begin{matrix}\frac{( \overline{{u}_{i + 1}^{′2}} - \overline{{u}_{i - 1}^{′2}} ) + ( \overline{{v}^{′} {u}_{i + 1}^{′}} - \overline{{v}^{′} {u}_{i - 1}^{′}} ) + ( \overline{{w}^{′} {u}_{i + 1}^{′}} - \overline{{w}^{′} {u}_{i - 1}^{′}} )}{2 Δ x} + \\ \frac{( \overline{{u}_{j + 1}^{′2}} - \overline{{u}_{j - 1}^{′2}} ) + ( \overline{{v}^{′} {u}_{j + 1}^{′}} - \overline{{v}^{′} {u}_{j - 1}^{′}} ) + ( \overline{{w}^{′} {u}_{j + 1}^{′}} - \overline{{w}^{′} {u}_{j - 1}^{′}} )}{2 Δ y} + \\ \frac{( \overline{{u}_{k + 1}^{′2}} - \overline{{u}_{i - 1}^{′2}} ) + ( \overline{{v}^{′} {u}_{k + 1}^{′}} - \overline{{v}^{′} {u}_{k - 1}^{′}} ) + ( \overline{{w}^{′} {u}_{k + 1}^{′}} - \overline{{w}^{′} {u}_{k - 1}^{′}} )}{2 Δ z}\end{matrix} ) i + ρ ( \begin{matrix}\frac{( \overline{{u}^{′} {v}_{i + 1}^{′}} - \overline{{u}^{′} {v}_{i - 1}^{′}} ) + ( \overline{{v}_{i + 1}^{′2}} - \overline{{v}_{i - 1}^{′2}} ) + ( \overline{{w}^{′} {v}_{i + 1}^{′}} - \overline{{w}^{′} {v}_{i - 1}^{′}} )}{2 Δ x} + \\ \frac{( \overline{{u}^{′} {v}_{j + 1}^{′}} - \overline{{u}^{′} {v}_{j - 1}^{′}} ) + ( \overline{{v}_{j + 1}^{′2}} - \overline{{v}_{j - 1}^{′2}} ) + ( \overline{{w}^{′} {v}_{j + 1}^{′}} - \overline{{w}^{′} {v}_{j - 1}^{′}} )}{2 Δ y} + \\ \frac{( \overline{{u}^{′} {v}_{k + 1}^{′}} - \overline{{u}^{′} {v}_{k - 1}^{′}} ) + ( \overline{{v}_{k + 1}^{′2}} - \overline{{v}_{k - 1}^{′2}} ) + ( \overline{{w}^{′} {v}_{k + 1}^{′}} - \overline{{w}^{′} {v}_{k - 1}^{′}} )}{2 Δ z}\end{matrix} ) j + ρ ( \begin{matrix}\frac{( \overline{{u}^{′} {w}_{i + 1}^{′}} - \overline{{u}^{′} {w}_{i - 1}^{′}} ) + ( \overline{{v}^{′} {w}_{i + 1}^{′}} - \overline{{v}^{′} {w}_{i - 1}^{′}} ) + ( \overline{{w}_{i + 1}^{′2}} - \overline{{w}_{i - 1}^{′2}} )}{2 Δ x} + \\ \frac{( \overline{{u}^{′} {w}_{j + 1}^{′}} - \overline{{u}^{′} {w}_{j - 1}^{′}} ) + ( \overline{{v}^{′} {w}_{j + 1}^{′}} - \overline{{v}^{′} {w}_{j - 1}^{′}} ) + ( \overline{{w}_{j + 1}^{′2}} - \overline{{w}_{j - 1}^{′2}} )}{2 Δ y} + \\ \frac{( \overline{{u}^{′} {w}_{k + 1}^{′}} - \overline{{u}^{′} {w}_{k - 1}^{′}} ) + ( \overline{{v}^{′} {w}_{k + 1}^{′}} - \overline{{v}^{′} {w}_{k - 1}^{′}} ) + ( \overline{{w}_{k + 1}^{′2}} - \overline{{w}_{k - 1}^{′2}} )}{2 Δ z}\end{matrix} ) k \qquad ( 2 \text{-} 57 )$$

To determine the resulting pressure field the Pressure Poisson equation in 2-56 is formed in a two-step process. In the first step, equation 2-57 is evaluated at each cell to determine the x, y and z pressure gradients in a domain marching scheme, moving from one corner and sweeping through all rows and columns. These pressure gradients are then used as the source term for the Poisson equation 2-58.

∇² p̅=∇·{∇ p̅} (2-58)

The right and left hand sides of the Poisson equation are discretized using second order central differences for the first and second derivatives as given in 2-59 and 3-60 respectively.

$$\begin{matrix}{∇}^{2} \overline{p} = \frac{{\overline{p}}_{i + 1} - 2 {\overline{p}}_{i} + {\overline{p}}_{i - 1}}{Δ {x}^{2}} + \frac{{\overline{p}}_{j + 1} - 2 {\overline{p}}_{j} + {\overline{p}}_{j - 1}}{Δ {y}^{2}} + \frac{{\overline{p}}_{k + 1} - 2 {\overline{p}}_{k} + {\overline{p}}_{k - 1}}{Δ {z}^{2}} & ( 2 \text{-} 59 ) \\ ∇ \cdot \{ ∇ \overline{p} \} = \frac{∇ {\overline{p}}_{i + 1} - ∇ {\overline{p}}_{i - 1}}{2 Δ x} + \frac{∇ {\overline{p}}_{j + 1} - ∇ {\overline{p}}_{j - 1}}{Δ y} + \frac{∇ {\overline{p}}_{k + 1} - ∇ {\overline{p}}_{k - 1}}{Δ z} & ( 2 \text{-} 60 )\end{matrix}$$

The Poisson equation can then be solved iteratively using SOR with Neumann boundary conditions applied through evaluating 2-55 with first order forward differences.

Instantaneous Lagrangian Acceleration Method:

An alternative approach to calculating the static pressure field was derived for preferred embodiments and is based on the instantaneous Lagrangian acceleration calculation and resulting local trajectory pressure gradient, as discussed above with respect to the SAG of FIG. 5. In this method, the local pressure gradient along each trajectory is accumulated into the SAG in the same weighted fashion as velocity and acceleration. Then the method to solve for the individual cell pressures is the same as for the RANS method, where equation 2-58 is solved using SOR and iterated until convergence.

### 3D Visualization

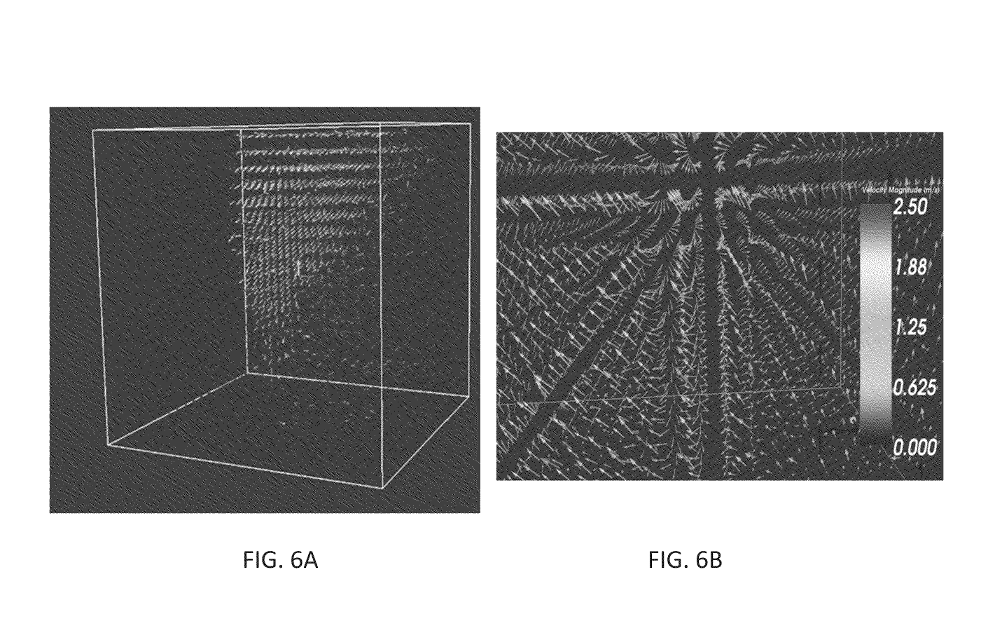

The Eularian properties of the particle flow field can be visualized using the interactive rendering environment, implemented with VTK. The vector fields of velocity and vorticity are displayed as vectors and can be colored by magnitude as shown in FIGS. 6A and 6B. The vectors can be set to uniform scaling or sized based on the magnitude to emphasize the relative spatial differences. As with the Lagrangian trajectory visualization, the user can interactively zoom and rotate the vector field.

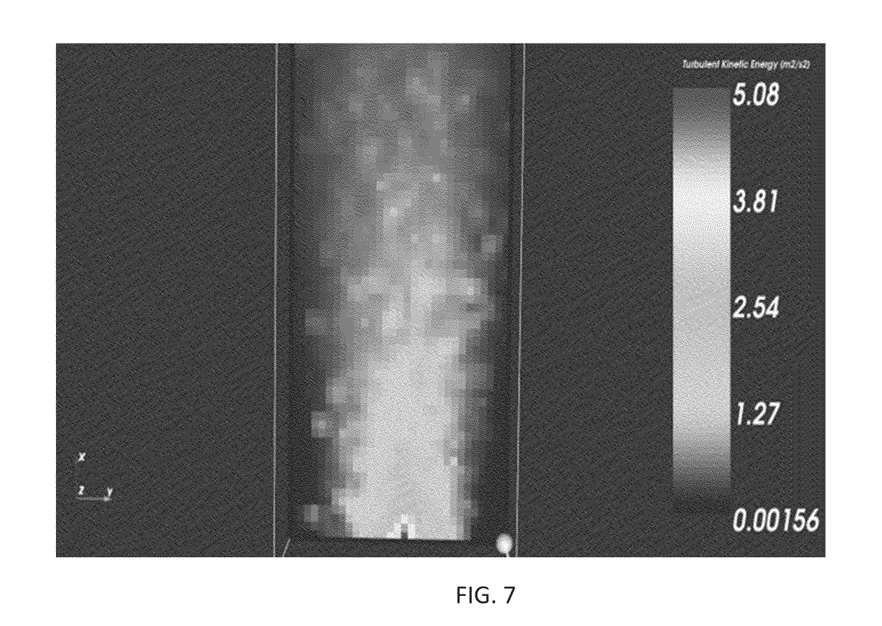

An interactive view plane tool has been implemented to probe the volume and view planar distributions of mass residual, turbulence intensity, velocity variance, static pressure and sample count per cell. FIG. 7 shows the interactive view plane tool displaying turbulence intensity profile along the center plane of an axisymmetric jet. The user can click, grab, move and orient the plane in order to view different slices of the domain.

### Real Time LPT System Advantages

The algorithms and real-time LPT system provide particle information from imaging and detection, to solving the correspondence problem, 3D reconstruction, tracking and result visualization in real-time. Various advantages will be apparent to artisans.

The image processing and particle detection algorithm is based on image segmentation and centroid calculation based on the spatial moments of the contours around particle image “blobs”. Image distortion is removed through the use of an 8 parameter lens distortion model.

The multi-camera correspondence algorithm is based upon strict match criteria in which four cameras and must simultaneously satisfy the epipolar constraint in order for a set of particle images to be considered a match. The algorithm being divided into two stages exposes parallelism in evaluation of the epipolar constraint. The combinatorial algorithm can work with an arbitrary number of cameras to allow easy scaling with a multi-camera system.

The 3D reconstruction algorithm is based on the classical pinhole camera projection model and the particle's object coordinates are solved based on the linear least squares formulation involving all four cameras in a correspondence group.

The new Particle Priority tracking algorithm was developed based on given new particles priority in matching with trajectories at each time step. This method sorts matches based on a computationally inexpensive cost function and minimized tracking ambiguity by strictly matching each particle with only one trajectory.

The result processing and visualization module can display results in the Lagrangian and Eularian reference frame. The Lagrangian properties calculated can include velocity, acceleration and (pseudo) static pressure gradient. These Lagrangian properties can be attributed to a structured Cartesian grid comprised of statistical accumulators, through weighted means, variance and/or covariance. Eularian properties including mass residual, vorticity, Reynolds stress, turbulence intensity and static pressure can be derived from the velocity field mean and variance.

### Real-Time Multi-Layer Parallel Data Processing Framework

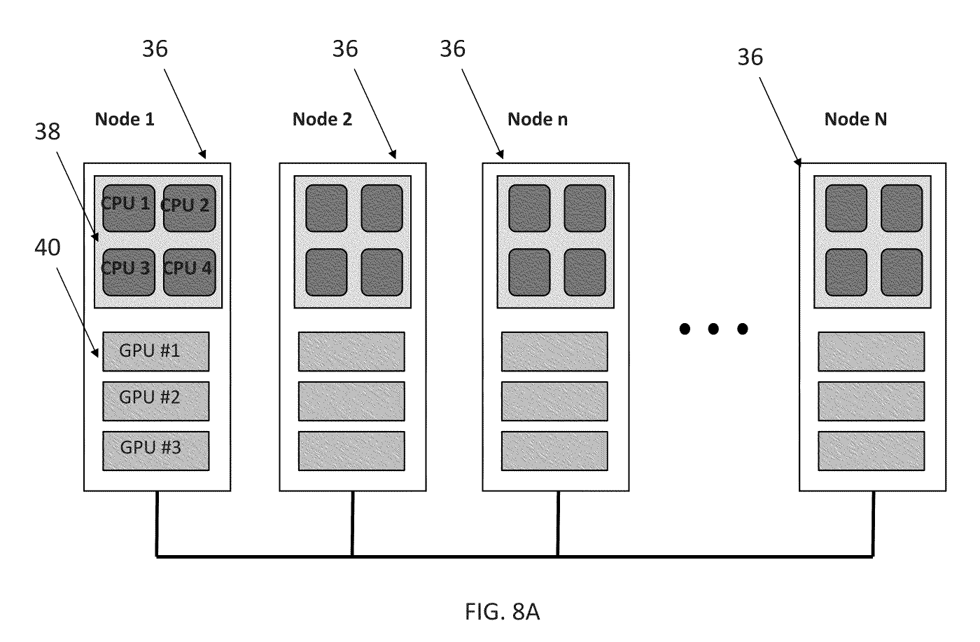

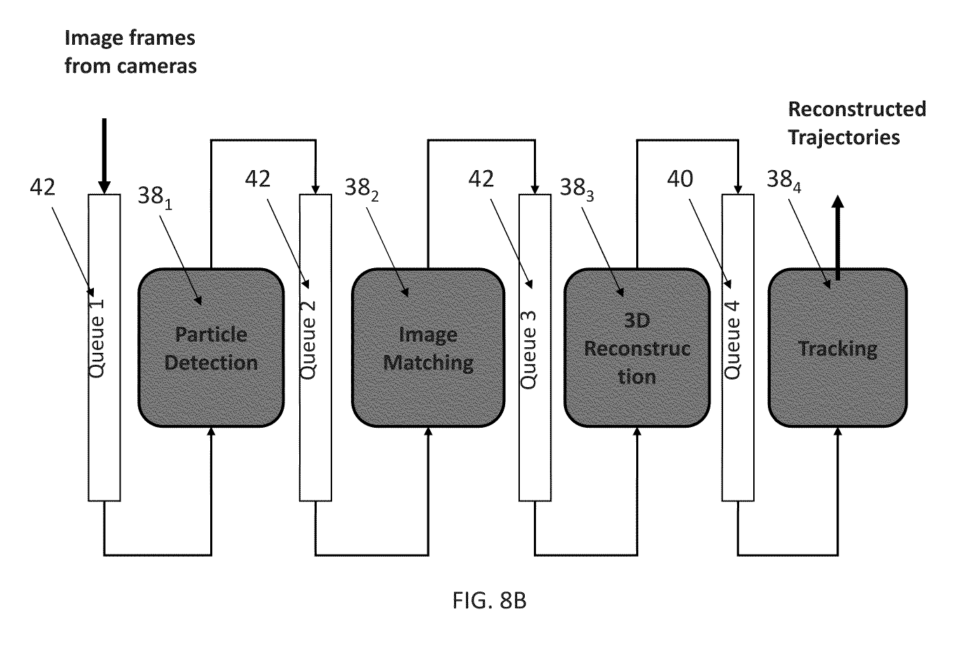

A framework to created efficient parallel processing utilizes fine and coarse grain parallelism on heterogeneous computing architectures. This can be implemented with a cluster of computing nodes 36 where each node is comprised of a multi-core CPU 38 and a group of graphics processors (GPU) 40, as illustrated in FIG. 8A. The LPT real-time processing frame work is divided into 1) compute node streaming framework, and 2) compute cluster message passing framework.

The compute node 36 streaming framework is a pipelining scheme where each of the five major LPT tasks (particle detection, correspondence, 3D reconstruction, tracking, visualization) are connected in a pipeline and data is processed in parallel with multiple CPU threads handling the tasks. The most compute intensive tasks of particle detection and multi-camera correspondence are broken down further to expose parallelization across multiple CPU threads and the GPU accelerators. Advantageously, this framework is designed to work on any multi-core computer including commodity workstations or laptops in addition to nodes of a high performance cluster.

The compute cluster message passing framework is can pipeline the LPT data by groups of frames to be processed in parallel on a cluster of nodes running the compute node streaming framework. This multi-layer parallel processing approach allows the real-time LPT system to scale with increasing number of cameras, increasing frame rates and higher seed particle densities.

Compute Node Pipelined Streaming Framework

Multi-Threaded Pipelining Scheme

The compute node streaming framework leverages multi-core processors by pipelining the LPT data across CPU cores as it streams in from the cameras. Each LPT task is assigned a group of CPU threads to process the data in parallel. A thread of execution is a unit of work that is processed by a CPU, and each CPU can be scheduled to work on multiple threads at a time. The multi-threaded data processing pipeline is implemented as a classical multiple producer/consumer model, where each task is a consumer for the data output by the preceding task and producer of data for the succeeding task. Worker threads need to be synchronized to ensure that data flows through the pipeline efficiently without accumulating and overrunning memory.

A concurrent queue data structure can be used. The concurrent queue is a First-In-First-Out FIFO data structure. Data packets are placed in the top of the queue by a producer thread(s) and removed from the bottom by a consumer thread(s). In the LPT system, the packets of data are called frames (data that is associated with an image frame), which could be arrays of image frames from the cameras, arrays of 2D particle image centroids, or arrays of 3D particle locations at a given time step. As shown in FIG. 8B, data is queued in queues 42 for processor cores 38ₙ. The cores 38ₙ can be multiple processors (cores on a single chip, physical processors, or even virtual processors (hyperthreading). However, the group of processors on a node should have shared memory. As frames stream in from the cameras they are placed in the top of the first queue and removed by the image processing thread. The image processing thread detects the particles, removes image distortion, places an array of particle centroids into the second queue, and grabs another set of images from the first queue. The multi-camera correspondence thread removes the arrays of particle centroids from queue two, finds all the matching particle images, places the matches in queue three, and grabs the next set of particle centroids. The 3D reconstruction thread removes the matches from queue 3, solves for the 3D coordinates of each particle and places the frames of 3D particles in queue 4 for the tracking thread.

Each queue is assigned a set amount of space. Therefore, each thread in the pipeline must consume frames fast enough to prevent queue over flow. If a thread cannot keep up, then the pipeline breaks down and data is lost. To prevent this, each of the four major tasks can be optimized to reach a balanced data process rate across all tasks. The first two tasks, Particle detection and multi-camera correspondence, are the most computationally expensive. These two tasks can be optimized as follows.

Image Processing and Particle Detection Parallelization

As discussed above, the smart cameras 10 aid the image processing task. Each camera completes the image segmentation to identify the particle image “blobs” and transfers up to 1000× less data for processing than if the image segmentation were left for processing section. In the preferred systems, the computer resources are left with centroid detection and distortion removal. The remaining particle detection and distortion are parallelized on the computer processing section by assigning a thread to each camera. Experiments show this to be very effective in avoiding a bottleneck and data accumulation problem of many prior systems. Another potential bottleneck is multi-camera correspondence issue. This is addressed with a new parallelization approach in preferred embodiments.

Camera Correspondence Algorithm Parallelization

A key step in this routine is to break it into two threads; one thread to evaluate the epipolar constraint equation for all particles of unique camera pairs and one thread to test for satisfaction of the four camera correspondence criteria. As discussed above, the first stage of this problem is the most computationally expensive, but it also exposes a significant level of parallelism. In each camera pair AB, the particles from camera A can be compared with those in camera B without any dependencies. This problem can be efficiently solved on the GPU as it is highly data parallel, while the same operation (epipolar constraint evaluation) is computed for different data.

A GPU implementation of the camera correspondence problem was demonstrated with NVidia's Compute Unified Device Architecture (CUDA) programming paradigm. CUDA is an extension of the C/C++ language to allow efficient programming of graphics processors for general compute purposes. The parallel GPU algorithm for the correspondence problem used in an experimental embodiment is as follows:

(1) Initialize the GPU with the Fundamental matrices for all camera pairs and allocate memory for particle data.
(2) Grab a frame of particle centroid data from queue and asynchronously copy all particles from all cameras to the GPU
(3) On the GPU, a thread is generated for each particle in camera A of each camera pair. Each thread loops through all particles in camera B and evaluates the epipolar constraint equation.
(4) The CPU copies the resulting epipolar constraint residuals for each particle and sends the data to the second stage to evaluate four camera correspondence criteria.

Time Performance of Experimental Embodiment

The compute node pipelining scheme was tested using the PIV Standard images data set #352. This data set consists of 145 frames of particle data with approximately 300 particles per frame. Each of the LPT algorithms was verified for accuracy and ultimately tested within the nodal pipelining scheme to determine the real-time capability of the system. For the streaming algorithm to be considered real-time, no data accumulation can occur in the pipeline. Therefore, the slowest task in the pipeline determines the ability of the whole pipeline to reach real time processing with respect to the input camera frame rate. Testing the four cameras and data set #352, the slowest task was the image processing task which was able to operate at 467 frames per second assuming a seeding density of 300 particles per frame. With six cameras, the slowest task was the multi-camera correspondence algorithm which processed frames at 273 frames per second.

Compute Cluster Message Passing Framework

A compute cluster message passing framework provided by the invention achieves scaling with increased number of cameras, higher frame rates and seed particle densities. The cluster based parallel algorithm provides consistent results that are consistent with the serial version and not introduce tracking errors in the form of erroneous trajectories. It provides scalability and can scale from a minimum of three (preferably more, e.g. four or six or more) to hundreds of processors without significant reductions in speedup per processor added. It is flexible, modular and able to run any form of the compute node streaming.

Parallel Implementation Strategy

The LPT compute cluster parallel algorithm was implemented in an experimental system in C++ and Charm++, allowing the algorithm to be naturally expressed using object-oriented programming. Charm++ is an object-oriented parallel programming paradigm that acts as an extension to the C++ language. It allows programming objects (i.e.: data structures, classes, etc.) to be distributed across multiple processors and synchronously communicate by sending and receiving messages.

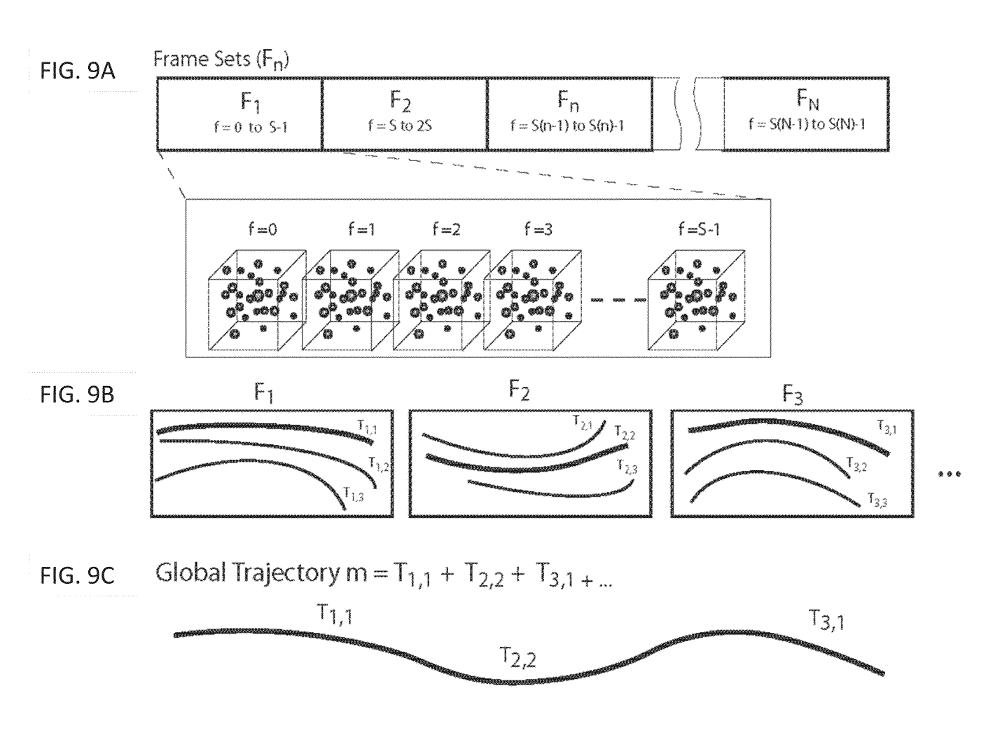

The general strategy used in the preferred algorithm is to first decompose the LPT data into multiple sets of consecutive frames. These frame-sets are distributed between a group of processors where trajectory segments are built in parallel by executing the node based pipelining scheme to simultaneously execute all LPT algorithms. The trajectory segments from each frame-set are then compared with all segments in adjacent frame-sets to be merged into longer global trajectories. FIGS. 9A-9C illustrate the parallel implementation. In FIG. 9A particle data is divided into N frame sets F of size S frames each; in FIG. 9B trajectory segments are built in parallel and given local ID T_{n,i}, In FIG. 9C trajectory segments are merged to create global trajectories and stored.

In FIGS. 9A-9C, T_{n,i} is the local trajectory segment ID for trajectory segment i in frame-set n, S is the frame-set size, a tunable parameter for parallel decomposition, Fₙ Frame-set ID for the n^{th} frame-set, N is the total number of frame-sets.

Data Decomposition

The first step in parallelizing the LPT algorithms across clusters of nodes was to decompose the problem into multiple work units to be distributed across many processors. Decomposition strategies for LPT include: distributed particles, distributed frames, and distributed object space. The distribution of particles or object space can require extensive communication between processors that do not share memory. Frame decomposition is preferred because the communication costs are low and it exposes sufficient parallelism for both shared and distributed memory systems.

With frame decomposition, the data is divided into frame sets of size S consecutive frames which are distributed across processors as shown in FIGS. 9A-9C. The number of frames in a set S, is the parallel decomposition factor or frame-set size, and is left as a tunable parameter with a minimum value of eight frames as required for the trajectory merge operation. The frame sets can be processed in parallel using any sequential tracking algorithm. An important task is merging the disjoint trajectory segments without significant processor communication overhead.

Trajectory Merging

A merge operation concatenates local trajectory segments spanning across a single frame-set into global trajectories that span multiple frame-sets. This occurs between FIGS. 9B and 9C and begins once all local trajectory segments from two adjacent frame sets have been constructed. Therefore, trajectory merging can happen asynchronously without waiting for all trajectory segments from all frame sets to be constructed.

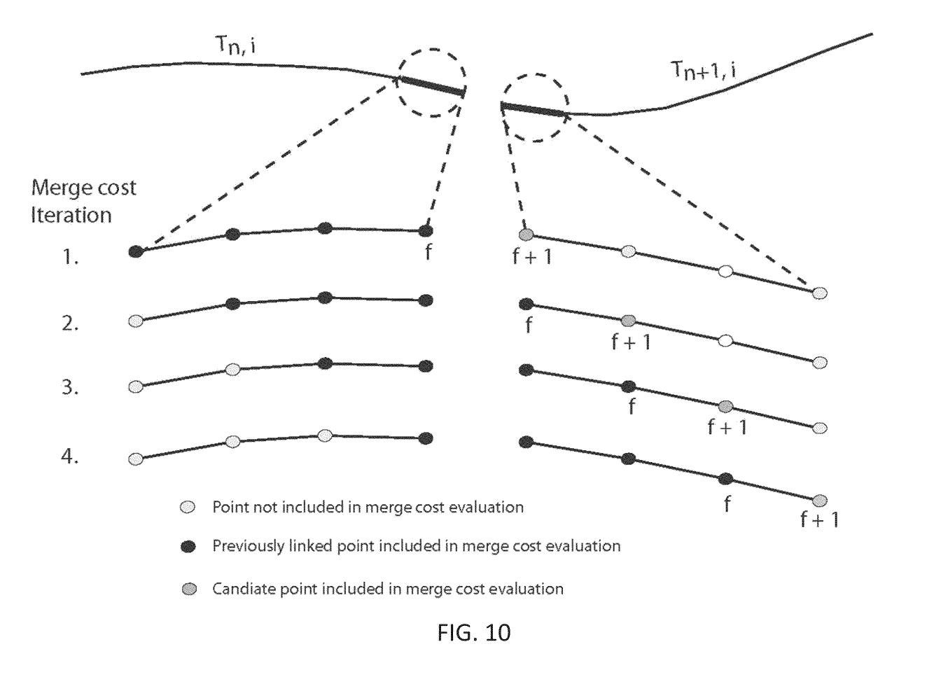

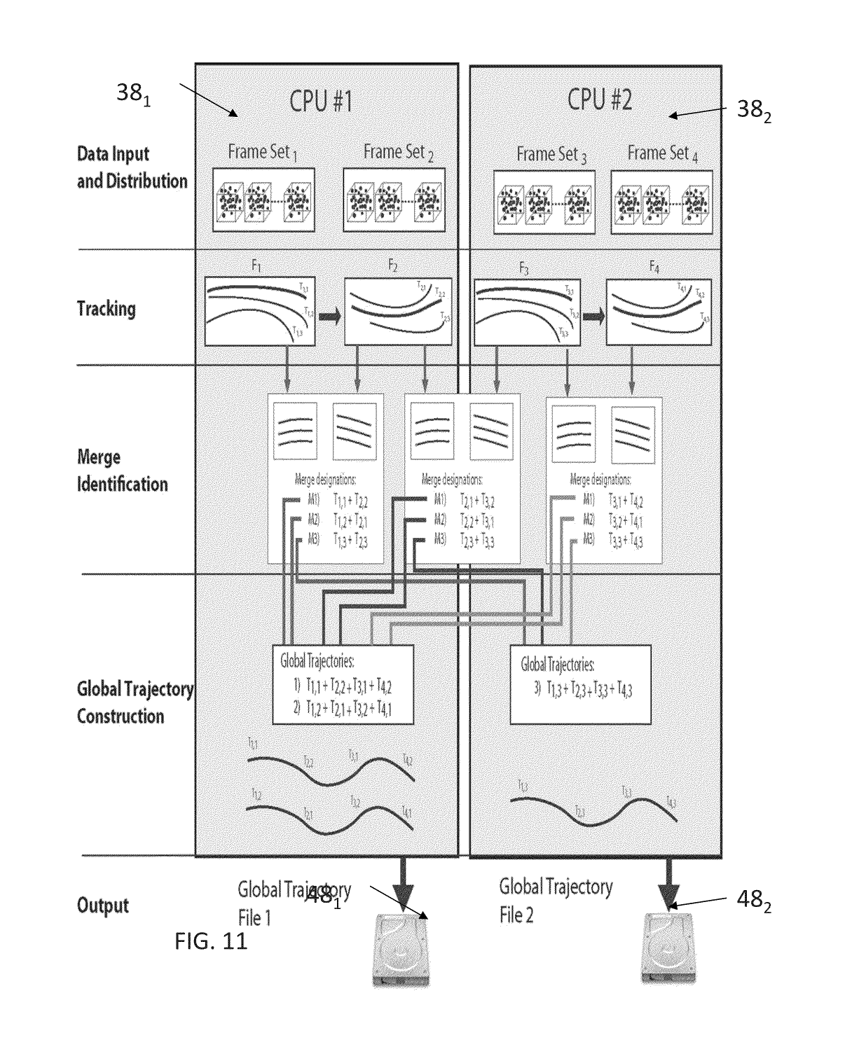

A linear regression based cost function (Li, D., Y. Zhang, et al. “A multi-frame particle tracking algorithm robust against input noise,” Measurement Science and Technology 19: 105401 (2008)) was used to determine if two local trajectory segments from adjacent frame-sets constitute a single trajectory. Only the tails of each trajectory, composed of first four and last four linked particles, are sent to the merge function to minimize data transfer between processors. The merge function compares all trajectories constructed within frame-set n to those in frame-set n+1, where n is the frame-set index from 1 to N−1. If the first particle of the trajectory segment from frame-set n+1 is within certain proximity to the last particle from frame-set n then the cost function is evaluated. FIG. 10 illustrates that the cost evaluation requires four iterations per candidate trajectory to fully examine the quality of fit for each particle in the tails. In FIG. 10, four cost function iterations are required to evaluate the merge of the last four linked particles of trajectories in frame-set Fᵣ, are with the first four linked particles of the trajectories in frame-set Fₙ₊₁. If the cost associated with each of the four iterations is below a set threshold beta then the two local trajectory segments are paired for merger.

TABLE 3
Global merge map: final instructions for global trajectory
assembly from local trajectory segments

| | Frame set number | | | | |
|---|---|---|---|---|---|
| Global Trajectory ID | 1 | 2 | n | . . . | N |
| 1 | T_{1,1} | T_{2,2} | T_{n,1} | . . . | T_{N,13} |
| 2 | T_{1,34} | T_{2,7} | T_{n,19} | . . . | T_{N,15} |
| m | . | . | . | . | . |
| | . | . | . | . | . |
| | . | . | . | . | . |
| M | T_{1,3} | T_{2,1} | T_{n,24} | . . . | T_{N,4} |

Where M is the total number of global trajectories, n is the frame-set index, and m is the global trajectory index.

Parallel Communication and Data Flow

Parallel particle tracking occurs in five steps 1) data input and distribution, 2) tracking, 3) merge identification, 4) global trajectory construction, and 5) trajectory data output to file. FIG. 11 shows a simplified example of the parallel communication and flow using only two processors 38₁ and 38₂ and particle data divided into four frame-sets, two per processor. In the first step, the 3D particle location data is read from memory and distributed in frame-sets of S frames to the pool of processors. Next, each processor 38₁ and 38₂ runs the sequential tracking algorithm on its frame-sets to build local trajectory segments. Once the trajectory segments spanning two adjacent frame-sets have been constructed, the merge operation is conducted as discussed above. The result of the merge operation is a local mapping of trajectory pairings between adjacent frame-sets. The actual trajectory data remains fragmented across processors 38₁ and 38₂ at this point and only the locally paired trajectory segment IDs are known by each processor. Once all local trajectory merges have been identified between each adjacent frame-set, the global trajectory construction process can begin. The purpose of this phase is to consolidate the trajectory segments belonging to a single global trajectory on the same processor. First, a set of instructions is generated that defines the segments to be merged along with their respective frame-set IDs and host processor. A sample of these instructions is shown in Table 3. Next, each processor selects an equal subset of global trajectories and begins communicating with the other processors to obtain the segments needed for their construction. Once a processor has received all of the contiguous trajectory segments and built the global trajectories it outputs them to a single file 48₁ and 48₂ and exits. The final results are a series of files (one per processor) containing full length trajectories.

Algorithm Evaluation and Results

The cluster based parallel LPT algorithm was evaluated for accuracy, consistency and scaling using three data sets. In this evaluation the only the tracking algorithm was used from the node based streaming framework. See, Barker, Douglas, Lifflander, Jonathan, Arya, Anshu, & Zhang, Yuanhui, “A parallel algorithm for 3D particle tracking and Lagrangian trajectory reconstruction,” Measurement Science and Technology, 23(2), 025301 (2012) (incorporated by reference herein). Thus the data input consisted on 3D particle locations grouped by frame and the output was reconstructed trajectories. The sequential regression based tracking algorithm by Li (2008) was used to evaluate the cluster based message passing framework.

The first data set was used to evaluate consistency with the sequential version and was obtained from the PIV 3D standard images data set #352 (Okamoto, K., S. Nishio, et al., “Evaluation of the 3D-PIV Standard Images (PIV-STD Project)” J. Vis. 3: 115-123 (2000)). The second set consisted of a large data set with uniform characteristics and was used to evaluate the optimal parallel performance of the algorithm on several large clusters. The third data set was generated using computational fluid dynamics (CFD) and used to test the parallel performance with non-uniform data and inherent work load imbalance across processors. A wide range of machines were used in the evaluation including a desktop workstation, a moderate-size cluster (Turing) and one very large cluster (BlueGene/P). The specifications of these machines are in Table 4.

TABLE 4
Computer systems used in parallel algorithm evaluation

| System Name | number of Processors | CPU Architecture | RAM |
|---|---|---|---|
| Multi-core workstation | 2 | Intel(R) Xeon(R) E5530 2.4 GHz quad-core CPUs | 16 GB/CPU |
| Turing Cluster | 1536 | Apple G5 2 GHz X-serve cluster | 4 GB/node |
| BlueGene/P Cluster | 163,840 | PowerPC 450 CPUs 850 MHz | 2 GB/node |

Performance Metrics

The trajectory reconstruction accuracy of the algorithm is measured by two key metrics: the coverage ratio and correct ratio as shown in the equations below. Coverage ratio (γ_{coverage}) is the ratio of correct two-frame particle links made during the tracking process (L_{correct}) to the total number of known input links (Lₜₒₜₐₗ). A coverage value of 1.0 indicates that all of the input particles were tracked correctly. Correct ratio (γ_{correct}) refers to the number of correct links made with respect to the total number of links established in the tracking process (L_{tracked}). A correct ratio of 1.0 indicates all established particle links were accurately reconstructed.

$${γ}_{coverage} = \frac{{L}_{correct}}{{L}_{total}} \\ {γ}_{correct} = \frac{{L}_{correct}}{{L}_{tracked}} \qquad ( 3 \text{-} 1 )$$

Parallel performance can be measured in terms of speedup and scalability. The speedup of the parallel algorithm is the ratio of serial execution time to parallel execution time given the same work (equation 3-2). The algorithm is timed from data input to data output excluding reading and writing of data from/to the hard drive. The measure of how well a parallel application scales is the ratio of speedup achieved to the number of processors. The optimal case is when the speedup divided by the number of processors equals unity, in which case perfect scaling is observed. However, in real applications adding processors creates overhead and eventually a loss in parallel efficiency is observed.

$$speedup = \frac{sequential time}{parallel time} \qquad ( 3 \text{-} 2 )$$

PIV Standard 3D Images Data Set #352

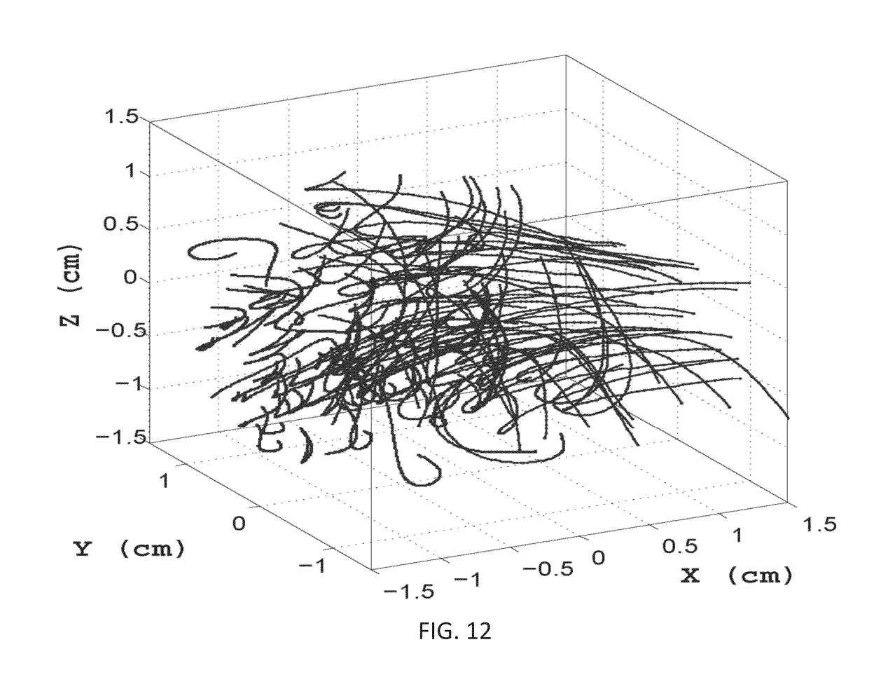

The standard 3D images data set #352 from Okamoto (2000) was selected to test the parallel algorithm for trajectory reconstruction accuracy and consistency in comparison with the serial version. This simulated data set consists of an average of 300 particles per frame in three cameras over 145 frames (Okamoto, Nishio et al. 2000) and is available on the Internet. The flow field is 2 cm×2 cm×2 cm and contains a jet impinging on a wall with inlet speed of 15 cm/s and Reynolds number of 3000. A subset of 3D trajectories from this set is shown in FIG. 12. Accuracy was measured by comparing the output trajectories with the true trajectories from the known input data. This data set is too small for a full evaluation of the parallel scaling and speedup, which are evaluated separately.

Five tracking runs were completed on this data set as shown in Table 5. The first run was conducted with the serial algorithm to build the performance benchmark followed by four runs of the parallel algorithm with different frame set decomposition sizes (8, 16, 32, and 64 frames) on a desktop workstation with two quad-core processors.

TABLE 5
Trajectory reconstruction results using standard PIV data set with no
noise #352 (Okamoto, Nishio et al. 2000)

| | | | | | Avg. | Tra- |
|---|---|---|---|---|---|---|
| Number of | Frames/ | Run | | | Trajectory | jectories |
| Processors | Set | Time (s) | γ_{correct} | γ_{coverage} | Length | Tracked |
| 2 | 8 | 0.619 | 0.984 | 0.923 | 32 | 1400 |
| 2 | 16 | 0.662 | 0.981 | 0.942 | 32 | 1444 |
| 2 | 32 | 0.692 | 0.980 | 0.954 | 32 | 1463 |
| 2 | 64 | 0.707 | 0.980 | 0.958 | 32 | 1468 |
| 1 (serial) | 145 | 0.640 | 0.979 | 0.960 | 32 | 1471 |

To evaluate the algorithm in the presence of noise, the data set was heavily modified and used for reevaluation. Ten percent of the known particles were randomly selected for removal to simulate occlusion, ten percent more ghost particles were randomly added throughout the domain to simulate false detections and all particle positions were perturbed by an average of 0.003 cm in each dimension (equivalent to a 0.5 pixel error in particle centroid localization) to simulate common detection uncertainty.

TABLE 6
Trajectory reconstruction results using standard PIV data set with heavy
noise #352 (Okamoto, Nishio et al. 2000)

| | | | | | Avg. | Tra- |
|---|---|---|---|---|---|---|
| Number of | Frames/ | Run | | | Trajectory | jectories |
| Processors | Set | Time (s) | γ_{correct} | γ_{coverage} | Length | Tracked |
| 2 | 8 | 0.485 | 0.992 | 0.245 | 9 | 1375 |
| 2 | 16 | 0.529 | 0.990 | 0.288 | 9 | 1627 |
| 2 | 32 | 0.554 | 0.980 | 0.311 | 9 | 1762 |
| 2 | 64 | 0.570 | 0.989 | 0.319 | 9 | 1805 |
| 1 (serial) | 145 | 0.510 | 0.989 | 0.324 | 9 | 1831 |

The results show that tracking was consistent between the serial and parallel versions, achieving average tracking correct ratios of 0.98 and average coverage ratios of 0.94. The average length of the trajectories remains at 32 frames and is consistent with the serial results and input data. This indicates that the merge operation performs successfully. When the frame set size, S, is reduced from 64 frames to 8 the correct tracking ratio increases slightly while the coverage ratio decreases slightly. This is an acceptable deviation since the accuracy (correctness) of the tracked particles remains constant and no tracking errors are introduced. Overall, the parallel algorithm was successful in preserving long and accurate trajectories when noise is low. In the presence of heavy noise and uncertainty, the performance diminishes significantly. The results of the parallel algorithm's performance in the presence of noise are shown in Table 6. Although the coverage ratio decreases with added noise, the correct ratio remains near 99 percent in the presence of heavy noise.

Simulated Vortex for Parallel Performance Evaluation

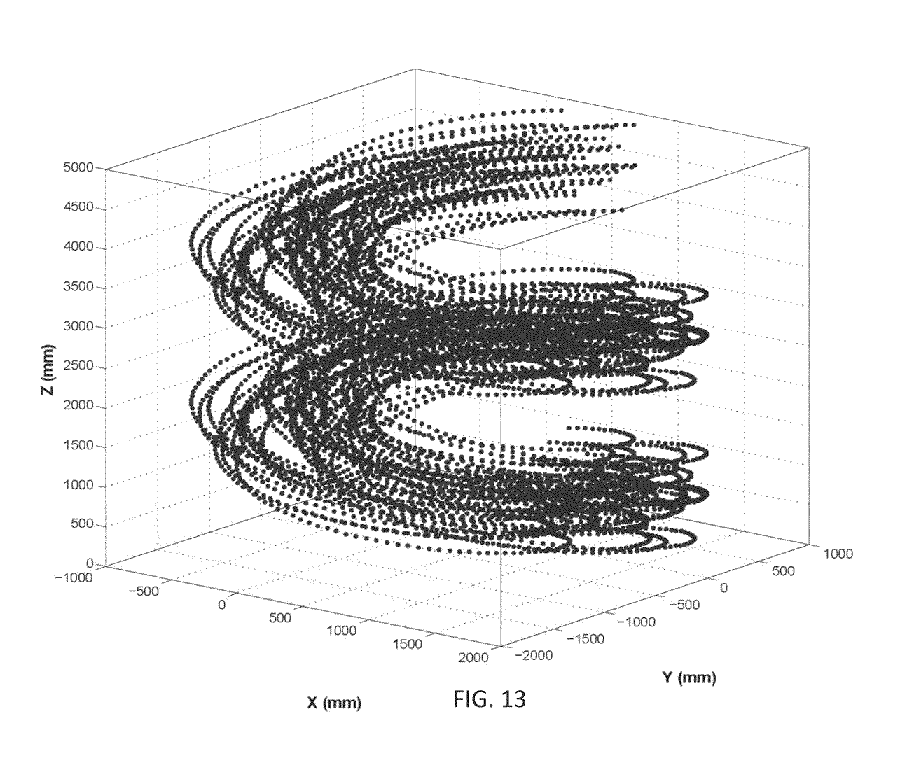

A large uniform data set was created to test the optimal parallel performance of the algorithm under near perfect load balancing for up to 512 processors. This data set consists of a 1024 particles moving with uniform acceleration in a downward spiral through a 2m×2m×6m domain as shown in FIG. 13. The spacing-displacement ratio was greater than 10 in order to ensure 100 percent tracking coverage and accuracy. All trajectories are equal length and span 8192 frames, therefore each frame contains the same number of particles and parallel workload is balanced. This type of data set eliminates the possibility of tracking errors and permits isolated evaluation of the parallel performance in terms of scaling efficiency and speedup. To assist in the evaluation, the data set was parsed to create six total sets representing three variations in total particles (1024, 512 and 256 particles) and three trajectory lengths (8192, 4096 and 2048 frames). The particle trajectories are described by equations 3-3, where 0 and d are the angle and diameter of rotation, and [xₒ, yₒ, zₒ] is the particle's random location in the initial frame.

$$x = {x}_{o} + \frac{d}{2} sin ( θ ) \\ y = {y}_{o} + \frac{d}{2} cos ( θ ) \\ z = {z}_{o} + \frac{d}{2 π} θ \qquad ( 3 \text{-} 3 )$$

The Turing cluster was used to evaluate the impact varying the frame decomposition (frame-set size) from 8 to 256 frames on the parallel performance for a fixed number of processors. The BlueGene/P cluster was used to test the scalability and speedup when the number of frames and particles are varied.

TABLE 7
Impact of parallel decomposition factor, frame set size (5),
on parallel speedup (Turing cluster) 1024 particles 8192 frames

| | frame- | frame- | | | processed |
|---|---|---|---|---|---|
| Number | set | sets | | | frames |
| of | size | per | time | speed | per |
| processors | S | processor | (s) | up | second |
| 1 (serial) | 8192 | 1 | 3662.57 | 1.00 | 2.23 |
| 32 | 8 | 32 | 66.79 | 54.84 | 122.65 |
| 32 | 16 | 16 | 69.22 | 52.91 | 118.35 |
| 32 | 32 | 8 | 67.95 | 53.90 | 120.56 |
| 32 | 64 | 4 | 69.37 | 52.80 | 118.09 |
| 32 | 128 | 2 | 70.04 | 52.29 | 116.96 |
| 32 | 256 | 1 | 85.74 | 42.72 | 95.54 |

Table 7 shows how the parallel decomposition factor, the frame-set size S, impacts speedup. With 32 processors working on the 1024 particle 8192 frame data set, the speedup remains nearly constant for all frame-set sizes until the number of frame-sets per processor approaches one. Once this happens, the processors are unable to hide communication latency by overlapping communication with computation. Two or more frame-sets should be assigned to each processor to minimize idle time. A frame-set size of S=8 frames was selected for the following analysis to ensure at least 512 processors could be used with the largest data set. The speed up of 54 achieved in this evaluation was greater than the number of processors used indicating that the parallel algorithm has better memory characteristics than the sequential version due to slight differences in implementation.

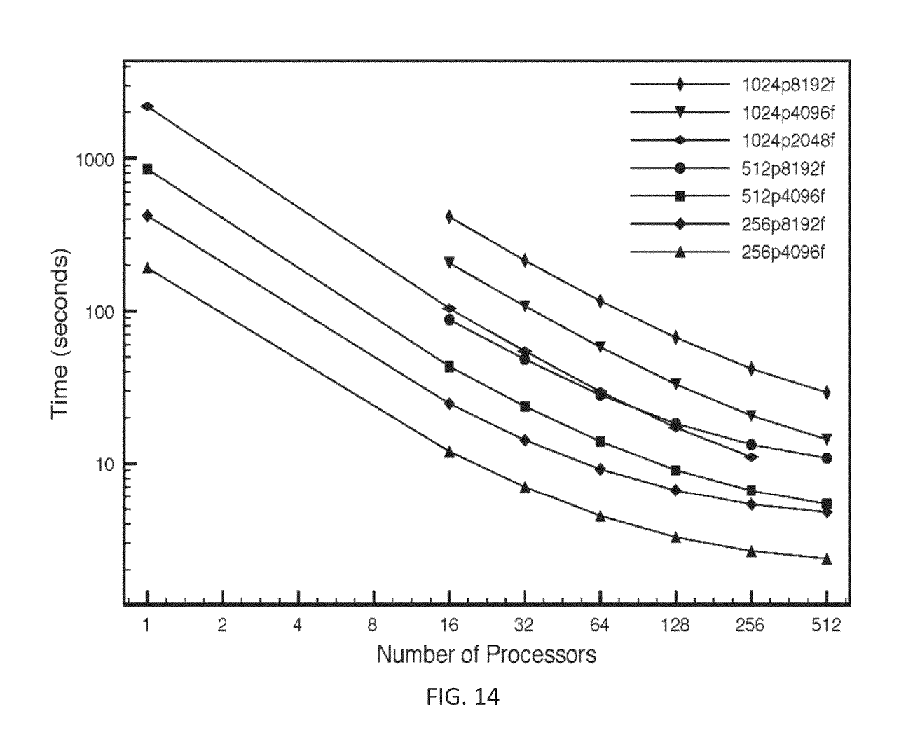

FIG. 14 shows strong scaling of the six data sets up to 512 processors on the BlueGene/P cluster. Data sets are labeled by ApBf where A is the number of particles and B is the number of frames. FIG. 14 demonstrates the impact of diminishing returns and loss of parallel efficiency as the number of processors increase. The run time for the data set with 1024 particles remains at a near constant slope with added processors while the data set with only 256 particles begins to reduce in slope as inefficiencies arise. The data set with more particles has more work and can be processed more efficiently with a larger number of processors. The program scales very well with an increasing number of particles tracked. The slopes of the performance curves for data sets of common particle numbers are nearly equal when the number of frames is 4096 or 8192, indicating that the number of frames processed has little impact on the scaling performance.

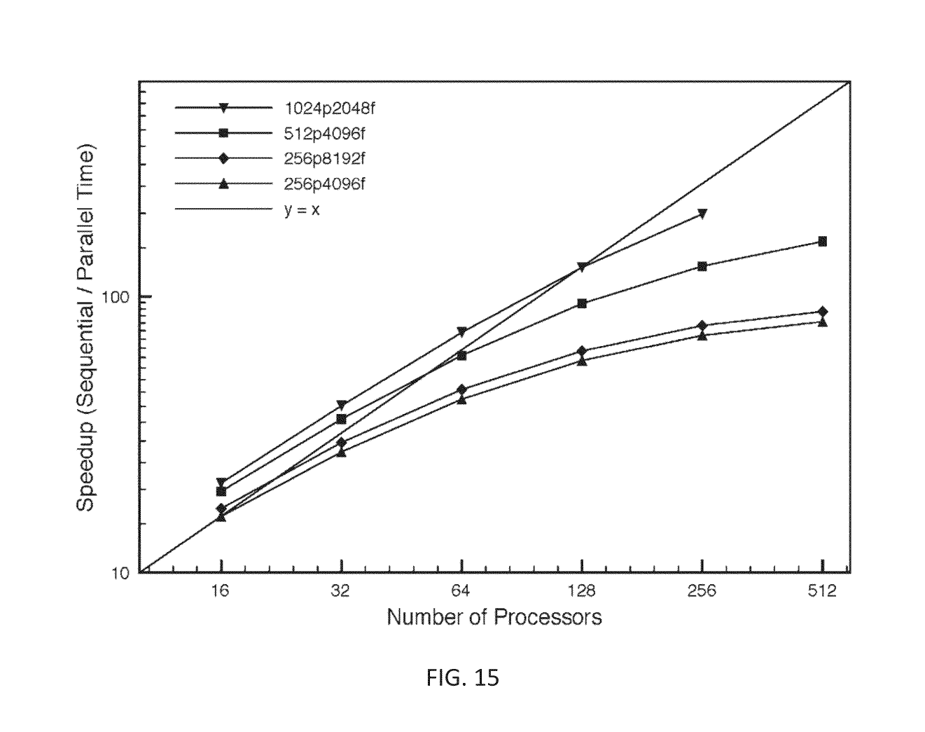

FIG. 15 shows the speedup over the sequential algorithm. The straight line represents a linear speedup and perfect scaling. For the first two points on the 512 particles 4096 frames data set and the three points on the 1024 particles 2048 frames data set, a super-linear speedup is observed. This phenomenon is normally due to differences between the sequential and parallel algorithms or cache effects (the parallel version has better memory characteristics).

As the number of processors increases (the problem size remaining constant), the curve becomes sub-linear due to a decline in parallel efficiency. As the amount of work per processor decreases, communication is more prevalent (because of less overlap with computation) and this decreases performance (less communication is being overlapped with computation). This graph clearly demonstrates that the algorithm scales very well with an increasing number of particles, and the number of frames has little effect. A maximum speedup of roughly 200 is achieved with 256 processors for 1024 particles and 2048 frames. The speedup would continue to increase for this number of processors if larger data sets (particles) were used.

Simulated Displacement Ventilation Flow

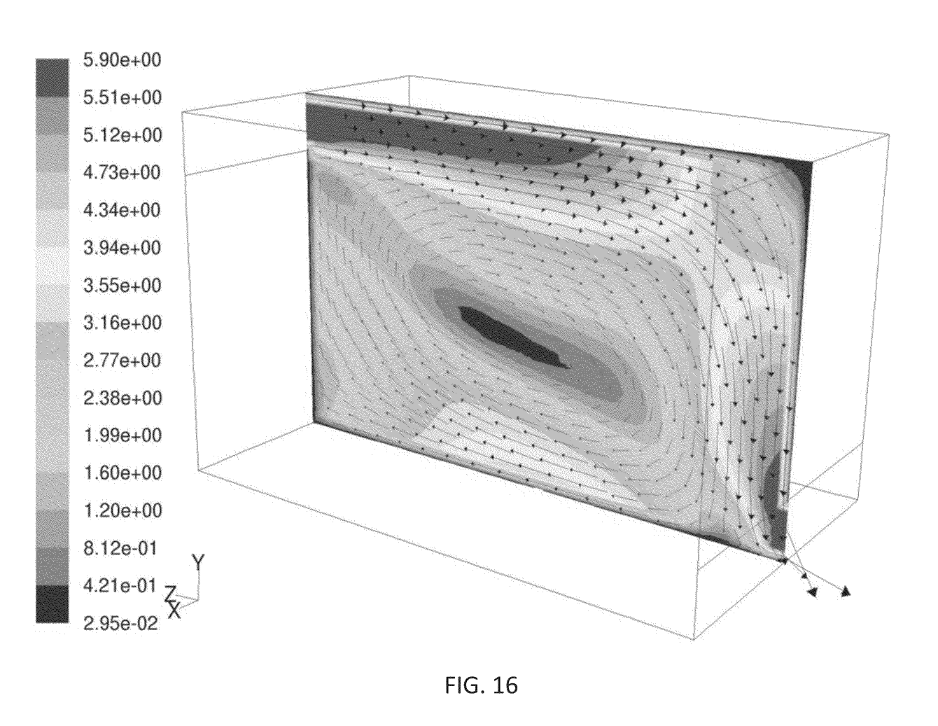

A CFD simulated indoor air flow field was used to test the trajectory reconstruction accuracy and parallel performance of the present tracking algorithm in the presence of large velocity gradients and non-uniform particle seeding over time. This test was conducted to determine how the algorithm performs when the computational load is unbalanced across processors. The data set includes 1540 particles tracked over 4096 frames to accurately evaluate parallel speedup. The flow domain was a large room (3 m×3m×6m) with a slot inlet spanning the width of the room and located on the front wall near the ceiling and a slot outlet located on the opposite wall near the floor). The inlet boundary condition was a constant uniform velocity of 4 m/s and the outlet boundary was a standard pressure outlet set to atmospheric conditions. Turbulence was modeled using a Reynolds Averaged Navier-Stokes approach. The resulting steady state flow field solution is shown in FIG. 16.

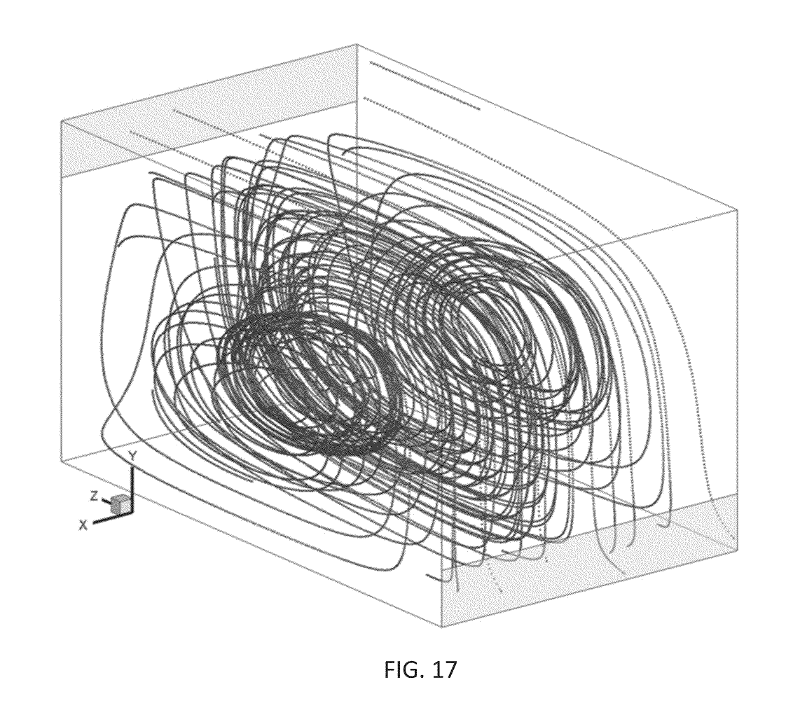

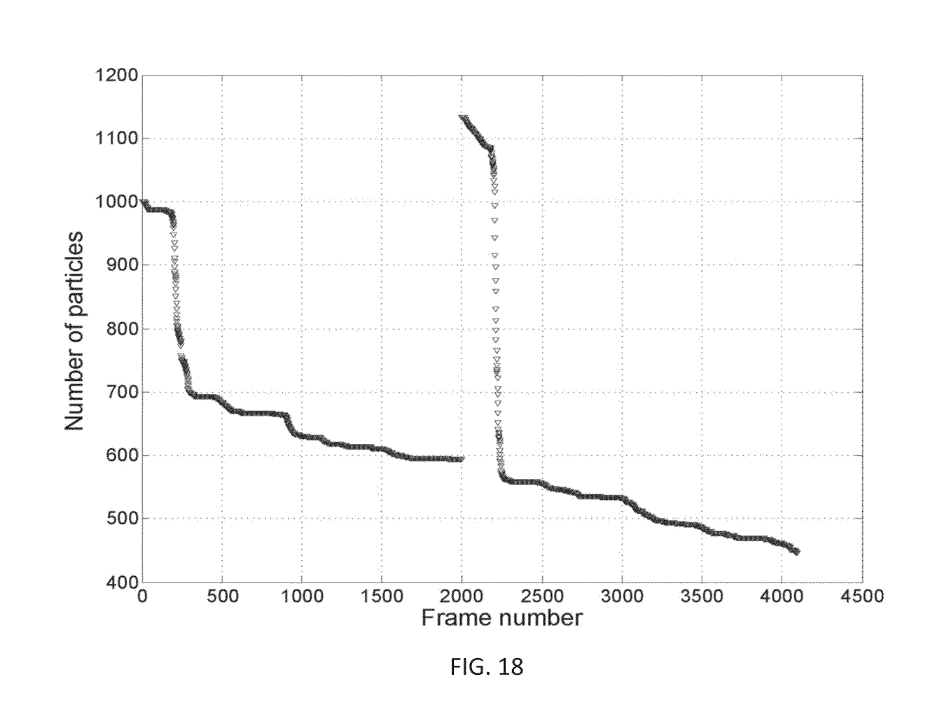

Particle trajectories were simulated using a Lagrangian tracking model, assuming massless particles. A subset of particle trajectories from the experiment is shown in FIG. 17. Particles were injected throughout the domain at two instances in time (frames 0 and 2000) to obtain a non-uniform number of particles per frame as shown in FIG. 18. The data was further unbalanced due to the presence of large velocity gradients which caused a portion of the particles to leave the domain more quickly than others, leading to variation in trajectory lengths.

TABLE 8
Trajectory reconstruction accuracy results for
CFD data set (Workstation)

| | | | Avg. | |
|---|---|---|---|---|
| Frame | | | Trajectory | Trajectories |
| set size S | γcorrect | γcoverage | Length | Tracked |
| 8 | 0.999 | 0.995 | 1234 | 2057 |
| 64 | 0.998 | 0.998 | 1232 | 2070 |
| 256 | 0.998 | 0.999 | 1228 | 2079 |
| 512 | 0.998 | 0.999 | 1222 | 2088 |
| 4096 (serial) | 0.998 | 0.999 | 1359 | 1879 |

TABLE 9
Parallel performance results for CFD data set,
Frame-set size (S) = 8 frames

| | | | | processed |
|---|---|---|---|---|
| | | | | frames |
| | Number | Run | | per |
| | of | time | speed | second |
| System | Processors | (s) | up | (fps) |
| Workstation | 8 | 10.18 | 7.02 | 402.36 |
| | 4 | 19.54 | 3.66 | 209.62 |
| | 2 | 59.01 | 1.21 | 69.41 |
| | 1 (serial) | 71.43 | 1.00 | 57.34 |
| Turing Cluster | 128 | 6.98 | 42.02 | 586.82 |
| | 64 | 8.68 | 33.79 | 471.89 |
| | 32 | 12.41 | 23.63 | 330.06 |
| | 16 | 27.42 | 10.70 | 149.38 |
| | 8 | 37.88 | 7.74 | 108.13 |
| | 1 (serial) | 293.31 | 1.00 | 13.96 |

The results from the trajectory reconstruction analysis are presented in Table 8. The algorithm worked well and reconstructed the trajectories with nearly 100 percent coverage and correctness. However, the parallel algorithm constructed more trajectories and had a lower average trajectory length than the serial version, which indicates that some shorter trajectories did not completely merge. This is likely due to a locally small particle spacing-displacement ratio near the boundaries of several frame-sets, which resulted in match ambiguity. This however, does not introduce tracking errors. The lack of tracking errors is demonstrated by no reduction of the correct tracking ratio values, and therefore may be acceptable tradeoff for increased processing speed and scalability of data storage. The frame-set size of eight resulted in the highest percent correct trajectories and was used for the parallel performance analysis.

The Turing cluster and multi-core workstation were used to evaluate the parallel performance with the non-uniform data set and the results are given in Table 9. As expected, the speedups achieved were lower than those for the uniform data sets in the previous section due to the inherent load imbalance, which caused an increase in processor idle time. On the Turing cluster, the maximum speedup of 42 was achieved with 128 processors for a processed frame rate of 586 fps. The multi-core workstation achieved a maximum speedup of 7 with 8 processors and processed 402 fps. The workstation with 2.4 GHz processor cores and shared memory was four times faster than the Turing cluster with 2.0 GHz cores and distributed memory when processing the sequential code. These results show that real-time processing of the tracking algorithm for a camera frame rate of 100 fps could be possible with either machine

Simulation shows that parallel processing of the particle tracking algorithm can provide as scalable real-time LPT measurement system where large data sets are seamlessly distributed and processed across many computers. Such a scalable system directly addresses the data management issues experienced in LPT experiments and provides the foundation for real-time measurement capabilities for very high speed cameras. The parallel processing framework was evaluated on three simulated data sets, which proved that it was consistent with the serial version and could efficiently scale to over 500 processors. The algorithm was based on frame decomposition and programmed using object-oriented C++ with the Charm++ extensions for asynchronous message passing between distributed objects. The asynchronous trajectory merge operation importantly minimizes processor idle time and data transfer between nodes.

Evaluation of the present algorithm with the PIV standard 3D images dataset #352 demonstrated that it was consistent with the optimized serial version in terms of trajectory reconstruction accuracy as quantified by the correct tracking ratio. This data set also validated the new algorithm's ability to handle merging of trajectories of non-uniform length distributed across many processors. In a few instances several local trajectory segments did not merge due to short trajectories formed near the frame-set intersections. However, this may be an acceptable tradeoff for runtime speedup and scalability since major tracking errors were not introduced into the results. Modification and optimization of the merge algorithm is an avenue to eliminate even the minor tracking errors.

The parallel performance evaluation showed that the present algorithm scaled well with an increasing number of particles tracked, while the number of frames processed had very little impact on the scaling performance. This implies that the parallel performance of the algorithm will remain nearly constant if only a few frames are processed at a time, as in real-time data streaming from smart cameras, or if thousands of frames are processed in batch. If camera resolution is increased to grow the number of resolved tracer particles then a proportional number of processors can be added to maintain parallel performance. The parallel decomposition factor (frame-set size S) did not influence the speedup significantly as long as each processor was assigned more than one frame-set. A significant speedup of up to 200 was obtained with 256 processors for the optimal case of inherently load balanced data (1024 particles and 2048 frames). Testing of a more realistic data set containing non-uniform trajectories showed that the speedups were still significant: 42 on 128 processors at 586 frames processed per second. Scaling is consistent from multi-core workstations to large clusters, and the magnitude of speedup achieved is very dependent on the specific architecture of the system including cache size and processor clock rate.

The parallel frameworks for real-time processing of LPT data on node based multi-core processors with GPU accelerators and a message passing framework for use on high performance clusters can be used together to allow massive scaling of the LPT system to include many more cameras and higher frame rates.

The results from tests showed that the of the LPT algorithms, the image processing and detection algorithm is the bottleneck of the system when only four cameras are used. However, as the number of cameras is increased to six or more the multi-camera correspondence algorithm becomes the bottleneck. With four cameras and a data set of 300 particles per frame, the compute node streaming framework was able to achieve a processed frame rate of nearly 500 frames per second. With six cameras the added processing load slowed the rate to 270 frames per second. Thus in a real 6 camera system, real-time processing can be achieved on just one node for frame rates less than 270 fps.

However, when frame rates are increased then the compute cluster message passing framework can be used to distribute the frames by group across a large compute cluster. Results from tests of the compute cluster message passing framework showed that scaling could be achieved for 500 processors. This demonstrates the ability to reach real-time processing of LPT data scalable to hundreds of processors for high frame rate cameras.

Practical Considerations for Prototype Systems and Sensitivity Analysis

The real-time LPT system is composed of four major hardware components 1) Imaging system including cameras and lenses, 2) illumination system and seed particle generator, and 3) computational resources.

Imaging System

The imaging system is composed of cameras and lenses, each of which introduces important selection decisions when designing the real-time LPT system. The important factors when selecting cameras can be broken down in the following 1) frame rate, 2) sensor resolution, 3) synchronization and controllability, and 4) image processing capabilities and data transfer bandwidth.

The sensor resolution and frame rate directly impact the type of particle flow that can be characterized with the LPT system. For example, the frame rate directly relates to the maximum particle velocity which can be tracked based on maintaining a minimum particle spacing-displacement ratio.

The invention demonstrates that the frame rate of the cameras should be selected based on the ability to over sample a particles trajectory at the maximum expected velocity of the flow field, desired seed particle density, and length of desired trajectories. This permits the simplification of velocity and acceleration calculations by making the particle trajectory substantially linear as shown in FIG. 4C.

The sensor resolution impacts the density of particles that can be resolved along with the uncertainty of the particle centroid location. However, the importance of spatial resolution should be lower than that of frame rate when the goal is to track few particles over longer trajectories. Priority in the design of a system is preferably given to camera frame rate, multi-camera synchronization, data compression and controllability.

Field Programmable Gate Array (FPGA) cameras can carry processing load and synchronize among groups up to hundreds of cameras. The prototype real-time LPT system that was tested included six low cost motion capture cameras were purchased based on the availability of a C++ control interface, hard wire synchronization, flexible lens mounts, and built in FPGA for particle detection and image compression. The cameras chosen contained VGA resolution (640×480) monochrome sensors which were housed in aluminum housings with standard CS lens mounts with C mount adaptors. The six cameras form 15 unique pairs, and 15 unique four camera groups which were enough to test the viability of the real-time multi-camera tracking approach. The variable zoom lenses had a focal length range from 2.8-8 mm and aperture of F/1.2 with a CS mount. The lenses were IR-corrected and designed for 3 megapixel sensor which meant that the image sensors of our system would not be limited by the resolving power of the lenses.

TABLE 10
Camera system specifications

| Parameter | Specification |
|---|---|
| Frame rate | 30, 60, 120 fps |
| Resolution | 640 × 480 |
| Sensor type | CMOS monochrome |
| Bit depth | 8 |
| Pixel size | 6 × 6 microns |
| Imager size | 4.5 × 2.88 mm |
| Shutter type | Global |
| Shutter speed | 1 ms-20 μs |
| Image processing abilities | MJPEG compression |
| | Image segmentation |
| | Object centroid detection |
| Control | C++ camera SDK |
| Synchronization | Synch breakout cable |
| Communication | USB 2.0 |

Illumination and Seed Particle Generator

The decisions on types of illumination systems and seed particle generators are closely linked. In most particle tracking velocimetry studies, the illumination source is a high power pulse laser and the particles are small flow tracers on the order of 10 microns in diameter. LPT systems of the invention are designed to provide real time observation of flows on larger scales and provide systems that are not cost prohibitive.

Advantageously, low cost LED light panels can be used for illumination. In addition, a low cost commercial generator for neutrally buoyant helium filled soap bubbles can be used. In the prototype, each LED light panel contained 500 individual diodes and had a total power consumption of 50 watts. The 1-4 mm helium filled soap bubbles were easily visible using the LED system. This combination provided a safe, affordable and scalable solution that can scale to room size flows.

Computational Resources

The prototype used multi-core workstation that contained two quad-core Intel Xeon 2.4 GHz CPUs, 32 GB of random access memory, and four graphics processing units (GPU). Three of the graphics cards were NVidia TESLA C1060 GPU compute accelerators strictly for data processing and one card was an NVidia Quadro FX3700 for 3D visualization. The two quad core CPUs were hyper threaded, to provided 16 virtual processors for multi-threading. The six cameras were connected to the computer using a 7 port USB 2.0 hub. The large amount of RAM was used in experiments to maintain real-time capability in the case that any of the data queues in the nodal pipelining scheme began to fill up.

System Calibration

The cameras were calibrated before each experiment using an open source camera calibration routine. The calibration algorithm is based finding the optimal camera parameters (f, c, and distortion coefficients) that minimize the reprojection error between known image points and their specified 3D object coordinates. See, Zhang, Z., “A flexible new technique for camera calibration,” Pattern Analysis and Machine Intelligence, IEEE Transactions on 22(11): 1330-1334 (2000). The calibration procedure used in this research imaged a planar calibration board containing black 44 circles in at least 50 orientations for each camera. Each circle on the board was detected and its centroid computed. Finally, the list of image point coordinates and 3D object coordinates (relative to the board plane) were processed with the method of Zhang to determine the optimal camera parameters based on all 50 images. The reprojection residuals from the optimal camera parameters are usually on the order of 0.1 pixels for each camera.

The extrinsic parameters are determined through the use of an open source function (solvePnP found in OpenCV) which estimates an objects pose from a set of detected image points and known object points for the same planar calibration object. With this method, all cameras must share a common view of the static calibration board. Once imaged and detected in each camera, the rotation and translation vectors in each camera are determined by minimizing the reprojection error, which is the Euclidian norm of the difference between the actual imaged point locations and the reprojected image points from known object coordinates. The resulting intrinsic and extrinsic are used to calculate the Fundamental matrices for each unique camera pair, which are required for the multi-camera correspondence algorithm.

Derivation of Measurement Uncertainties

Methods to identify the measurement uncertainty of 3D particle position, velocity and acceleration are provided. These uncertainty calculation methods can be used to conduct a sensitivity analysis in and determine the standard uncertainties in any real-time particle tracking system constructed in accordance with the invention.

3D Position Uncertainty

3D positions of the particles are an output of the particle tracking system. The standard uncertainty of the 3D position in terms of a single length value can be calculated. This value defines the radius of a sphere of uncertainty around the measured particle position. The standard uncertainty of the 3D world position measurement is based on uncertainty propagation from three factors 1) detected particle centroid coordinates, 2) camera intrinsic parameters including distortion coefficients, principle point and focal length, and 3) the extrinsic parameters defining the cameras translation and rotation from the global coordinate system.

The particle's world coordinate x_{w} is of interest and can be defined as a function of the particle's camera coordinates along with the rotation and translation vectors of camera involved in the 3D reconstruction, as given in equation 4-1.

$$\begin{matrix}{x}_{w} = f ( {p}_{1} , {p}_{2} , … {p}_{n} ) \\ = f ( [ {x}_{{c}_{1}} , {R}_{1} , {t}_{1} ] , [ {x}_{{c}_{2}} , {R}_{2} , {t}_{2} ] , … [ {x}_{{c}_{n}} , {R}_{n} , {t}_{n} ] )\end{matrix} \qquad ( 4 \text{-} 1 )$$

ƒ is the 3D reconstruction function described above. The uncertainty associated with the world coordinates follows the standard uncertainty equation, where all parameters p in the function measurement equation are assumed to be independent from one another.

$${u}^{2} ( {x}_{w} ) = {\sum }_{i = 1}^{N} {( \frac{\partial f}{\partial {p}_{i}} )}^{2} {u}^{2} ( {p}_{i} ) \qquad ( 4 \text{-} 2 )$$

The particle's coordinates in each camera, x_{c, i} are related to the world coordinates through the following equation.

$$[ \begin{matrix}{x}_{c} \\ {y}_{c} \\ {z}_{c}\end{matrix} ] = R [ \begin{matrix}{x}_{w} \\ {y}_{w} \\ {z}_{w}\end{matrix} ] t \qquad ( 4 \text{-} 3 )$$

Its homogenous coordinates (x′ and y′) are defined by normalizing the x and y components by the z component.

x′=x_{c}/z_{c}

y′=y_{c}/z_{c} (4-4)

The first factor introducing uncertainty into the 3D reconstruction process is the uncertainty in the lens distortion coefficients k₁, k₂, p₁ and p₂ as determined through calibration. The distorted image coordinate of a particle x_{pd} and the undistorted coordinate xₚ are related through a nonlinear function g and the distortion coefficients.

xₚ=g(x_{pd},k₁,k₂,p₁,p₂) (4-5)

The uncertainty in the undistorted particle image coordinate is then a combination of the uncertainty in the original distorted coordinate x_{pd} and the uncertainty in each distortion coefficient as follows.

$${u}^{2} ( {x}_{p} ) = {( \frac{\partial g}{\partial {x}_{pd}} )}^{2} {u}^{2} ( {x}_{pd} ) {( \frac{\partial g}{\partial {k}_{1 }} )}^{2} {u}^{2} ( {k}_{1} ) {( \frac{\partial g}{\partial {k}_{2}} )}^{2} {u}^{2} ( {k}_{2 } ) {( \frac{\partial g}{\partial {p}_{1}} )}^{2} {u}^{2} ( {p}_{1} ) {( \frac{\partial g}{\partial {p}_{2}} )}^{2} ( {p}_{2} ) \qquad ( 4 \text{-} 6 )$$

In practice, the standard uncertainty of the distortion coefficients can be ascertained by repeating the calibration process with different sets of calibration images and finding the standard deviation in the resulting optimal camera parameters. The standard uncertainty in the distorted image coordinate x_{pd} is directly a result of the particle centroid finding algorithm and random image noise; this term is dependent on experimental conditions and will vary during the experiment. The partial derivatives of the undistortion function g( ) are not easily determined, since this represents an iterative non-linear optimization algorithm. Therefore, these sensitivities are more readily determined by perturbing the distortion coefficients by their standard uncertainty and solving for the undistorted coordinates. The change in the undistorted coordinates is then recorded as the uncertainty component for that coefficient.

The homogenous coordinates are a function of the image coordinates through the following relation.

$${x}^{′} = \frac{{x}_{p} - {c}_{x}}{{f}_{x}} \\ {y}^{′} = \frac{{y}_{p} - {c}_{y}}{{f}_{y}} \qquad ( 4 \text{-} 7 )$$

The combined uncertainty for the homogenous coordinates are then easily determined by taking the partial derivatives of the previous terms to obtain:

$${u}^{2} ( {x}^{′} ) = {( \frac{1}{{f}_{x}} )}^{2} {u}^{2} ( {x}_{p} ) + {( \frac{- 1}{{f}_{x}} )}^{2} {u}^{2} ( {c}_{x} ) + {( \frac{{c}_{x} - {x}_{p}}{{f}_{x}^{2}} )}^{2} {u}^{2} ( {f}_{x} ) \\ {u}^{2} ( {y}^{′} ) = {( \frac{1}{{f}_{y}} )}^{2} {u}^{2} ( {y}_{p} ) + {( \frac{- 1}{{f}_{y}} )}^{2} {u}^{2} ( {c}_{y} ) + {( \frac{{c}_{y} - {y}_{p}}{{f}_{y}^{2}} )}^{2} {u}^{2} ( {f}_{y} ) \qquad ( 4 \text{-} 8 )$$

The total combined uncertainty of the 3D position can then be written as a sum of squares of all the parameter uncertainties multiplied by the squared sensitive of the reconstruction function ƒ for N cameras used in the reconstruction.

$${u}^{2} ( {x}_{w} ) = {\sum }_{c = 1}^{N} [ {( \frac{\partial f}{\partial {x}_{c}^{′}} )}^{2} {u}^{2} ( {x}_{c}^{′} ) + {( \frac{\partial f}{\partial {y}_{c}^{′}} )}^{2} {u}^{2} ( {y}_{c}^{′} ) + {( \frac{\partial f}{\partial {R}_{c}} )}^{2} {u}^{2} ( {R}_{c} ) + {( \frac{\partial f}{\partial {t}_{c}} )}^{2} {u}^{2} ( {t}_{c} ) ] \qquad ( 4 \text{-} 9 )$$

The sensitivity of the reconstruction function ƒ, which is a linear least squares problem, depends on both the conditioning of the matrix A and the magnitude of the residual r. Where the least squares problem is defined as:

Ax_{w}=b

r=Ax_{w}b (4-10)

For 3D reconstruction this linear system of equations can be formed with a minimum of two cameras and takes the form shown in below.

$$A = [ \begin{matrix}{A}_{1} \\ {A}_{i} \\ ⋮ \\ {A}_{N}\end{matrix} ] \\ b = [ \begin{matrix}{b}_{1} \\ {b}_{i} \\ ⋮ \\ {b}_{N}\end{matrix} ] \qquad ( 4 \text{-} 11 )$$

Where for the matched imaged point in camera i the sub matrices Aᵢ and bᵢ with respect to the normalized image point (x′ᵢ, y′ᵢ) are

$${A}_{i} = [ \begin{matrix}{x}_{i}^{′} {r}_{31} - {r}_{11} & {x}_{i}^{′} {r}_{32} - {r}_{12} & {x}_{i}^{′} {r}_{33} - {r}_{13} \\ {y}_{i}^{′} {r}_{31} - {r}_{21} & {y}_{i}^{′} {r}_{32} - {r}_{22} & {y}_{i}^{′} {r}_{33} - {r}_{23}\end{matrix} ] ; \\ {b}_{i} = [ \begin{matrix}{t}_{x} - {x}_{i}^{′} {t}_{z} \\ {t}_{y} - {y}_{i}^{′} {t}_{z}\end{matrix} ] \qquad ( 4 \text{-} 12 )$$

The sensitivity of the solution vector x_{w} as a function of a perturbation in the vector b, called Δb, is known to be a function of the condition number of matrix A and the angle theta between b and Ax_{w}.

$$\frac{{‖ Δ {x}_{w} ‖}_{2}}{{‖ {x}_{w} ‖}_{2}} \leq cond ( A ) \frac{1}{cos ( θ )} \frac{{‖ Δ b ‖}_{2}}{{‖ b ‖}_{2}} \qquad ( 4 \text{-} 13 )$$

The angle theta can be derived from the L2 norms of Ax_{w} and b as follows.

$$cos ( θ ) = \frac{{‖ A {x}_{w} ‖}_{2}}{{‖ b ‖}_{2}} \qquad ( 4 \text{-} 14 )$$

Sensitivity of the solution x_{w} as a function of the perturbation in the matrix A, called E is known to be:

$$\frac{{‖ Δ {x}_{w} ‖}_{2}}{{‖ {x}_{w} ‖}_{2}} \leq ( {cond ( A )}^{2} tan ( θ ) + cond ( A ) ) \frac{{‖ E ‖}_{2}}{{‖ A ‖}_{2}} \qquad ( 4 \text{-} 15 )$$

Singular Value Decomposition (SVD) of the matrix A can be used to determine the L2 norm and condition number of A which are required to compute the sensitivities of x_{w}. The SVD of A is:

A=UΣV^{T} (4-16)

Where Σ is a diagonal matrix containing the positive singular values labeled σ₁ through σ_{N}.

Σ=diag(σ₁,σ₂ . . . σ_{N})

σᵢ≧0 (4-17)

The L2 norm of A is equal to the largest singular value, while the condition number of A is equal to the ratio of the largest singular value divided by the smallest. The condition number defines the bounds of the ratio of relative change in the solution x to a change in the matrix A. Thus, the 3D reconstruction problem will be highly sensitive to uncertainties in any of the input parameters if the resulting matrix A is ill-conditioned, which corresponds to a large condition number greater than 1.

$$\begin{matrix}{‖ A ‖}_{2} = {σ}_{max} & ( 4 \text{-} 18 ) \\ cond ( A ) = \frac{{σ}_{max}}{{σ}_{min}} & ( 4 \text{-} 19 )\end{matrix}$$

Now the sensitivities of the 3D reconstruction function ƒ can be calculated for each parameter in equation 4-9, as below where the terms for each input parameter are generalized by pᵢ

$$\frac{\partial f}{\partial {p}_{i}} \approx \frac{{‖ Δ {x}_{w} ‖}_{2}}{Δ {p}_{i}} \qquad ( 4 \text{-} 20 )$$

The standard 3D position uncertainty can then be calculated for each set of match particle images as follows:

(1) Calibrate cameras and obtain uncertainties for internal and external parameters
(2) Specify or measure the particle image centroid uncertainty u(x_{pd})
(3) For a specified group of N cameras, select a matched group of corresponding particle image coordinates
(4) Solve equation 4-6 for the uncertainties in the N sets of undistorted pixel coordinates
(5) Solve equation 4-8 for the uncertainties in the N sets of homogenous image coordinates
(6) Build the matrix A based on equation 4-12 and compute its Singular Value Decomposition

### (7) Calculate

x_{w} based on the SVD of A
L2 norm of A, Ax_{w}, and b, equation 5-19
the condition number of A, equation 5-20
   (8) Calculate least squares solution sensitivities for x′, y′, R and t of each camera using equations 4-13, 4-15, and 4-20
   (9) Substitute the sensitivities into equation 5-10 and compute the combined 3D position standard uncertainty u(x_{w})
   (10) Repeat for all 3D points

Velocity and Acceleration Uncertainties

The standard uncertainties for particle velocity and acceleration can be derived from the respective finite difference approximations and the standard particle position uncertainty at each point in the finite difference stencil. For velocity the second order central difference uses a two point stencil and therefore uncertainty is propagated from the n+1 and n−1 particle positions as follows:

$$\begin{matrix} v \approx \frac{{x}^{n + 1} - {x}^{n - 1}}{2 Δ t} + O ( Δ {t}^{2} ) & ( 4 \text{-} 21 ) \\ {u}^{2} ( v ) = {( \frac{1}{2 Δ t} )}^{2} {u}^{2} ( {x}^{n + 1} ) + {( \frac{- 1}{2 Δ t} )}^{2} {u}^{2} ( {x}^{n - 1} ) + {( - \frac{{x}^{n + 1} - {x}^{n - 1}}{2 Δ {t}^{2}} )}^{2} {u}^{2} ( Δ t ) & ( 4 \text{-} 22 )\end{matrix}$$

The acceleration approximation utilizes a three point central difference stencil and results in an uncertainty equation as follows:

$$\begin{matrix} a \approx \frac{{x}^{n + 1} - 2 {x}^{n} + {x}^{n - 1}}{Δ {t}^{2}} + O ( Δ {t}^{2} ) & ( 4 \text{-} 23 ) \\ {u}^{2} ( a ) = {( \frac{1}{Δ {t}^{2}} )}^{2} {u}^{2} ( {x}^{n + 1} ) + {( - \frac{2}{Δ {t}^{2}} )}^{2} {u}^{2} ( {x}^{n} ) + {( \frac{1}{Δ {t}^{2}} )}^{2} {u}^{2} ( {x}^{n - 1} ) + {( - 2 \frac{{x}^{n + 1} - 2 {x}^{n} + {x}^{n - 1}}{Δ {t}^{3}} )}^{2} {u}^{2} ( Δ t ) & ( 4 \text{-} 24 )\end{matrix}$$

These uncertainty equations take into account both the uncertainties in particle positions, but also the uncertainty in the time step. In practice the time step uncertainty is on the order of 10⁻⁶ s and this term can be neglected.

Sensitivity Analysis

Camera calibration, camera placement, and the selection of 3D reconstruction camera groups can affect 3D position uncertainty and 3D reconstruction error. The 3D reconstruction error or 3D position error is defined as:

$$\begin{matrix}{E}_{3 D} = {‖ x - \hat{x} ‖}_{2} \\ = \sqrt{{( x - \hat{x} )}^{2} + {( y - \hat{y} )}^{2} + {( z - \hat{z} )}^{2}}\end{matrix} \qquad ( 4 \text{-} 25 )$$

Where x is the known “true” position of a particle and X is the estimated 3D position resulting from the 3D reconstruction process.

Impact of Camera Calibration Parameter Uncertainty on 3D Reconstruction

Values are estimated to 1/1000 of the overall scale. This provides a reasonable set of values which can be used to understand the relative importance of each parameter during an experiment. The table below shows the estimated uncertainty values for each parameter based on 1/1000 of the parameters scale. For example the estimated 0.1% uncertainty for the distorted particle image position x_{pd} based on an image sensor with 640×480 pixels is 0.64 pixels.

TABLE 11
Estimated 0.1% uncertainties for calibration parameters
based on maximum scale of each parameter

| | | 0.1% uncertainties | | |
|---|---|---|---|---|
| Max range | | x | y | z |
| u(c) | 320 × 240 pixels | 0.32 pix | 0.24 pix | — |
| u(f) | 8 mm, 6 μm/pixel | 1.33 pix | 1.33 pix | — |
| u(X) | 640 pixels | 0.64 pix | 0.64 pix | — |
| u(T) | 1120 mm | 0 mm | 0 mm | 1.12 mm |
| u(R) | 1.57 | 1.57E−03 | 1.57E−03 | 1.57E−03 |

To determine the impact of camera calibration parameter uncertainty on the relative 3D position uncertainty, a 16×16×16 virtual 3D point grid was generated with 10 mm spacing between points. Two virtual cameras were placed at 45 degrees relative to the front face of the 300 mm×300 mm×300 mm cubic domain. The resulting average condition number of A for the two camera combination was 2.64±0.196 based on all points in the grid.

Six 3D position uncertainty averages were calculated based on isolating the influence of each of the five parameters in Table 11, and an additional calculation taking the combination of parameter uncertainties into account. The resulting 3D position uncertainties were divided by the domain length scale of 300. Alone, the centroid position uncertainty of 0.64 pixels had the largest impact on the 3D position uncertainty. 0.1% uncertainty in the image coordinates of the particle in each camera caused nearly a 0.9% uncertainty in object space. The next most important parameter was the principle point of the imager which produced nearly 0.4 percent position uncertainty alone. When combined, the 0.1% parameter uncertainties created 1% uncertainty in the particle's position corresponding to a Therefore focus should be placed on minimizing the uncertainty for the centroid localization through reducing image noise and improving the robustness of the particle detection and centroid localization algorithm.

Impact of Camera Placement on 3D Position Uncertainty

Tests were conducted to test the effect of angle between two cameras placed equal distances from the center of an observation volume on the impact of the position uncertainty and error in presence of image noise. Tests also addressed selection of lens focal length and working distance on the impact the position uncertainty and error in presence of image noise.

Calculation of the 3D position uncertainties was conducted for two cameras with an increasing angle of separation around the 3D point grid. The standard 3D position uncertainty and relative 3D position error were compared with the condition number of the A matrix.

The lens focal length and location of the cameras was also varied to maintain the same observation volume and observe the impact to uncertainty and error. For example, a camera with a wide angle lens, f=3 mm, can be placed at a distance of 0.33 m to observe the same volume as a camera with a narrower field of view, f=8 mm, at a distance of 1.3 m.

In each analysis particle image centroid location errors were simulated by adding in a specified amount of random noise to the centroid x y pixel positions. This type of error would occur due to particle image overlap and is expected during an experiment with high particle seed densities. The tests were conducted to determine how this type of error propagates through to the reconstructed 3D position.

Angle Between Cameras

The angle between cameras is a major factor that determines the sensitivity and conditioning of the 3D reconstruction problem. Two cameras placed very close together would cause the reconstruction problem to be ill-conditioned and sensitive to noisy data and calibration parameter uncertainties. Cameras were placed at five degree intervals in the range from 0 and 180 degrees around the center of the 3D virtual point grid. The distance from the cameras to the center of the grid were fixed at 1.3 m and a lens of f=8 mm was used. The estimated camera parameter uncertainties were based on parameter uncertainty levels u(p)=1.0%, 0.1% and 0.01% of the maximum range for each parameter.

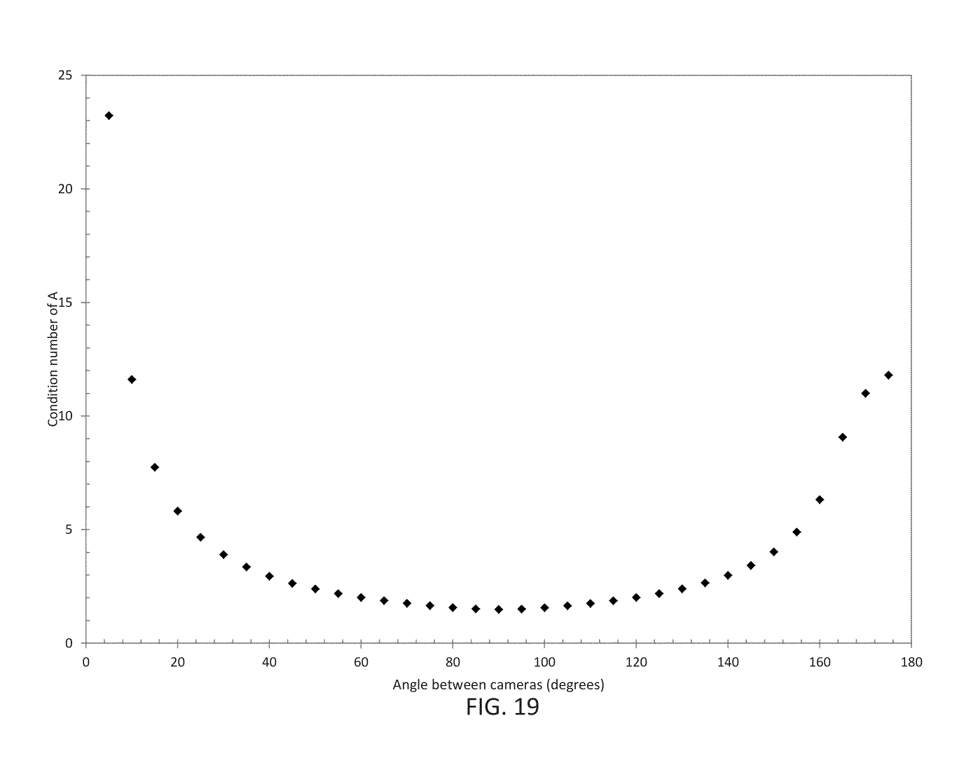

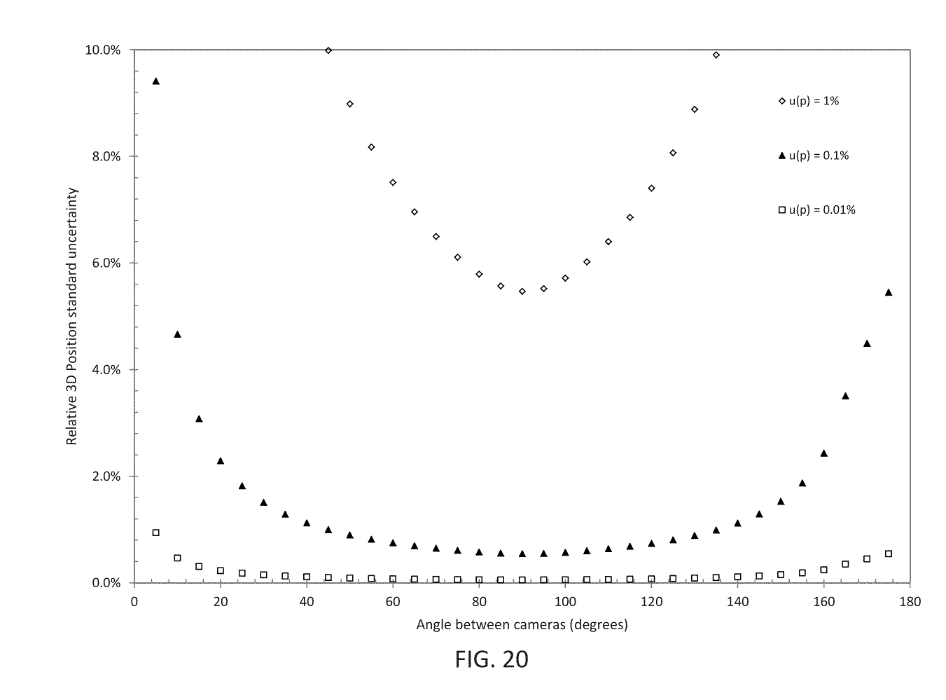

The resulting condition numbers of each camera pair are shown in FIG. 19. The zone of ill-conditioning can be seen when cameras are placed less than 20 degrees apart around the perimeter of the volume of interest and when nearly opposite each other at 160-180 degrees. The corresponding relative 3D position uncertainty, based on the length scale of 300 mm, varied with separation angle as shown in FIG. 20 for the three levels of camera parameter uncertainty. FIG. 20 displays the impact of the camera parameter uncertainty level, which narrows the range of acceptable camera placement if increased.

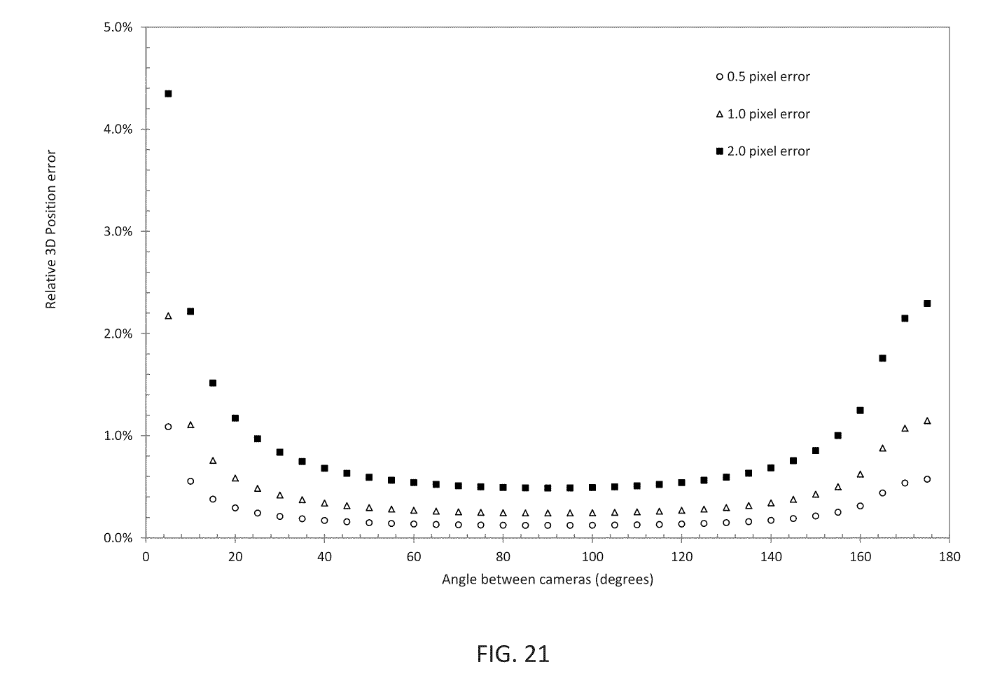

Finally the impacts of centroid detection errors were analyzed at random noise levels of 0.5, 1.0, and 2.0 pixels and were plotted with respect to camera separation angle. FIG. 21 highlights the sensitivity issue arising from using only two cameras placed in a similar location for the 3D reconstruction process. When cameras are placed at a right angle to each other the relative 3D position error resulting from a 2 pixel centroid error in both cameras is less than 1%. However if the two cameras are placed 5 degrees apart, the resulting error would be magnified by 4×. Overall, the condition number is a direct indicator of the sensitivity of the reconstruction process to position uncertainty and error. Using more the two cameras in the reconstruction process can greatly reduce the sensitivity of the system.

Focal Length and Focus Distance

Six equivalent camera setups were evaluated. Six focal lengths ranging from 8 mm to 3 mm and corresponding working distances required to maintain a common observed volume were selected and are given in Table 12. These values correspond to the zoom range and sensor size of the lenses and cameras selected for this research. Two virtual cameras were used for the 3D reconstruction, with both cameras were placed equal distances from the center of the grid and separated by an angle of 45 degrees. A two-pixel centroid position error was introduced to test the sensitivity of resulting 3D position error.

TABLE 12
Equivalent camera setups based on lens focal and
focus distance settings

| | | | | | Depth |
|---|---|---|---|---|---|
| | max | max | max | focus | of |
| f | distance | width | height | distance | Field |
| (mm) | (mm) | (mm) | (mm) | (mm) | (mm) |
| 3.00 | 500.00 | 640.00 | 480.00 | 333.83 | 249.44 |
| 4.00 | 666.67 | 640.00 | 480.00 | 485.44 | 284.99 |
| 5.00 | 833.33 | 640.00 | 480.00 | 641.68 | 311.63 |
| 6.00 | 1000.00 | 640.00 | 480.00 | 800.71 | 332.34 |
| 7.00 | 1166.67 | 640.00 | 480.00 | 961.54 | 348.91 |
| 8.00 | 1333.33 | 640.00 | 480.00 | 1123.60 | 362.46 |

The six setups showed no statistically significant difference in relative 3D position uncertainty. The same is observed for position error resulting from random centroid detection errors up to 2 pixels. Focal length and working distance do not theoretically impact the 3D reconstruction process. However, this assumes lens distortion model fits the real lens distortion equally well for large and small focal length lenses.

A Increasing the Number of Cameras

Increasing the number of cameras involved in solving the image correspondence problem from two to four is known to reduce the particle image matching ambiguities to near. The 3D position uncertainty and error are also of interest.

Two cases were tested. Case 1) Four cameras well positioned 45 degrees apart arranged with their projective centers in square, Case 2) same as Case 1 but with cameras 2 and 3 ill positioned with only 10 degrees separation. For each case the average relative 3D position uncertainty over all points in the 16×16×16, (300 mm×300 mm×300 mm), grid were calculated based on all possible two, three and four camera combinations. Then the 3D relative position error was calculated for each camera combination when all cameras in the group contain uniformly distributed random ±0.5, 1.0 and 2.0 pixel detection errors.

The ill-conditioned camera pair from Case 2 was easily identified by a high condition number compared to other pairs. The interesting result is that by adding a third or fourth camera (placed at a good angle from the others) to the ill-conditioned pair converts the group into a well-conditioned system. In Case 2, camera group 2-3 has an average condition number of 11 resulting in an average relative 3D position uncertainty of 4.7±2.7%, but with the addition of camera 0 the group 0-2-3 has a condition number of 2.5 and relative position uncertainty of 1.0±0.24%. Adding a fourth camera (group 0-1-2-3) further reduces the average condition number to 2.1 and relative 3D position uncertainty to 0.81±0.17%. Therefore, 3D particle position uncertainty of the system can be made less sensitive to camera placement by utilizing more than two cameras in the 3D reconstruction process. The same stabilizing effect is seen when the ill-conditioned pair is grouped with a third and fourth camera.

The uncertainty testing showed that the most influential factor in uncertainty propagation into the 3D reconstructed particle position was found to be the particle centroid location. When all camera parameters were given a relative uncertainty of 0.1%, the particle centroid location uncertainty lead to a 3D position uncertainty of nearly 1% relative to the observed volume or 3 mm. Certainty is enhanced by ensuring that the particle centroid detection algorithm minimizes this uncertainty due to random image noise as much as possible.

When data from two cameras are used for 3D reconstruction, the cameras should be positioned with a minimum of angle 10 degrees between the camera planes. The minimum of data from two camera is only relevant to the 3D reconstruction algorithm. The multi-camera correspondence algorithm requires a minimum of data from three cameras, as discussed above. When the system has three or more cameras that are determined to have corresponding images of a given particle, then there is flexibility to select a subset of these cameras for the 3D reprojection algorithm to minimize 3D position uncertainty. The two cameras should be positioned to minimize the condition number of the A matrix in the least squares 3D reconstruction problem. This occurs when two cameras are placed with their image planes perpendicular to each other.

The selection of focal length and camera working distance do not significantly impact the 3D position uncertainty or error, for equivalent camera setups (large focal length and large working distance or short focal length and short working distance). Therefore other factors such as light intensity and lens distortion should guide the decision on lens selection for a given volume.

It is best to use at least four cameras in the 3D reconstruction process. Grouping the cameras by fours makes the system is very robust to image centroid detection errors and inherent uncertainty in the camera parameters. The tests demonstrated that adding one or two cameras to a pair of ill-placed (nearly linearly dependent) cameras, the sensitivity of the 3D reconstruction to input errors and uncertainties can be greatly reduced.

Additional experiments with jet flows showed that the particle tracking system can successfully track hundreds of particles over hundreds of frames in real-time through a 3D turbulent flow field. Tests also showed that the experimental measurements of a turbulent round jet show that the system is able to accurately track particles in turbulent flow and utilize the Lagrangian velocity statistics of the particles to characterize a flow field. Use of inertial particles and millimeter diameter neutrally buoyant helium bubbles provided reasonable velocity averages and variances for the jet flow studied. The testing confirmed that velocity statistics of turbulent flow are not impacted significantly when viewed through filter of inertial particle motion. Testing also shows that the spatial distribution of the velocity statistics appears to match reasonably well with published measurements of turbulent jet flow.

An unconfined swirling flow was also tested. These tests shows that the particle tracking system was able to reliably track particles in the swirling flow field as supported by the nearly symmetric mean velocity profiles that were observed. The axial and tangential velocity profiles appear to be a qualitative match to what would be theoretically predicted for a vortex flow field. The axial velocity profile has two peaks on either side of a vortex core, while the tangential velocity is anti-symmetric about the center line of the core. The velocities of the particles were consistent in all three dimensions when compared in the XY and XZ planes indicating that the system can faithfully track particles as they traverse all three dimensions in complex paths.

The velocity statistics (Reynolds stress terms) <u′²>, <v′²>, <w′²> and <u′v′>, <u′w′> and <v′w′> of the particle field were plotted and showed signs of symmetry about the vortex core. The <u′v′> shear stress profile in the XY plane is particularly interesting as it exhibits anti-symmetry about the center line with two local peaks (positive and negative) on each side of the vortex. This pattern is closely approximated by a fifth order polynomial. The <u′v′> shear stress reaches zero three times in an example profile, at −1.1dₕ, 0dₕ and 1.2dₕ. These locations of zero <u′v′> shear stress nearly line up with the mean axial velocity (u) peaks as shown in the figure. This observation is congruent with the theory of forced vortex flow where shear equals zero in regions of fixed body rotation.

The turbulent kinetic energy was a maximum in the core region, which may be supported by the following observation. While conducting the experiment it was observed that the flow was pulsating and generating a steady acoustic signal. The pressure fluctuation could be felt by placing a hand in the flow field above the swirl generator. This pulsing is likely the result of the vortex core continuously collapsing due to the low pressures created at the center and high tangential velocities in the surrounding fluid. This would explain the peak of turbulence at the core where the mean velocity magnitudes are low. The static pressure calculations, although not validated for accuracy, qualitatively support this theory as the pressure profiles found contained sharp gradients towards a local minimum at the center of the vortex core.

The Instantaneous Lagrangian Acceleration (ILA) and Reynolds Averaged Navier-Stokes (RANS) based static pressure calculation methods were in agreement on the magnitude and spatial distribution of the static pressure field around the vortex core. Both found a low pressure region peaking at −4 Pa at the very center of the vortex core. The ILA method created smoother and more symmetric pressure profiles, while the RANS method formed more asymmetric profiles as the distances from the swirl generator increased. This difference may be explained by the source terms used in each method. The RANS method is based on the Reynolds Stress tensor which in effect stores information about the flow accelerations through variances and covariance's of the velocity field in space. The pressure gradients from this method are calculated based on statistical means and variances of velocity only, at the end of the experiment. The ILA method collects the instantaneous pressure gradients, calculated from instantaneous velocities and acceleration of individual particles, and then averages the gradients at the end of the experiment. In this way the solution to the Navier-Stokes equations should be more accurate when calculated on a per particle basis as the material acceleration term is solved using a second order finite difference scheme. The RANS method on the other hand will suffer from greater truncation and numerical error as it utilizes first order accurate finite difference schemes at the boundaries when solving the Navier-Stokes equations.

The unconfined swirling flow testing showed that the particle tracking system was able to faithfully track particles moving in complex 3D paths through a turbulent flow field. This was first verified by consistently observing the reconstruction of long (<100 frame) trajectories that wrapped around the vortex core. Secondly, analysis of the collect particle velocity statistics indicated symmetrical flow properties qualitatively consistent with theory.

The two static pressure calculation methods based on RANS and ILA formulations were in agreement on the magnitude and structure of the pressure field which was qualitatively in agreement with theory. However, the RANS approach appeared to suffer from numerical errors due to the use of first order finite difference schemes at the boundaries of the domain. More studies are required to validate the accuracy of these methods and better compare their advantages and disadvantages with different flow regimes.

Testing showed that velocities and accelerations calculated based on the raw trajectories can suffer from significant errors and uncertainties at higher frame rates. This can be addressed with smoothing kernel, polynomial approximation, or piecewise cubic spline to approximate a smooth trajectory through the points prior to calculating derivative properties.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A particle tracking system, comprising:
lighting to illuminate a volume of interest;
a plurality of programmable, synchronized cameras arranged to image the volume of interest;
a heterogeneous, multi-core CPU and GPU cluster for processing data sent from the plurality of programmable, synchronized cameras;
and code that controls the plurality of programmable, synchronized cameras and the heterogeneous, multi-core CPU and GPU cluster to operate in real-time, wherein the code controls the plurality of programmable, synchronized cameras to conduct particle detection and output particle frame data for processing by the heterogeneous, multi-core CPU and GPU cluster and the heterogeneous, multi-core CPU and GPU cluster processes frames of particles in parallel across an array of nodes in a streaming pipeline as they are received and outputs particle trajectories.

2. The system of claim 1, wherein each node in the heterogeneous, multi-core CPU and GPU cluster receives a set of frames, then divides the particles within each frame and processes the particles in parallel on a GPU to determine the multi-camera correspondence of particle images, followed by conducting 3D reconstruction.

3. The system of claim 2, wherein each node the heterogeneous, multi-core CPU and GPU cluster communicates with a local group of nodes to merge trajectory segments to form longer trajectories.

4. The system of claim 3, wherein the longer trajectories are processed to determine Lagrangian and Eularian properties of a particle flow field.

5. The system of claim 1, wherein the heterogeneous, multi-core CPU and GPU cluster is provided via a cloud resource an internet connection.

6. The system of claim 5, further comprising a work station that receives and displays the particle frame data in real time.

7. The system of claim 1, wherein the plurality of programmable, synchronized cameras conduct image processing and the heterogeneous, multi-core CPU and GPU cluster processes multi-camera correspondence, 3D reconstruction, tracking and result visualization.

8. The system of claim 7, wherein the plurality of programmable, synchronized cameras send identified particle pixel coordinates or segmented images in real-time to the heterogeneous, multi-core CPU and GPU cluster.

9. The system of claim 8, wherein the heterogeneous, multi-core CPU and GPU cluster processes multi-camera correspondence in two stages, a first stage determines all possible two camera combinations and identifies particles within each camera pair that satisfy an epipolar constraint within a predetermined tolerance as corresponding match particles and passes corresponding match particles onto a second stage, and in the second stage all four camera groups formed from the all possible two camera combinations are evaluated to determine if the matched two camera sets combine within a group to satisfy a four camera epipolar constraint.

10. The system of claim 7, wherein the multi-camera correspondence comprises conducting a particle priority strict matching as follows:
(1) for an initial frame f−1, initiate two point trajectories by adding the nearest neighboring particle in frame f to each particle in frame f−1 and proceed to the next frame;
(2) extrapolate the trajectories to estimate a particle's position in a new frame f+1 with an approximation of velocity through the first order backward difference scheme, and calculate a search radius based on the magnitude of velocity times a time step where the radius defines a sphere in object space centered at a point;
(3) for each of the particles in frame f+1, loop through all trajectories calculating a distance d from the particle to the extrapolated point of the trajectory, if the distance is less than the radius then a cost function is evaluated, and if the cost is less than any prior trajectory costs for that particle then the particle stores the trajectory and cost as the best match and proceeds to the next trajectory, and once the particle has tried to match with all trajectories, the particle and its lowest cost trajectory matched in the trajectory's candidate list are stored;
(4) after all particles at frame f+1 have tried to match with all trajectories then each trajectory sorts its candidate list and accepts its lowest cost match, extending the trajectory.

11. The system of claim 7, wherein the heterogeneous, multi-core CPU and GPU cluster processes multi-camera correspondence and the multi-camera correspondence comprises conducting a particle priority strict matching as follows:
(1) for an initial frame f−1, initiate two point trajectories by adding the nearest neighboring particle in frame f to each particle in frame f−1 and proceed to the next frame;
(2) extrapolate the trajectories to estimate a particle's position in a new frame f+1 with an approximation of velocity through the first order backward difference scheme, and calculate a search radius based on the magnitude of velocity times a time step where the radius defines a sphere in object space centered at a point;
(3) for each of the particles in frame f+1, loop through all trajectories calculating a distance d from the particle to the extrapolated point of the trajectory, if the distance is less than the radius then a cost function is evaluated, and if the cost is less than any prior trajectory costs for that particle then the particle stores the trajectory and cost as the best match and proceeds to the next trajectory, and once the particle has tried to match with all trajectories, the particle and its lowest cost trajectory matched in the trajectory's candidate list are stored;
(4) after all particles at frame f+1 have tried to match with all trajectories then each trajectory sorts its candidate list and accepts its lowest cost match, extending the trajectory.

12. The system of claim 1, wherein the heterogeneous, multi-core CPU and GPU cluster processes multi-camera correspondence and the multi-camera correspondence comprises conducting a particle priority strict matching that utilizes finite difference approximations and prevents tracking ambiguities by ensuring that particles in frame f+1 can match with only one trajectory based on minimizing a cost function.

13. The system of claim 12, wherein the particle priority strict matching comprises having a particle in the frame pick the trajectory that minimizes the tracking cost, and then if a trajectory has been selected by multiple particles, it sorts the multiple particles and selects a candidate that minimizes the cost function such that the cost function is only evaluated once, but a resulting value is judged by both the particle and the trajectory.

14. The system of claim 12, wherein the heterogeneous, multi-core CPU and GPU cluster calculates Eularian properties of a particle flow field by treating particles as ideal tracers and calculating pseudo Eularian flow properties for inertial particles that are being tracked.

15. The system of claim 1, wherein a frame rate of the plurality of programmable, synchronized cameras is high enough to make particle velocity and acceleration calculations substantially linear.

16. The system of claim 15, wherein Lagrangian values of velocity and acceleration of a particle along a trajectory are calculated based on second order central difference calculations.

17. The system of claim 16, wherein the Lagrangian values are calculated along each trajectory in real-time, further comprising calculating instantaneous pressure gradients along each trajectory, storing calculated instantaneous values over time in the cells of a finite volume grid, and extracting mean and variance of pressure gradient in each cell to thereby transform instantaneous Lagrangian accelerations and velocities into a Eularian representation of the pressure gradient field.

18. The system of claim 16, wherein the heterogeneous, multi-core CPU and GPU cluster processes multi-camera correspondence by matching tail portions of trajectories with a cost function and associated cost threshold.

19. The system of claim 18, wherein the tail portions are comprises of a first four and last four linked particles

20. The system of claim 17, wherein the heterogeneous, multi-core CPU and GPU cluster processes determines instantaneous pressure gradients along each particle trajectory defined by equations 2-35 and 2-36, assuming the particles behave as ideal flow tracers, and the resulting instantaneous pressure gradients are statistically accumulated in cells of a finite volume grid used to calculate static pressures in the Eularian framework:
$$\begin{matrix}a = \frac{\partial v}{\partial t} + v \cdot ∇ v = \frac{1}{ρ} ( - ∇ p + μ {∇}^{2} v ) & ( 2 \text{-} 35 ) \\ ∇ p = - ρ a + μ {∇}^{2} v & ( 2 \text{-} 36 )\end{matrix}$$
where μ is the dynamic viscosity and ρ is the density of the fluid, the velocity is v, and acceleration and diffusion terms μ∇²v are discretized using second order central finite differences.

21. The system of claim 20, wherein a discretized acceleration term is given in 2-37 and the discretized Laplacian of velocity (∇²v) is given in equation 2-38.
$$\begin{matrix}a = \frac{( {x}^{n + 1} - 2 {x}^{n} + {x}^{n - 1} )}{Δ {t}^{2}} i + \frac{( {y}^{n + 1} - 2 {y}^{n} + {y}^{n - 1} )}{Δ {t}^{2}} j + \frac{( {z}^{n + 1} - 2 {z}^{n} + {z}^{n - 1} )}{Δ {t}^{2}} k + O ( Δ {t}^{2} ) & ( 2 \text{-} 37 ) \\ {∇}^{2} v = [ \begin{matrix}\frac{( {u}^{n + 1} - 2 {u}^{n} + {u}^{n - 1} )}{Δ {x}^{2}} + \\ \frac{( {u}^{n + 1} - 2 {u}^{n} + {u}^{n - 1} )}{Δ {y}^{2}} + \frac{( {u}^{n + 1} - 2 {u}^{n} + {u}^{n - 1} )}{Δ {z}^{2}}\end{matrix} ] i [ \begin{matrix}\frac{( {v}^{n + 1} - 2 {v}^{n} + {v}^{n - 1} )}{Δ {x}^{2}} + \\ \frac{( {v}^{n + 1} - 2 {v}^{n} + {v}^{n - 1} )}{Δ {y}^{2}} + \frac{( {v}^{n + 1} - 2 {v}^{n} + {v}^{n - 1} )}{Δ {z}^{2}}\end{matrix} ] j [ \begin{matrix}\frac{( {w}^{n + 1} - 2 {w}^{n} + {w}^{n - 1} )}{Δ {x}^{2}} + \\ \frac{( {w}^{n + 1} - 2 {w}^{n} + {w}^{n - 1} )}{Δ {y}^{2}} + \frac{( {w}^{n + 1} - 2 {w}^{n} + {w}^{n - 1} )}{Δ {z}^{2}}\end{matrix} ] k & ( 2 \text{-} 38 )\end{matrix}$$

22. The system of claim 21, wherein the pressure gradient along a trajectory is calculated in real-time along with velocity and acceleration as the trajectories are being constructed.

23. The system of claim 1, wherein the heterogeneous, multi-core CPU and GPU cluster calculates a structured Cartesian virtual finite volume grid, where each voxel contains an array of statistical accumulators, and the accumulators are objects which accept instantaneous values of the Lagrangian properties and actively calculate statistical values for the each property including mean, variance and/or covariance.

24. The system of claim 23, wherein instantaneous velocity components of particles as they move through the statistical accumulator grid are collected and the Reynolds stress tensor is calculated as the variance and covariance of the accumulated velocities.

25. The system of claim 1, wherein Lagrangian particle tracking (LPT) data is output from the plurality of programmable, synchronized cameras and pipelined across CPU cores in the heterogeneous, multi-core CPU and GPU cluster as it streams in from the plurality of programmable, synchronized cameras, and each LPT task is assigned a group of CPU threads to process the data in parallel.

26. The system of claim 25, wherein the pipeline is implemented as a multiple producer/consumer model, wherein each task is a consumer for the data output by the preceding task and a producer of data for the succeeding task.

27. The system of claim 1, wherein the heterogeneous, multi-core CPU and GPU cluster processes multi-camera data and determines all possible two camera combinations and identifies particles within each camera pair that satisfy an epipolar constraint within a predetermined tolerance as corresponding match particles, and the plurality of programmable, synchronized cameras use a thread to evaluate an epipolar constraint equation for all particles of unique camera pairs and another thread to test for satisfaction of the four camera correspondence criteria.

28. The system of claim 27, wherein the thread to evaluate comprises steps including:
(1) initialize a GPU in the heterogeneous, multi-core CPU and GPU cluster with fundamental matrices for all camera pairs and allocate memory for particle data;
(2) grab a frame of particle centroid data from queue and asynchronously copy all particles from all cameras to the GPU;
(3) on the GPU, generated a thread for each particle in camera A of each camera pair, and loop each thread through all particles in camera B and evaluate the epipolar constraint equation; and.
(4) a CPU copies resulting epipolar constraint residuals for each particle and sends the data to the second stage to evaluate four camera correspondence criteria for the another thread to test.

29. The system of claim 1, wherein the heterogeneous, multi-core CPU and GPU cluster processes 3D particle data from the plurality of programmable, synchronized cameras by
in a first step, reading 3D particle location data from memory and distributing the data in frame-sets of S frames to a pool of processors;
next, each processor in the pool of processors runs a sequential tracking algorithm on its frame-sets to build local trajectory segments;
after the trajectory segments spanning two adjacent frame-sets have been constructed, a merge operation is conducted to locally map trajectory pairings between adjacent frame-sets while actual trajectory data remains fragmented across processors and only locally paired trajectory segment identifications are known by each processor;
after all local trajectory merges have been identified between each adjacent frame-set, a global trajectory construction process consolidates trajectory segments belonging to a single global trajectory on the same processor.

30. The system of claim 29, wherein the global trajectory construction process comprises:
generating instructions that define segments to be merged along with respective frame-set identifications and a host processor identification,
next, each processor selects an equal subset of global trajectories and communicates with other processors to obtain segments needed for construction of global trajectories;
and once a processor has received all of the contiguous trajectory segments and built the global trajectories, it outputs them to a single file such that results are a series of files (one per processor) containing full length trajectories.

31. A particle tracking system, comprising:
lighting to illuminate a volume of interest;
camera means for imaging the volume of interest with oversampling frame rates and for conducting image acquisition, processing and particle detection with zero net data retention while outputting particle detection results;
processor means for processing data sent from the plurality of programmable, synchronized cameras and for conducting multi-camera correspondence, 3D reconstruction, tracking and result visualization in real time by spreading processing over multiple CPUs and GPUs.

32. The system of claim 31, wherein the processor means processes frames of particles in parallel across the array of nodes in a streaming pipeline as they are received.

33. The system of claim 31, wherein said processor means conducts the multi camera correspondence by applying an epipolar geometry constraint.

34. The system of claim 33 wherein the processor means separates evaluation of an epipolar constraint evaluation from a judgment that compares match lists used to find camera correspondences.

35. The system of claim 31, wherein the processor means conducts particle tracking by a particle priority algorithm that utilizes finite difference approximations and prevents tracking ambiguities by ensuring that particles in a frame can match with only one trajectory based on minimizing a selected cost function.

36. A method for particle tracking, comprising:
receiving particle tracking trajectory data from a multi-camera system in real-time;
calculating Lagrangian values are calculated along each trajectory in the particle tracking data in real-time;
calculating instantaneous pressure gradients along each trajectory;
storing calculated instantaneous values over time in cells of a finite volume grid;
extracting mean and variance of pressure gradient in each cell to thereby transform instantaneous Lagrangian accelerations and velocities into a Eularian representation of the pressure gradient field;
calculating static pressure in the Eularian frame as the mean and variance of the instantaneous pressure gradient values accumulated in each cell.
